(19) United States
(12) Patent Application Publication
(10) Pub. No.: US 2025/0261637 A1
(43) Pub. Date: Aug. 21, 2025

(54) DISINFECTANT COMPOSITIONS AND METHODS THEREOF

(71) Applicant: HALOMINE INC., Ithaca, NY (US)

(72) Inventors: Buket DEMIR, Ithaca, NY (US); Mingyu QIAO, Ithaca, NY (US); Edward SYMONDS EVELETH, Ithaca, NY (US); Marc Douglas HEIN, Ithaca, NY (US); Jeffrey A. KEHL, Ithaca, NY (US); Ting-Yen CHI, Ithaca, NY (US); Ziying CUI, Ithaca, NY (US); Ekrem OZKAN, Ithaca, NY (US); Joshua TUNG, Ithaca, NY (US); Vikram Kumar KANMUKHLA, Ithaca, NY (US)

(21) Appl. No.: 19/196,184

(22) Filed: May 1, 2025

Related U.S. Application Data
(63) Continuation of application No. PCT/US2023/033875, filed on Sep. 27, 2023.
(60) Provisional application No. 63/410,380, filed on Sep. 27, 2022.

(51) Int. Cl. A01N 37/02; A01N 25/12; A01N 37/18; C08F 220/06; C08F 220/34; C08F 222/38; C08F 226/06; C08K 5/05; C08K 5/19; C08K 5/544

(52) U.S. Cl. CPC A01N 37/02; A01N 25/12; A01N 37/18; C08F 220/06; C08F 220/34; C08F 222/385; C08F 226/06; C08K 5/05; C08K 5/19; C08K 5/544

(57) ABSTRACT

The present disclosure describes compositions and methods of manufacturing and using the same for providing residual disinfecting, biocidal activity on a surface of an object. The compositions of the present invention can comprise a polymer or non-polymer comprising any number of N-halamine precursors or the N-halamine derivatives thereof.

### CROSS-REFERENCE

This application is a continuation of International Patent Application No. PCT/US2023/033875, filed Sep. 27, 2023, which claims the benefit of U.S. Patent Application No. 63/410,380, filed Sep. 27, 2022, each of which is entirely incorporated herein by reference.

### BACKGROUND

Microorganisms (e.g., fungi, bacteria, virus, etc.) can grow on a number of surfaces, such as those of food packages or processing units, textiles, medical devices, and water treatment systems. For example, bacteria (e.g., Pseudomonas, Listeria monocytogenes, Salmonella, etc.) can adhere to and colonize solid surfaces of food processing units, resulting in harmful contamination and cross-contamination of food products. Without timely treatment, bacteria can form biofilms that are resistant to various cleaning agents, such as chlorine bleach.

### INCORPORATION BY REFERENCE

Each patent, publication, and non-patent literature cited in the application is hereby incorporated by reference in its entirety as if each was incorporated by reference individually.

### SUMMARY OF THE INVENTION

In some embodiments, the present invention provides a coating composition (e.g., a polymer coating composition), wherein the coating composition is configured to adhere to surfaces to form a coating (e.g., a polymer coating), wherein the coating provides or is activated to provide biocidal activity. In some embodiments, the surfaces can be abiotic or biotic surfaces. In some embodiments, the coating provides the protection for a plurality of hours. In some embodiments, the coating is activated with chlorine-based sanitizers. In some embodiments, the coating is activated with halogenated solutions. In some embodiments, the coating is activated and/or reactivated with chlorine-based sanitizers for several cycles. In some embodiments, the coating can be reactivated with the halogenated solutions for several cycles. In some embodiments, the coating composition is blended with chlorine-based solutions. In some embodiments, the coating composition is biocidal.

In some embodiments, the coating composition as disclosed herein can be a liquid composition usable for forming the coating. In some embodiments, the coating composition as disclosed herein can be a non-liquid composition (e.g., solid, tablet, gel, powder, etc.) usable for forming the coating. In some embodiments, a mixture comprising a solvent (e.g., an organic or aqueous solvent) and the non-liquid composition can be usable for forming the coating.

In some embodiments, disclosed herein is a copolymer comprising a plurality of units of a first repeating group and a plurality of units of a second repeating group, wherein:
the first repeating group or a portion thereof is:

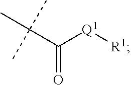

the second repeating group or a portion thereof is:

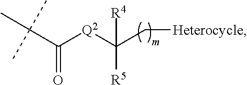

wherein Q¹ is O, NH, or N(alkyl); Q² is O, NH, or N(alkyl); R¹ is H, —C(R²)(R³)(CH₂)ₙ-Charged Group; R² is H or alkyl; R³ is H or alkyl; R⁴ is H or alkyl; R⁵ is H or alkyl; m is 0, 1, 2, 3, 4, or 5; n is 0, 1, 2, 3, 4, or 5; Charged Group is an ionized or ionizable moiety; and Heterocycle is a heterocyclic ring containing a nitrogen atom.

In some embodiments, disclosed herein is a sample of a copolymer comprising a plurality of units of a first repeating group and plurality of units of a second repeating group, wherein: the first repeating group or a portion thereof is:

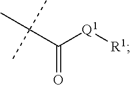

the second repeating group or a portion thereof is:

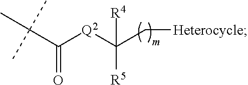

wherein Q¹ is NC, NH, O, or N(alkyl); Q² is NCl, O, or N(alkyl); R¹ is —C(R²)(R³)(CH₂)ₙ-Charged Group, H, or Cl; R² is alkyl or H; R³ is alkyl or H; R⁴ is alkyl or H; R⁵ is alkyl or H; m is 1, 0, 2, 3, 4, or 5; n is 1, 0, 2, 3, 4, or 5; Charged Group is an ionized or ionizable moiety; and Heterocycle is a heterocyclic ring containing a nitrogen atom that is substituted with a chlorine atom.

In some embodiments, disclosed herein is a method comprising combining: a sample of a compound of formula (I):

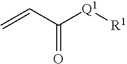

or an ionized form thereof; a sample of a compound of formula (II):

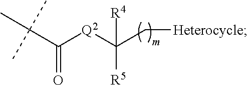

and a solvent under free radical polymerization conditions to provide a mixture, wherein: Q¹ is O, NH, or N(alkyl); Q² is O, NH, or N(alkyl); R¹ is H, —C(R²)(R³)(CH₂)ₙ-Charged Group; R² is H or alkyl; R³ is H or alkyl; R⁴ is H or alkyl; R⁵ is H or alkyl; m is 0, 1, 2, 3, 4, or 5; n is 0, 1, 2, 3, 4, or 5; Charged Group is an ionizable or ionized moiety; and Heterocycle is a heterocyclic ring containing a nitrogen atom.

In some embodiments, disclosed herein is a solid composition comprising: (i) a N-chlorinated halamine, wherein the N-chlorinated halamine is part of a side chain of a first repeating unit of a polymer; and (ii) a quaternary ammonium moiety, wherein the solid composition is dissolvable in an aqueous medium.

In some embodiments, disclosed herein is a solid composition comprising a copolymer, wherein the copolymer comprises a first repeating unit and a second repeating unit, wherein: (i) the first repeating unit comprises a side chain, wherein the side chain comprises a N-chlorinated halamine moiety; and (ii) the second repeating unit comprises a water-soluble moiety, wherein the composition is soluble in an aqueous medium.

In some embodiments, disclosed herein is a composition comprising a copolymer, wherein the copolymer comprises a first repeating unit and a second repeating unit, wherein: (i) the first repeating unit comprises a side chain, wherein at least a portion of the side chain forms an N-halamine when exposed to an electrophilic halogen source; and (ii) the second repeating unit comprises a water-soluble moiety, wherein a number average molar mass of the copolymer in the composition is less than or equal to about 10 kilodalton (kDa).

In some embodiments, disclosed herein is a composition comprising: a polymer comprising a N-halamine precursor configured to form a N-halogenated halamine when exposed to an electrophilic halogen source, wherein the N-halamine precursor is part of a repeating unit of the polymer; and a small molecule binder comprising an organosilane moiety.

In some embodiments, disclosed herein is a composition comprising: a copolymer comprising a first repeating unit and a second repeating unit, wherein: the first repeating unit comprises a N-halamine precursor configured to form a N-halogenated halamine when exposed to an electrophilic halogen source; and the second repeating unit comprises a dopamine moiety; and a cross-linking moiety comprising: a reactive group configured to chemically conjugate to the dopamine moiety of the copolymer; and an additional reactive group configured to chemically conjugate to a surface, thereby coupling the copolymer to the surface.

In some embodiments, disclosed herein is a composition comprising: a copolymer comprising a first repeating unit and a second repeating unit, wherein: the first repeating unit comprises a N-halamine precursor configured to form a N-halogenated halamine when exposed to an electrophilic halogen source; and the second repeating unit comprise a dopamine moiety; and a plurality of cross-linking moieties comprising a first cross-linking moiety and a second cross-linking moiety, wherein the first cross-linking moiety and the second cross-linking moieties are configured to: (i) electrostatically bind to one another; or (ii) chemically conjugate to one another.

### BRIEF DESCRIPTION OF THE FIGURES

FIG. 1 shows the electrospray ionization mass spectrum of a p(HA-co-SA) (HASA) with 50:50 HA:SA monomer feed ratios prepared by reversible addition-fragmentation chain-transfer chemistry.

FIG. 2 shows available chlorine levels of HOCl, HASA/HOCl solutions at various HASA:HOCl ratios, and HA/HOCl solutions at various HA:HOCl ratios over 10 weeks.

FIG. 3 shows the pH of HOCl, HASA/HOCl solutions at various HASA:HOCl ratios, and HA/HOCl ratios at various HA:HOCl ratios over 10 weeks.

FIG. 4 shows available chlorine levels of HOCl, HASA/HOCl solutions at various HASA:HOCl ratios, and HA/HOCl solutions at various HA:HOCl ratios over 10 weeks.

FIG. 5 shows the pH of HOCl, HASA/HOCl solutions at various HASA:HOCl ratios, and HA/HOCl ratios at various HA:HOCl ratios over 10 weeks.

FIG. 6 shows available chlorine levels of NaOCl, HASA/NaOCl solutions at various HASA:NaOCl ratios, and HA/NaOCl solutions at various HA:NaOCl ratios over 10 weeks.

FIG. 7 shows the pH of NaOCl, HASA/NaOCl solutions at various HASA:NaOCl ratios, and HA/NaOCl solutions at various HA:NaOCl ratios over 10 weeks.

FIG. 8 shows available chlorine levels of NaOCl, HASA/NaOCl solutions at various HASA:NaOCl ratios, and HA/NaOCl solutions at various HA:NaOCl ratios over 10 weeks.

FIG. 9 shows the pH of NaOCl, HASA/NaOCl solutions at various HASA:NaOCl ratios, and HA/NaOCl solutions at various HA:NaOCl ratios over 10 weeks.

FIG. 10 shows available chlorine levels of HASA/NaOCl solutions at various HASA:NaOCl ratios over 10 weeks.

FIG. 11 shows the pH of HASA/NaOCl solutions at various HASA:NaOCl ratios over 10 weeks.

FIG. 12 shows available chlorine levels of HA/NaOCl solutions at various HA:NaOCl ratios over 10 weeks.

FIG. 13 shows the pH of HA/NaOCl solutions at various HA:NaOCl ratios over 10 weeks.

FIG. 14 shows available chlorine levels of NaDCC, HASA/NaDCC solutions at various HASA:NaDCC ratios, and HA:NaDCC solutions at various HA:NaDCC ratios over 10 weeks.

FIG. 15 shows the pH of NaDCC, HASA/NaDCC solutions at various HASA:NaDCC ratios, and HA/NaDCC solutions at various HA:NaDCC ratios over 10 weeks.

FIG. 16 shows the appearance of stainless steel (SS304) coupons deposited with 1 mL of HOCl, HASA/HOCl solutions at various HASA:HOCl ratios, and HA/HOCl solutions at various HA:HOCl ratios after one day of drying.

FIG. 17 illustrates the chlorine density of SS304 coupons deposited with 1 mL of HOCl, HASA/HOCl solutions at various HASA:HOCl ratios, and HA/HOCl solutions at various HA:HOCl ratios assessed at 1, 2, 3, 7, and 28 days after depositing. The bars are presented in the order: Day 1, Day 2, Day 3, Day 7, and Day 28.

FIG. 18 illustrates the chlorine density of SS304 coupons deposited with 1 mL of HOCl, HASA/HOCl solutions at various HASA:HOCl ratios, HA/HOCl solutions at various HA:HOCl ratios, NaDCC, HASA/NaDCC solutions at various HASA:NaDCC rations, HA/NaDCC solutions at various HA:NaDCC ratios, NaOCl, HASA/NaOCl solutions at various HASA:NaOCl ratios, and HA/NaOCl solutions at various HA:NaOCl ratios assessed at 1, 3, and 7 days after depositing. The bars are presented in the order: Day 1, Day 3, and Day 7.

FIG. 19 shows the appearance of SS304 coupons deposited with 1 mL of HOCl, HASA/HOCl solutions at various HASA:HOCl ratios, and HA/HOCl solutions at various HA:HOCl ratios following 2 days of drying and rinsing with deionized water.

FIG. 20 illustrates the chlorine density of SS304 coupons deposited with 1 mL of HOCl, HASA/HOCl solutions at various HASA:HOCl ratios, and HA/HOCl solutions at various HA:HOCl ratios following 2 days of drying and rinsing with deionized water.

FIG. 21 illustrates the effect of the equivalent of 1.5, 3, and 6 months of wet and dry abrasion on the chlorine density of stainless steel coupons coated with HA/DMA copolymer, the stainless steel coupons were chlorinated after abrasion.

### DETAILED DESCRIPTION

Liquid-based antimicrobial compositions (e.g., disinfectants provided on List N by the United States Environmental Protection Agency (EPA)) can be applied to a surface, to provide antimicrobial effect to the surface and/or microorganisms already existing on the surface at the time of the application to the surface. However, the liquid-based antimicrobial compositions can fail to provide antimicrobial activity substantially beyond the time of the application. Various objects used by humans (e.g., desk surfaces, containers, electronic devices, etc.) are in repeated contact by humans. To address this problem, disinfectant products that can continuously inhibit growth of microorganisms can provide biocidal efficacy in between regular cleaning and disinfection operations, e.g., to reduce the level of re-contamination on high touch surfaces.

Compositions and methods in the present invention can, for example, generate a surface coating that exhibits residual biocidal activity (e.g., antimicrobial activity, antiviral activity, etc.) beyond the initial time of application or generation of the surface coating (e.g., for at least or up to about 10 minutes, at least or up to about 30 minutes, 1 hour, at least or up to about 2 hours, 6 hours, at least or up to about 12 hours, at least or up to about 24 hours, at least or up to about 2 days, at least or up to about 1 week, at least or up to about 1 month, at least or up to about 2 months, or more, continuously, etc.). Compositions and methods herein can, for example, generate a surface coating exhibiting such biocidal activity in between regular cleaning and disinfection, e.g., to reduce level/occurrence of occurrence or re-contamination of surfaces, such as frequently-touched surfaces.

### Compositions and Methods of the Invention

The present invention provides compositions and methods of manufacturing and using the same for providing biocidal activity (e.g., antimicrobial and/or anti-fouling activity). The compositions of the present invention can be used to generate a coating (e.g., a coating comprising a biocidal moiety and, optionally, a binder) on a surface of an object, which coating can provide or exhibit the biocidal activity. The coating can be a biocidal coating. The coating can be long lasting and/or rechargeable.

### Biocidal Moieties:

In some embodiments, the coating compositions as disclosed herein can comprise a biocidal moiety. The biocidal moiety can exhibit or can be activated to exhibit biocidal activity. For example, the biocidal moiety can comprise N-halamine precursors or the N-halamine derivatives thereof (e.g., activated N-halamines, such as N-chlorinated halamines). The coating compositions can further comprise an activating moiety of the biocidal moiety. For example, the coating compositions can comprise a halogen source (e.g., a source of chlorine atoms, a source of bromine atoms, or a source of iodine atoms) usable to activate or sustain activated state of N-halamines in the compositions and/or a coating formed by such compositions. In some embodiments, the biocidal moiety can be water soluble.

In some embodiments, the biocidal moiety can be a small molecule. The small molecule biocidal moiety (e.g., the N-halamine precursors or the N-halamine derivative thereof) can have an average molar mass (e.g., as determined by mass spectrometry) that is at most about 10,000 Da, about 9,000 Da, about 8,000 Da, about 7,000 Da, about 6,000 Da, about 5,000 Da, about 4,000 Da, about 3,000 Da, about 2,000 Da, about 1,000 Da, about 900 Da, about 800 Da, about 700 Da, about 600 Da, about 500 Da, about 400 Da, about 300 Da, or less. In some embodiments, the small molecule biocidal moiety is not a monomer capable of forming a polymer.

In some embodiments, the coating composition as disclosed herein can comprise a small molecule biocidal moiety. The coating composition may not comprise a binder (e.g., a polymeric binder). Upon application of the coating composition to a surface (e.g., a surface of an object), the small molecule biocidal moiety can be dried on the surface to exhibit biocidal activity, e.g., in absence of any binder.

In some embodiments, the small molecule biocidal moiety can be a monomer capable of forming a polymer.

In some embodiments, the biocidal moiety can be a large molecule, such as a polymer comprising a plurality of repeated units comprising a biocidal functional group (e.g., N-halamines). An average molar mass (e.g., a number average molar mass as determined by gel permeation chromatography (GPC)) of the polymeric biocidal moiety can be at least or up to about 1 kilodaltons (kDa), at least or up to about 2 kDa, at least or up to about 3 kDa, at least or up to about 4 kDa, at least or up to about 5 kDa, at least or up to about 6 kDa, at least or up to about 7 kDa, at least or up to about 8 kDa, at least or up to about 9 kDa, at least or up to about 10 kDa, at least or up to about 11 kDa, at least or up to about 12 kDa, at least or up to about 13 kDa, at least or up to about 14 kDa, at least or up to about 15 kDa, at least or up to about 16 kDa, at least or up to about 17 kDa, at least or up to about 18 kDa, at least or up to about 19 kDa, at least or up to about 20 kDa, at least or up to about 50 kDa, at least or up to about 100 kDa, at least or up to about 150 kDa, at least or up to about 200 kDa, at least or up to about 300 kDa, at least or up to about 400 kDa, at least or up to about 500 kDa, at least or up to about 600 kDa, at least or up to about 700 kDa, at least or up to about 800 kDa, at least or up to about 900 kDa, at least or up to about 1,000 kDa, at least or up to about 2,000 kDa, at least or up to about 3,000 kDa, at least or up to about 4,000 kDa, at least or up to about 5,000 kDa, at least or up to about 6,000 kDa, at least or up to about 7,000 kDa, at least or up to about 8,000 kDa, at least or up to about 9,000 kDa, at least or up to about 10,000 kDa, at least or up to about 11,000 kDa, 15,000 kDa, at least or up to about 20,000 kDa, at least or up to about 25,000 kDa, at least or up to about 30,000 kDa, at least or up to about 35,000 kDa, at least or up to about 40,000 kDa, at least or up to about 45,000 kDa, or at least or up to about 50,000 kDa. In some embodiments, an average molar mass of a polymeric biocidal moiety can be no greater than about 1 kDa, no greater than about 2 kDa, no greater than about 3 kDa, no greater than about 5 kDa, no greater than about 10 kDa, no greater than about 20 kDa, no greater than about 50 kDa, no greater than about 100 kDa, no greater than about 150 kDa, no greater than about 200 kDa, no greater than about 300 kDa, no greater than about 400 kDa, no greater than about 500 kDa, at no greater than about 600 kDa, no greater than about 700 kDa, no greater than about 800 kDa, no greater than about 900 kDa, no greater than about 1,000 kDa, no greater than about 2,000 kDa, no greater than about 3,000 kDa, no greater than about 4,000 kDa, no greater than about 5,000 kDa, no greater than about 6,000 kDa, no greater than about 7,000 kDa, no greater than about 8,000 kDa, no greater than about 9,000 kDa, no greater than about 10,000 kDa, no greater than 11,000 kDa, no greater than about 15,000 kDa, no greater than about 20,000 kDa, no greater than about 25,000 kDa, no greater than about 30,000 kDa, no greater than about 35,000 kDa, no greater than about 40,000 kDa, no greater than about 45,000 kDa, or no greater than about 50,000 kDa. In some embodiments, average molar mass is determined by mass spectrometry, for example, electrospray ionization mass spectrometry (ESI-MS), matrix assisted laser desorption/ionization-time of flight (MALDI-TOF) mass spectrometry, chemical ionization (CI) mass spectrometry, atmospheric pressure chemical ionization mass spectrometry (APCI-MS), direct analysis in real time mass spectrometry (DART-MS), atmospheric solids analysis probe mass spectrometry (ASAP-MS), or electron impact (EI) mass spectrometry.

In some embodiments, the coating generated by the compositions and methods of the present invention can comprise N-halamine precursors and/or activated N-halamines (e.g., chlorinated N-halamines), to exhibit the biocidal activity. In some embodiments, the N-halamine precursors and/or activated N-halamines can be a part of a polymer (e.g., a homopolymer, a copolymer, etc.). In some embodiments, the N-halamine precursors and/or activated N-halamines can be a small molecule mixed in the coating composition. In some embodiments, the N-halamine precursors and/or activated N-halamines can be a small molecule blended with polymer coating (e.g., blended with a binder to generate a mixture usable for coating a surface).

In some embodiments, the coating composition as disclosed herein can comprise a plurality of biocidal moieties (or a plurality of biocides) comprising (i) the N-halamine precursors and/or activated N-halamines and (ii) one or more additional biocides (e.g., quaternary ammonium compounds (QACs)). In some cases, (i) an amount (e.g., mass) of the N-halamine precursors and/or activated N-halamines can be greater than (ii) an amount (e.g., mass) of the one or more additional biocides, e.g., by at least about 1%, at least about 2%, at least about 5%, at least about 10%, at least about 20%, at least about 30%, at least about 40%, at least about 50%, at least about 60%, at least about 70%, at least about 80%, at least about 90%, at least about 100%, at least about 200%, at least about 300%, at least about 500%, or more. In some cases, the amount of the one or more additional biocides (e.g., QACs) in the coating composition or the resulting coating as disclosed herein can be at most about 2% (e.g., at most about 0.75%, at most about 0.5%, at most about 0.2%, at most about 0.10%, at most about 0.05%, at most about 0.01%, or less) by weight of the coating composition of the resulting coating. In some cases, (i) the amount (e.g., mass) of the N-halamine precursors and/or activated N-halamines can be less than (ii) the amount (e.g., mass) of the one or more additional biocides, e.g., by at least about 1%, at least about 2%, at least about 5%, at least about 10%, at least about 15%, at least about 20%, at least about 25%, at least about 30%, at least about 35%, at least about 40%, at least about 45%, at least about 50%, at least about 60%, at least about 70%, at least about 80%, at least about 90%, at least about 95%, or more. In some cases, (i) the amount (e.g., mass) of the N-halamine precursors and/or activated N-halamines can be substantially the same as (ii) the amount (e.g., mass) of the one or more additional biocides. As provided herein, (i) N-halamine precursors and/or activated N-halamines and (ii) one or more additional biocides can be present in the coating composition as separate molecules or as part of a same molecule (e.g., a copolymer comprising a repeating unit that comprises (i) and an additional repeating unit that comprises (ii)).

In some embodiments, the composition as disclosed herein can comprise additional biocides (e.g., non-N-halamine biocides), such as, for example, as QACs, polybiguanides, or essential oils (e.g., fennel, peppermint, caraway etc.). For example, a polymer coating formed by the composition as disclosed herein can comprise both (i) the N-halamine precursors and/or the activated N-halamine derivatives thereof and (ii) at least one additional biocide, and the degree of biocidal activity exerted by the N-halamines can be greater than that by the at least one additional biocide by at least about 0.5-fold, at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, at least about 50-fold, at least about 60-fold, at least about 70-fold, at least about 80-fold, at least about 90-fold, at least about 100-fold, or more. Alternatively, a polymer coating formed by the composition as disclosed herein can comprise both activated N-halamines and at least one additional biocide, and the degree of biocidal activity exerted by the at least one additional biocide can be greater than that by the activated N-halamines by at least about 0.5-fold, at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, at least about 50-fold, at least about 60-fold, at least about 70-fold, at least about 80-fold, at least about 90-fold, at least about 100-fold, or more.

In some embodiments, (i) a first type of biocidal moiety comprising the N-halamine precursors and/or activated N-halamines and (ii) a second type of biocidal moiety (e.g., not capable of forming a N-halamine, such as QAC) of the coating composition as disclosed herein can be coupled to each other. In some cases, the second type of biocidal moiety can be chemically conjugated to the first type of biocidal moiety, e.g., after preparation or synthesis of the first type of biocidal moiety (e.g., a polymeric molecule comprising a plurality of N-halamine precursors or activated N-halamine derivatives thereof). Alternatively, in some cases, the biocidal moiety can be a copolymer comprising (i) a first repeating unit comprising the first type of biocidal moiety and (ii) a second repeating unit comprising the second type of biocidal moiety. For example, the copolymer can be synthesized by subjecting first monomeric units comprising the first repeating unit and second monomeric units comprising the second repeating unit to polymerization.

In some cases, in the copolymer or a sample of the copolymer, the amount (e.g., weight percentage, number of repeating units, molar percentage, etc.) of the first repeating unit comprising the first type of biocidal moiety can be less than the amount of the second repeating unit comprising the second biocidal moiety by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some cases, in the copolymer or a sample of the copolymer, the amount (e.g., weight percentage, number of repeating units, molar percentage, etc.) of the second repeating unit comprising the second type of biocidal moiety can be less than the amount of the first repeating unit comprising the first type of biocidal moiety by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some cases, in the copolymer or a sample of the copolymer, the amount (e.g., weight percentage, number of repeating units, molar percentage, etc.) of the first repeating unit and the amount of the second repeating unit can be substantially the same.

In some embodiments, the coating composition as disclosed herein can have a single type of biocidal moiety, such as the N-halamine precursors and/or activated N-halamines thereof. In some embodiments, the coating composition as disclosed herein can be substantially free of the QACs.

The compositions of the present invention can comprise polymers that can form any number of N-halamines upon exposure to a halogen source (e.g., an electrophilic halogen source such as an electrophilic chlorine source). The polymers can comprise any number of N-halamine precursors that can form the N-halamines. The N-halamines can exhibit antimicrobial and/or anti-fouling activity or efficacy against microorganisms. Polymer coating composition can comprise or consist essentially of N-halamine precursors or N-halamines. Upon discharge, polymer coating composition can inactivate (e.g., kill immediately) any microorganisms on a substrate, while forming a coating over substrate to continue inactivation of any additional microorganisms for an extended period of time, e.g., for hours to days or to months. Upon transfer (e.g., discharge) of any number of oxidative halogen atoms from the N-halamines to microorganisms (e.g., bacteria), the compositions of the present invention can be re-exposed to the same or a different halogen source to regenerate (e.g., recharge) the N-halamines.

In some embodiments, the coating composition as disclosed herein can exhibit the right balance of stability and activity of N-halamine molecules, e.g., (i) exhibiting sufficient stability to meet the shelf-life target of biocidal products or cleaning products (e.g., greater than or equal to 6 months, greater than or equal to 1 year, greater than or equal to 2 years, or more), while (ii) maintaining the efficacy performance once applied and in-use, as disclosed herein.

In some embodiments, the coating composition as disclosed herein can comprise (A) the biocidal moiety as provided herein, such as a small molecule, compound, monomer, or polymer (e.g., homopolymer, copolymer) comprising an N-halamine precursor or the N-halamine derivative thereof. The coating composition can further comprise one or more of the following: (B1) an activator of the N-halamine precursor (e.g., a halogen), (B2) a binder (e.g., a polymeric binder), and (B3) one or more additives.

In some embodiments, a component of the coating composition can serve a plurality of purposes. For example, a QAC can serve as an additional type of biocidal moiety and an additive (e.g., anti-fouling moiety).

### Activators of One or More Biocidal Moieties:

In some embodiments, the coating composition as provided herein can comprise (A) the biocidal moiety as provided herein and (B1) the activator of the N-halamine precursor. The activator can comprise electrophilic halogen (e.g., electrophilic chlorine). In some embodiments, the electrophilic halogen can be bound to the N-halamine precursor that would otherwise be non-halogenated in absence of the electrophilic halogen, to form activated N-halamine such as N-halogenated halamine (e.g., N-chlorinated halamine). In some embodiments, the electrophilic halogen can be excess halogen that is not bound to the N-halamine precursor. For example, the excess electrophilic halogen can be part of a halogen source as provided herein (e.g., gaseous chlorine (Cl₂), hypochlorous acid (HOCl), sodium hypochlorite (NaOCl), sodium dichloroisocyanurate (NaDCC), potassium hypochlorite (KOCl), potassium dichloroisocyanurate (KDCC) gaseous iodine (I₂), potassium iodide (KI), sodium hypoiodite (NaIO), potassium hypoiodite (KIO), sodium gaseous bromine (Br₂) sodium hypobromite (NaBrO), potassium hypobromite (KBrO), or sodium dibromoisocyanurate (NaDBrC)).

In some embodiments, the activator of the biocidal moiety can comprise an electrophilic halogen source. In some embodiments, the halogen source can comprise chlorine. In some embodiments, the halogen source can comprise sodium chlorite. In some embodiments, the halogen source can comprise sodium hypochlorite. In some embodiments, the halogen source can comprise hypochlorous acid. In some embodiments, the halogen source can comprise sodium dichloroisocyanurate. In some embodiments, the halogen source can comprise potassium chlorite. In some embodiments, the halogen source can comprise potassium hypochlorite. In some embodiments, the halogen source can comprise potassium dichloroisocyanurate.

In some embodiments, (i) a first composition comprising biocidal moieties comprising non-halogenated N-halamine precursors (e.g., a polymer comprising a plurality of N-halamine precursors) can be mixed with (ii) a second composition comprising the activator of the N-halamine precursors. Prior to the mixing, the first composition and the second composition can be, respectively, a liquid composition and a liquid composition, a liquid composition and a solid composition, a liquid composition and a gaseous composition, a solid composition and a liquid composition, or a solid composition and a solid composition. For example, a liquid composition comprising the non-halogenated N-halamine precursors can be mixed with an additional liquid composition comprising the activator of the N-halamine precursors (e.g., an oxidative halogen-containing solution comprising a halogen source). In another example, a liquid composition comprising the non-halogenated N-halamine precursors can be mixed with a solid composition comprising the halogen source (e.g., sodium hypochlorite powder or tablet). In a different example, a solid composition comprising the non-halogenated N-halamine precursors (e.g., dry powder of non-halogenated N-halamine precursor polymers) can be mixed with a liquid composition comprising the activator of the N-halamine precursors (e.g., the oxidative halogen-containing solution).

In some embodiments, the ratio of (i) the number of activatable (e.g., halogenatable) N-halamine precursor sites in the first composition over (ii) the number of halogen source or halogen atoms (precursor:halogen) in the second composition can be about 1:1 or greater, e.g., at least or up to about 1:1, at least or up to about 1.1:1, at least or up to about 1.2:1, at least or up to about 1.3:1, at least or up to about 1.4:1, at least or up to about 1.5:1, at least or up to about 2:1, at least or up to about 3:1, at least or up to about 4:1, at least or up to about 5:1, at least or up to about 6:1, at least or up to about 7:1, at least or up to about 8:1, at least or up to about 9:1, at least or up to about 10:1, at least or up to about 15:1, or at least or up to about 20:1.

In some embodiments, the ratio of (i) the number of halogen source or halogen atoms in the second composition over (ii) the number of activatable N-halamine precursor sites in the first composition (halogen:precursor) can be about 1:1 or greater, e.g., at least or up to about 1:1, at least or up to about 1.1:1, at least or up to about 1.2:1, at least or up to about 1.3:1, at least or up to about 1.4:1, at least or up to about 1.5:1, at least or up to about 2:1, at least or up to about 3:1, at least or up to about 4:1, at least or up to about 5:1, at least or up to about 6:1, at least or up to about 7:1, at least or up to about 8:1, at least or up to about 9:1, at least or up to about 10:1, at least or up to about 15:1, or at least or up to about 20:1.

In some embodiments, the resulting mixture of the first composition and the second composition as abovementioned can be utilized to generate the coating composition or utilized as the coating composition, without any additional step of isolating for the biocidal moieties comprising the activated N-halamine derivatives (e.g., a polymer comprising N-chlorinated halamines) from any excess non-halogenated N-halamine precursors, excess halogen source, and/or byproducts from forming activated N-halamines (e.g., sodium hydroxide when sodium hypochlorite is used as the halogen source to form N-chlorinated halamines). In some embodiments, the resulting mixture (e.g., without the isolation step) can be a liquid composition, and such liquid composition can be utilized as the coating composition (e.g., a working coating composition, or a stock coating composition that can be further diluted by at least or up to about 1×, at least or up to about 2×, at least or up to about 3×, at least or up to about 4×, at least or up to about 5×, at least or up to about 10×, etc.).

In some embodiments, the resulting mixture of the first composition and the second composition as abovementioned can be further processed to isolate for the biocidal moieties comprising the activated N-halamine derivatives (e.g., the polymer comprising N-chlorinated halamines) from any excess non-halogenated N-halamine precursors, excess halogen source, and/or byproducts from forming activated N-halamines. Non-limiting examples of the isolation process can include precipitating out the activated N-halamine derivatives (e.g., via pH adjustment and/or addition of salts) and evaporating at least a portion of the mixture that is not the activated N-halamine derivatives, such as, for example, liquid solvent such as water and/or ethanol, at least a portion of excess non-halogenated N-halamine precursors, at least a portion of excess halogen source, and/or at least a portion of byproducts from forming activated N-halamines. In some embodiments, the isolation process can yield a solid product (e.g., dry powder) comprising or substantially consisting of the biocidal moieties comprising the activated N-halamine derivatives. In such solid product, an amount of the biocidal moieties comprising the activated N-halamine derivatives can be at least or up to about 70% by weight, at least or up to about 75% by weight, at least or up to about 80% by weight, at least or up to about 85% by weight, at least or up to about 90% by weight, at least or up to about 91% by weight, at least or up to about 92% by weight, at least or up to about 93% by weight, at least or up to about 94% by weight, at least or up to about 95% by weight, at least or up to about 96% by weight, at least or up to about 97% by weight, at least or up to about 98% by weight, at least or up to about 99% by weight, or substantially about 100% by weight.

In some embodiments, the isolation step reduces the amount of excess non-halogenated N-halamine precursors, excess halogen source, and/or byproducts from forming activated N-halamines in the resulting coating composition by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 95%, at least or up to about 99%, or more, as compared to that in a control composition that has not been subjected to the same isolation step.

In some embodiments, the first composition and the second composition as abovementioned can be provided as separate compositions without mixing, as separate components of the coating composition. For example, a user can be required to mix the first composition and the second composition, to generate the mixture that can be utilized to generate the coating composition. In some cases, the second composition comprising the halogen source can be provided as a solid, semi-solid, liquid, gel, powder, tablet, capsule, etc. For example, the halogen source can be provided as a dry effervescent tablet blended with sodium dichloroisocyanurate that dissolves in a liquid to create a hypochlorous acid solution. Alternatively, in some cases, the second composition comprising the halogen source can be provided as a liquid composition (e.g., an oxidative chlorine containing solution such as a sodium hypochlorite solution).

In some embodiments, as provided herein, the resulting mixture (e.g., a liquid coating composition) of the first composition and the second composition can exhibit a target pH value or range. In some embodiments, as provided herein, the biocidal moieties comprising the activated N-halamine derivatives (e.g., the polymer comprising N-chlorinated halamines) can be isolated from the resulting mixture, and subsequently re-dissolved in a liquid medium (e.g., deionized water) to generate a liquid coating composition exhibiting the target pH value or range. In some embodiments, the liquid coating composition can exhibit the target pH value or range in absence of any additional pH adjustment of the liquid coating composition. In some embodiments, the target pH value or range can be basic, neutral, or acidic. The target pH value of the liquid coating composition can be less than or equal to about 13, less than or equal to about 12, less than or equal to about 11, less than or equal to about 10, less than or equal to about 9, less than or equal to about 8.5, less than or equal to about 8, less than or equal to about 7, 6.5, less than or equal to about 6, less than or equal to about 5.5, less than or equal to about 5, less than or equal to about 4.5, less than or equal to about 4, less than or equal to about 3.5, less than or equal to about 3, less than or equal to about 2.5, less than or equal to about 2, less than or equal to about 1.5, less than or equal to about 1, or less. The target pH range of the liquid coating composition can be between about 3 and about 8, between about 3 and about 7, between about 3 and about 6, between about 3 and about 5, between about 3 and about 4, between about 4 and about 8, between about 4 and about 7, between about 4 and about 6, between about 4 and about 5, between about 5 and about 8, between about 5 and about 7, between about 5 and about 6, between about 6 and about 8, between about 6 and about 7, or between about 7 and about 8.

In some embodiments, the level of halogens or the halogen source in the coating composition can affect stability of the coating composition (e.g., stability of the N-halamines of the coating composition).

In some embodiments, the coating composition as disclosed herein can comprise a greater number of the halogen source (e.g., a greater number of chlorine atoms) than that of the N-halamine precursors. In some cases, the coating composition can comprise excess halogen source (e.g., sodium hypochlorite) than an amount of the halogen source needed to activate substantially all of the N-halamine precursors in the composition, e.g., to make the chlorine atoms bound in the N-halamines more stable. For example, substantially all of the N-halamine precursors of the coating composition can be activated N-halamine (e.g., N-chlorinated halamine), and the coating composition can further comprise excess amount of the halogen source.

In some cases, the number of chlorine atoms in the coating composition can be greater than the number of activatable N-halamine precursors by at least or up to about 0.5-fold, at least or up to about 1-fold, at least or up to about 2-fold, at least or up to about 3-fold, at least or up to about 4-fold, at least or up to about 5-fold, at least or up to about 6-fold, at least or up to about 7-fold, at least or up to about 8-fold, at least or up to about 9-fold, at least or up to about 10-fold, at least or up to about 15-fold, at least or up to about 20-fold, at least or up to about 30-fold, at least or up to about 40-fold, at least or up to about 50-fold, at least or up to about 60-fold, at least or up to about 70-fold, at least or up to about 80-fold, at least or up to about 90-fold, at least or up to about 100-fold, or more. The number of chlorine atoms in the coating composition can be greater than the number of activatable N-halamine precursors by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 95%, at least or up to about 99%, or more. The number of halogen atoms in the coating composition can be greater than the total number of activatable sites (e.g., the total number of amine, amide and/or imide (R—N—H—) sites) found in the N-halamine precursors by at least or up to about 0.5-fold, at least or up to about 1-fold, at least or up to about 2-fold, at least or up to about 3-fold, at least or up to about 4-fold, at least or up to about 5-fold, at least or up to about 6-fold, at least or up to about 7-fold, at least or up to about 8-fold, at least or up to about 9-fold, at least or up to about 10-fold, at least or up to about 15-fold, at least or up to about 20-fold, at least or up to about 30-fold, at least or up to about 40-fold, at least or up to about 50-fold, at least or up to about 60-fold, at least or up to about 70-fold, at least or up to about 80-fold, at least or up to about 90-fold, at least or up to about 100-fold, or more. The number of chlorine atoms in the coating composition can be greater than the total number of activatable sites (e.g., the total number of amine, amide and/or imide (R—N—H—) sites) found in the N-halamine precursors by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 95%, at least or up to about 99%, or more.

In some embodiments, the ratio of (i) the number of halogen source or halogen atoms (e.g., electrophilic chlorine) over (ii) the number of activatable N-halamine precursor sites (halogen:precursor) in the coating composition can be at least or up to about 1:1, at least or up to about 1.1:1, at least or up to about 1.2:1, at least or up to about 1.3:1, at least or up to about 0.4:1, at least or up to about 1.5:1, at least or up to about 2:1, at least or up to about 3:1, at least or up to about 4:1, at least or up to about 5:1, at least or up to about 6:1, at least or up to about 7:1, at least or up to about 8:1, at least or up to about 9:1, at least or up to about 10:1, at least or up to about 15:1, or at least or up to about 20:1.

In some embodiments, the number of the halogen source or halogen atoms (e.g., electrophilic chlorine atoms) present in the coating composition can be less than the number of the halogen source or halogen atoms required to activate substantially all of the activatable N-halamine precursor sites in the coating composition (e.g., less than the number of the activatable N-halamine precursor sites). Having a greater number of activatable N-halamine precursor sites than the number of halogen source or halogen atoms can promote an equilibrium state within the coating composition, in which substantially all of the halogen source or halogen atoms are utilized to halogenate the N-halamines (e.g., form N-chlorinated halamines) in the coating composition (e.g., yielding the coating composition that is substantially free of electrophilic chlorine that is not chemically bound to an N-halamine precursor).

In some embodiments, the number of the halogen source or halogen atoms can be less than the number of activatable N-halamine precursor sites by at least or up to about 0.10%, at least or up to about 0.2%, at least or up to about 0.5%, at least or up to about 1%, at least or up to about 2%, at least or up to about 3%, at least or up to about 4%, at least or up to about 5%, at least or up to about 6%, at least or up to about 7%, at least or up to about 8%, at least or up to about 9%, at least or up to about 10%, at least or up to about 15%, at least or up to about 20%, at least or up to about 25%, at least or up to about 30%, at least or up to about 40%, at least or up to about 50%, at least or up to about 60%, at least or up to about 70%, at least or up to about 80%, at least or up to about 90%, at least or up to about 0.1-fold, at least or up to about 0.5-fold, at least or up to about 1-fold, at least or up to about 2-fold, at least or up to about 3-fold, at least or up to about 4-fold, at least or up to about 5-fold, at least or up to about 6-fold, at least or up to about 7-fold, at least or up to about 8-fold, at least or up to about 9-fold, at least or up to about 10-fold, at least or up to about 15-fold, at least or up to about 20-fold, at least or up to about 30-fold, at least or up to about 40-fold, at least or up to about 50-fold, at least or up to about 60-fold, at least or up to about 70-fold, at least or up to about 80-fold, at least or up to about 90-fold, or at least or up to about 100-fold.

In some embodiments, the ratio of (i) the number of activatable N-halamine precursor sites over (ii) the number of halogen source or halogen atoms (precursor:halogen) in the coating composition can be at least or up to about 1:1, at least or up to about 1.1:1, at least or up to about 1.2:1, at least or up to about 1.3:1, at least or up to about 1.4:1, at least or up to about 1.5:1, at least or up to about 2:1, at least or up to about 3:1, at least or up to about 4:1, at least or up to about 5:1, at least or up to about 6:1, at least or up to about 7:1, at least or up to about 8:1, at least or up to about 9:1, at least or up to about 10:1, at least or up to about 15:1, or at least or up to about 20:1.

In some embodiments, in the coating composition, the number of the halogen source (or halogen atoms such as chlorine atoms) and the number of the activatable N-halamine precursor sites can be substantially the same.

### Binders:

In some embodiments, the coating composition can comprise (A) the biocidal moiety as provided herein and (B2) the binder. In some embodiments, the binder is not capable of forming a N-halamine. The binder can be substantially free of a N-halamine precursors or the N-halamine derivative thereof.

In some embodiments, the binder as disclosed herein (e.g., a binder comprising one or more vinyl functional groups) can be copolymerized with a N-halamine precursor or the N-halamine derivative thereof. In some embodiments, the binder can be provided separately from a polymer comprising the N-halamine precursor or the N-halamine derivative thereof.

In some embodiments, the binder as disclosed herein can facilitate carriage of the biocidal moiety (e.g. the N-halamine precursor and/or the N-halamine derivative thereof) on a target surface (e.g., a substrate surface). A combination of the binder and the biocides (e.g., activated N-halamines) can form a polymer coating (e.g., a thin protective film) on the substrate surface upon deposition and/or drying. For example, at initial deposition of the coating composition, chlorine media in the formulation disinfects the surface by inactivating existing bacteria. Subsequently, once the media dries, the coating formed on the surface can provide residual disinfection by continuously inactivating any bacteria that comes in contact with the surface (e.g., that comes in contact with the activated N-halamines).

In some embodiments, the biocidal moiety and the binder of the coating composition as disclosed herein can be separate molecules, e.g., two distinct molecules that are not covalently conjugated to each other. In some embodiments, in the coating composition, the amount (e.g., weight percentage, molar percentage, etc.) of the biocidal moiety can be less than the amount of the separate binder by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the coating composition, the amount (e.g., weight percentage, molar percentage, etc.) of the separate binder can be less than the amount of the biocidal moiety by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the coating composition, the amount (e.g., weight percentage, molar percentage, etc.) of the separate binder and the amount of the biocidal moiety can be substantially the same.

In some embodiments, the biocidal moiety and the binder (e.g., a polymer) of the coating composition as disclosed herein can be coupled to each other (e.g., covalently or non-covalently, e.g., via one or more hydrogen bonds). In some embodiments, the binder can be chemically conjugated to a polymeric molecule comprising a plurality of N-halamine precursors or activated N-halamine derivatives thereof, e.g., chemically conjugated after preparation or synthesis of the polymeric molecule. Alternatively, in some cases, the biocidal moiety can be a copolymer comprising (i) a first repeating unit comprising a N-halamine precursor or an activated N-halamine derivative thereof and (ii) a second repeating unit comprising the binder or a sub-unit thereof. For example, the copolymer can be synthesized by subjecting first monomeric units comprising the first repeating unit and second monomeric units comprising the second repeating unit to polymerization.

In some embodiments, in the copolymer or a sample of the copolymer, the amount (e.g., weight percentage, number of repeating units, molar percentage, etc.) of the first repeating unit can be less than the amount of the second repeating unit by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the copolymer or a sample of the copolymer, the amount (e.g., weight percentage, number of repeating units, molar percentage, etc.) of the second repeating unit can be less than the amount of the first repeating unit by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the copolymer or a sample of the copolymer, the amount (e.g., weight percentage, number of repeating units, molar percentage, etc.) of the first repeating unit and the amount of the second repeating unit can be substantially the same.

In some embodiments, the binder can be water-soluble, and thus presence of the binder can enhance solubility of the biocidal moiety in a liquid medium (e.g., aqueous medium such as deionized water). In some embodiments, polymers comprising the N-halamines (e.g., N-halamine precursors or the N-halamine derivative thereof) can comprise additional moieties that are water soluble (e.g., polyethylene glycol). The additional moieties can have one or more water-soluble moieties that can be well-solvated in aqueous environments and that can impart enhanced water dissolvability to the compound to which the moiety is attached, such as a copolymer comprising a first repeating unit of the N-halamines and an additional repeating unit of the water-soluble moieties. Non-limiting examples of water-soluble moieties include one or more functional groups comprising alcohol; polyalcohol; straight chain or cyclic saccharide; primary, secondary, tertiary, or quaternary amine; primary, secondary, tertiary, or quaternary polyamine; sulfate group or sulfonic acid group; carboxylate group or carboxylic acid group; phosphate group, phosphonate group, phosphoric acid group, or phosphonic acid group; ascorbate group or ascorbic acid group; glycol such as polyethylene glycol (PEG); and polyether.

In some embodiments, upon application of the coating composition and drying of the applied coating composition, the biocidal moiety can be presented by the binder surface coating. In some embodiments, the binder surface coating can be achieved via physical entrapment or chemical conjugation. In some embodiments, upon application of the coating composition and drying of the applied coating composition, the binder (e.g., a polymer) of the coating composition can bind or trap (e.g., non-covalently) the biocidal moiety (e.g., the small molecule biocidal moiety), to generate a biocidal surface coating.

In some embodiments, the binder of the coating composition as disclosed herein can comprise polymeric and/or small molecule organosilanes comprising one or more vinyl, -epoxide, -amino, -methacryloxy, and/or -alkyl functional groups. The binder can comprise siloxanes/polysiloxane-based binders or oxazoline-based binders. Non-limiting examples of the binder can include 3-aminopropyltriethoxysilane (e.g., Silanil 919), (3-glycidyloxypropyl)trimethoxysilane), 3-Aminopropyl(diethoxy)methylsilane, 3-chloropropyltrimethoxysilane, dimethyloctadecyl[3-(trimethoxysilyl)propyl]ammonium chloride, (3-Mercaptopropyl)trimethoxysilane, trimethoxyvinylsilane, γ-methacryloxypropyltrimethoxysilane, N-(6-Aminohexyl) Aminomethyl triethoxy silane, 3-(2-aminoethyl)-aminopropyltrimethoxysilane, 3-(m-Aminophenoxy) Propyl trimethoxysilane, 3-(Trimethoxysilyl)propyl methacrylate, and any combination thereof. Additional examples of the binder can include, but are not limited to, acrylic acid, poly(acrylic acid), vinyl acetate, poly(vinyl acetate), ethylene vinyl acetate, poly(ethylene oxide), poly(ethyleneglycol), vinyl alcohol, poly(vinyl alcohol), poly(ethyloxazoline), poly(dopamine), N-(3,4-dihydroxyphenethyl)methacrylamide, poly(2-ethyl-2-oxazoline) (e.g., Aquazol 500), acrylic and styrene-acrylic polymers (e.g., Acronal), carboxylated styrene-butadiene polymer (e.g., Styronal), and any combination thereof.

### Additives:

In some embodiments, the coating composition can comprise (A) the biocidal moiety as provided herein and (B3) the one or more additives. In some embodiments, the one or more additives of the coating composition as disclosed herein can comprise surfactants (e.g., non-ionic and/or ionic surfactants), anti-fouling compounds, pH adjusting agents, and/or antioxidants.

In some embodiments, the one or more additives can be mixed with the biocidal moiety in a solvent. In some embodiments, the biocidal moiety can comprise N-halamine precursors (e.g., a polymer comprising repeating units of N-halamine precursors), and the one or more additives can be mixed with the biocidal moiety prior to, simultaneously with, or subsequent to activation of the N-halamine precursors into N-halogenated halamine (e.g., N-chlorinated halamines). Upon mixing, the one or more additives can be physically mixed with or chemically conjugated to the biocidal moiety.

In some embodiments, in the coating composition, the amount (e.g., weight percentage, molar percentage, etc.) of the biocidal moiety can be less than the amount of the one or more additives by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the coating composition, the amount (e.g., weight percentage, molar percentage, etc.) of the one or more additives can be less than the amount of the biocidal moiety by at least or up to about 1%, at least or up to about 2%, at least or up to about 3%, at least or up to about 4%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, or at least or up to about 95%. In some embodiments, in the coating composition, the amount (e.g., weight percentage, molar percentage, etc.) of the one or more additives and the amount of the biocidal moiety can be substantially the same.

In some embodiments, surfactants as disclosed herein can include at least one non-ionic surfactant, at least one ionic surfactant, and/or at least one amphoteric surfactant. The surfactants can be wetting agents. The surfactants can be used to, e.g., promote uniform spreading of the composition as disclosed herein for forming a substantially uniform polymer coating. The surfactants can help to decrease surface tension between the coating composition and the surface for uniform coating. Non-limiting examples of surfactants can include Triton X-100, sorbitan alkyl esters, block copolymers of polyethylene glycol and polypropylene glycol, sodium lauryl ether sulfate, dioctyl sodium sulfosuccinate, sodium stearate, 3-[(3-cholamidopropyl) dimethylammonio]-1-propanesulfonate), [2-(Methacryloyloxy)ethyl]dimethyl-(3-sulfopropyl)ammonium hydroxide, cocamidopropyl betaine (CAPB), and any combination thereof.

Non-limiting examples of cationic surfactants can include QACs that have antimicrobial properties (e.g., benzalkonium chloride).

In some embodiments, an anti-fouling compound can be added to the composition as disclosed herein. Non-limiting examples of the anti-fouling compounds can include non-ionic hydrophilic compounds (e.g., oligo(ethylene glycol) (OEG), poly(ethylene glycol) (PEG), propylene suloxide, polyglycerol dendrons, polyoxazoline polymer, polypeptide, polypeptoid, dextran, mannitol, etc.), zwitterionic compounds (e.g., phosphobetaine (PB), sulfobetaine (SB), carboxybetaine (CB), phosphorylcholine (PC), polyampholyte polymers, etc.), and amphiphilic compounds (e.g., polymer with perfluoroalkyl tagged OEG as side chains, hyperbranched amphiphilic fluoropolymers, etc.). For example, the anti-fouling compound can be zwitterionic compounds and/or or polymers. The zwitterionic compounds can be derived from phosphorylcholine, carboxylbetaine, and/or or sulfobetaine. Non-limiting examples of the zwitterionic compounds can include [2-(methacryloyloxy)ethyl]dimethyl-(3-sulfopropyl)ammonium hydroxide, polysulfobetaines, and any combination thereof.

In some embodiments, the anti-fouling compound as disclosed herein can be copolymerized with a N-halamine precursor or the N-halamine derivative thereof. In some embodiments, the anti-fouling compound can be provided separately from a polymer comprising the N-halamine precursor or the N-halamine derivative thereof.

Non-limiting examples of the pH adjusting agents as disclosed herein can include sodium hydroxide, hydrochloric acid, citric acid, malic acid, tartaric acid, acetic acid, phosphoric acid, maleic acid, glycine, sodium lactate, lactic acid, sodium citrate, ascorbic acid, sodium acetate, acetic acid, sodium bicarbonate, sodium carbonate, carbonic acid, sodium succinate, succinic acid, sodium benzoate, benzoic acid, sodium phosphates, tris(hydroxymethyl)aminomethane, histidine, histidine hydrochloride, and any combination thereof.

Non-limiting examples of the antioxidants as disclosed herein can include Vitamin C (ascorbic acid), Vitamin E, glutathione, lipoic acid, melatonin, uric acid, carotenes, ubiquinol, resveratrol, tocopherols, polyphenols, selenium, flavonoids, phosphite antioxidants (e.g., PUREfos 168 or RICHFOS 158), or phenolic antioxidants (e.g., Synox-3114 or Synox-1135) and any combination thereof.

### Additional Details of Coating Compositions:

In some embodiments, the coating composition as disclosed herein can be formulated as a liquid formulation. The liquid formulation can be usable by an end user to generate a biocidal coating on a surface of an object. In some cases, the liquid formulation can comprise a halogen source (e.g., sodium hypochlorite) or halogen atoms (e.g., electrophilic chlorine), and the liquid formulation can be characterized to have a high pH (e.g., greater than or equal to pH of about 7, greater than or equal to pH of about 7.5, greater than or equal to pH of about 8, greater than or equal to pH of about 8.5, greater than or equal to pH of about 9, greater than or equal to pH of about 9.5, greater than or equal to pH of about 10, greater than or equal to pH of about 10.5, greater than or equal to pH of about 11, greater than or equal to pH of about 11.5, greater than or equal to pH of about 12, greater than or equal to pH of about 12.5, greater than or equal to pH of about 13, greater than or equal to pH of about 13.5, or greater than or equal to pH of about 14, e.g., to maintain stability of the halogen source. In some embodiments, the liquid formulation can comprise a halogen source (e.g., sodium dichloroisocyanurate) or halogen atoms (e.g., electrophilic chlorine), and the liquid formulation can be characterized to have a pH that is less than or equal to about 6.5, less than or equal to about 6, less than or equal to about 5.5, less than or equal to about 5, less than or equal to about 4.5, less than or equal to about 4, less than or equal to about 3.5, less than or equal to about 3, less than or equal to about 2.5, less than or equal to about 2, less than or equal to about 1.5, or less than or equal to about 1.

In some embodiments, the coating composition can be a solid formulation (e.g., a dry effervescent tablet) that dissolves in a liquid to form a liquid formulation usable to form a biocidal polymer coating, as disclosed herein. Upon dissolving the solid formulation in the liquid, the resulting liquid formulation can be characterized to have a reduced pH value (e.g., relative to a normal pH value of 7), while having the N-halamines activated (e.g., halogenated) for residual disinfection. In some embodiments, the coating composition as disclosed herein can be a solid formulation (e.g., a dry effervescent tablet) that dissolves in a liquid to form a polymer coating formulation. Upon dissolving the solid formulation in a solution, the resulting liquid formulation can be characterized to have N-halamine precursor or derivatives thereof to be used for residual disinfection after deposition on a target surface.

Whether provided initially as a liquid formulation or a solid formulation that is processed to form a liquid formulation, the activated N-halamines (e.g., N-chlorinated halamines) in the resulting liquid formulation can remain substantially activated (e.g., halogenated) once formed into a polymer coating on a substrate surface, e.g., for a duration of time until substantially all the oxidative halogen (e.g., oxidative chlorine) is exhausted.

Solvents usable to prepare the liquid formulation as disclosed herein can include water (e.g., deionized water), alcohols, polyols, alkyl glycol ethers, esters, and ketones. Suitable alcohols include but are not limited to low molecular weight C1 to C8 alcohols, such as methanol, ethanol, n-propanol, iso-propanol, butanol, and pentanol. Non-limiting examples of the alkyl glycol ethers can include ethylene glycol monopropyl ether, diethylene glycol monoethyl ether, diethylene glycol monobutyl ether, propylene glycol methyl ether acetate, dipropylene glycol n-butyl ether, and tripropylene glycol methyl ether. Non-limiting examples of polyols can include ethylene glycol, propylene glycol, diethylene glycol, 1,4-butylene glycol, and dipropylene glycol. Non-limiting examples of ketones can include acetone, ethyl methyl ketone, and methyl phenyl ketone. In some embodiments, solvents of the liquid formulation can be water, ethanol, isopropanol, methanol, ethylene glycol monopropyl ether, and any combination thereof. In some embodiments, the liquid formulation can comprise water. In some embodiments, the liquid formulation can comprise a mixture comprising (i) water and (ii) one or more alcohols disclosed herein. The ratio of (i) the amount (e.g., weigh percentage, volume percentage, etc.) of water and (ii) the amount of the one or more alcohols (e.g., ethanol) can range between about 99:1 and about 1:99, e.g., at least or up to about 1:99, at least or up to about 5:95, at least or up to about 10:90, at least or up to about 15:85, at least or up to about 20:80, at least or up to about 25:75, at least or up to about 30:70, at least or up to about 35:65, at least or up to about 40:60, at least or up to about 45:55, at least or up to about 50:50, at least or up to about 55:45, at least or up to about 60:40, at least or up to about 65:35, at least or up to about 70:30, at least or up to about 75:25, at least or up to about 80:20, at least or up to about 85:15, at least or up to about 90:10, at least or up to about 95:5, or at least or up to about 99:1.

In some embodiments, the solid formulation disclosed herein can comprise a single solid formulation (e.g., a single tablet, such as a single effervescent tablet) comprising (i) a halogen source (e.g., sodium hypochlorite) and (ii) the N-halamine precursor and/or the activated N-halamine derivative thereof as disclosed herein. In some embodiments, the solid formulation disclosed herein can comprise a plurality of different solid formulations comprising (i) a first solid formulation (e.g., a first tablet) comprising the halogen source and (ii) a second solid formulation comprising the N-halamine precursor and/or the activated N-halamine derivative thereof. For example, the second solid formulation can comprise N-halamine precursors, such that when the first solid formulation and the second solid formulation are mixed in a solvent (e.g., dissolved in a liquid), the N-halamine precursor can be activated (e.g., halogenated) by the halogen from the halogen source of the first solid formulation. Whether provided as a single solid formulation or as a plurality of different solid formulations, as disclosed herein, the N-halamine precursor and/or the activated N-halamine derivative thereof can be mixed (e.g., within the solid formulation, or subsequent to dissolution into a solvent) with other components as disclosed herein, such as the binder, to, e.g., ensure proper dissolution or polymer coating formation. Such a solid formulation could be subsequently mixed with a solvent that is also halogenated to provide the halogenation. Alternatively, such solid formulation can comprise an amount of the halogen source that yields a degree of halogenation of the N-halamine precursors in the formulation (e.g., at least or up to about 1%, at least or up to about 2%, at least or up to about 5%, at least or up to about 10%, at least or up to about 20%, at least or up to about 30%, at least or up to about 40%, at least or up to about 50%, at least or up to about 55%, at least or up to about 60%, at least or up to about 65%, at least or up to about 70%, at least or up to about 75%, at least or up to about 80%, at least or up to about 85%, at least or up to about 90%, at least or up to about 91%, at least or up to about 92%, at least or up to about 93%, at least or up to about 94%, at least or up to about 95%, at least or up to about 96%, at least or up to about 97%, at least or up to about 98%, at least or up to about 99%, or substantially about 100%), in absence of mixing in any additional halogen source.

In some embodiments, a concentration of the biocidal molecule (e.g., a molecule comprising at least the biocidal moiety, such as a polymer or a copolymer) in the coating composition (e.g., a liquid coating composition) can be at least or up to about 0.1 grams of the biocidal molecule per 1 liter of the liquid coating composition (g/L), at least or up to about 0.2 g/L, at least or up to about 0.3 g/L, at least or up to about 0.4 g/L, at least or up to about 0.5 g/L, at least or up to about 0.6 g/L, at least or up to about 0.7 g/L, at least or up to about 0.8 g/L, at least or up to about 0.9 g/L, at least or up to about 1 g/L, at least or up to about 1.5 g/L, at least or up to about 2 g/L, at least or up to about 3 g/L, at least or up to about 4 g/L, at least or up to about 5 g/L, at least or up to about 6 g/L, at least or up to about 7 g/L, at least or up to about 8 g/L, at least or up to about 9 g/L, at least or up to about 10 g/L, at least or up to about 12 g/L, at least or up to about 15 g/L, at least or up to about 20 g/L, at least or up to about 30 g/L, at least or up to about 40 g/L, or at least or up to about 50 g/L.

In some embodiments, the N-halamine precursor as disclosed herein can be halogenated, e.g., at least one nitrogen atom (e.g., amine, amide, or imide group) of the N-halamines is conjugated to a halogen atom, such as Cl, Br, or I. The activatable N-halamine precursor as disclosed herein can comprise at least one nitrogen atom (e.g., amine, amide, or imide group) that is hydrogenated (e.g., secondary amine) instead of being halogenated.

In some embodiments, the biocide can form a single type of activated N-halamines or a plurality of types of activated N-halamines. Non-limiting examples of N-halamine precursors or N-halamine derivatives thereof can include aliphatic N-halamine, heterocyclic N-halamine, N-halamine monomer which contains at least a vinyl group, polymeric N-halamines that are homopolymers, heteropolymers, or a combination thereof.

### Molecules Comprising the Biocidal Moieties:

In some embodiments, the N-halamine as disclosed herein can be derived from an imidazolidine having the structure:

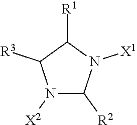

wherein X¹ and X² are independently hydrogen atoms or halogen atoms (e.g., Cl, Br, or I) and R¹, R², and R³ are independently hydrogen atoms, oxygen atoms, vinyl groups, linear or branched alkyl groups containing, e.g., from 1 to about 12 carbon atoms, or more. In some embodiments, at least one of the R¹, R², and R³ is independently an oxygen atom.

Non-limiting examples of N-halamines can include N-halamines are likely 1,3-dichloro-2,2,5,5-tetramethylimidazolidin-4-one, 1-chloro-2,2,5,5-tetramethylimidazolidin-4-one, trichloroisocyanuric acid, potassium dichloroisocyanurate, sodium dichloroisocyanurate, 1-bromo-5,5-dimethylhydantoin, 1-chloro-5,5-dimethylhydantoin, N-chloro-2,2,6,6-tetramethyl-4-piperidinol laurate, [N-(2-methyl-1-(4-methyl-2,5-dioxoimidazolidin-4-yl)propan-2-yl)acrylamide], and any combination thereof.

In some embodiments, fully or partially halogenated N-halamines can be utilized. In some embodiments, the number of different types of N-halamines in the composition as disclosed herein can be selected to, e.g., control properties (e.g., biocidal properties) and/or stabilities of such composition.

In some embodiments, N-halamines of the composition as disclosed herein can comprise low molecular weight N-halamines and/or high molecular weight N-halamines. In some embodiments, N-halamines of the composition as disclosed herein can be provided in polymers, such as homo- and/or hetero-polymers, such as co-polymers, ter-polymers polymerized. The polymers can be formed with any suitable monomers to obtain such desired compounds with wide range of molecular weights.

In some embodiments, the coating composition as disclosed herein can comprise activated N-halamines, such that the coating comprises activated N-halamines upon formation. In some embodiments, the coating composition as disclosed herein can comprise activatable N-halamine precursors, such that the coating formed by the composition can require an additional activation step (e.g., halogenation step) to exhibit sufficient biocidal activity.

The polymers of the present invention comprising any number of N-halamines can withstand at least or up to 1 discharge-recharge cycle, at least or up to 2 discharge-recharge cycles, at least or up to 3 discharge-recharge cycles, at least or up to 4 discharge-recharge cycles, at least or up to 5 discharge-recharge cycles, at least or up to about 10 discharge-recharge cycles, at least or up to about 15 discharge-recharge cycles, at least or up to 20 discharge-recharge cycles, at least or up to about 30 discharge-recharge cycles, at least or up to about 40 discharge-recharge cycles, at least or up to about 50 discharge-recharge cycles, at least or up to about 60 discharge-recharge cycles, at least or up to about 70 discharge-recharge cycles, at least or up to about 80 discharge-recharge cycles, at least or up to about 90 discharge-recharge cycles, at least or up to about 100 discharge-recharge cycles, at least or up to about 200 discharge-recharge cycles, at least or up to about 300 discharge-recharge cycles, at least or up to about 400 discharge-recharge cycles, at least or up to about 500 discharge-recharge cycles, or at least or up to about 1,000 discharge-recharge cycles.

The polymers of the present invention can comprise a repeating unit that can form a halogenated N-halamine when exposed to an electrophilic halogen source. The repeating unit can comprise any number of N-halamine precursors that can from an N-halamine (e.g., halogenated N-halamine). An N-halamine precursor can be a part of the backbone of the repeating unit and/or a part of a side chain of the repeating unit. The N-halamine precursor can comprise a nitrogen atom bound to a hydrogen atom. The N-halamine precursor can be a part of, for example, primary or secondary amines, amides, imides, cyclic amines (e.g., hydantoins, piperazines, etc.), cyclic amides, or cyclic imides. The N-halamine precursor can be a part of a non-heterocyclic compound. Alternatively, the N-halamine precursor can be a part of a heterocyclic compound. A heterocycle can be aromatic (heteroaryl) or non-aromatic. Non-limiting examples of heterocycles include pyrrole, pyrrolidine, pyridine, piperidine, succinimide, maleimide, morpholine, and imidazole. Non-limiting examples of heterocycles include heterocyclic units having a single ring containing one or more heteroatoms, non-limiting examples of which include, imidazolidinyl, oxazolidinyl, oxazolidinonyl, hydantoinyl, and piperazinyl.

Upon exposure to an electrophilic halogen source, the N-halamine precursor can form a nitrogen-halogen covalent bond, for example, a nitrogen-fluorine bond, a nitrogen-chlorine bond, a nitrogen-bromine bond, a nitrogen-iodine bond, or a combination thereof. The N-halamine precursor can form any number of nitrogen-halogen covalent bonds, for example, at least or up to 1 nitrogen-halogen covalent bond, at least or up to 2 nitrogen-halogen covalent bonds, at least or up to 3 nitrogen-halogen covalent bonds, at least or up to 4 nitrogen-halogen covalent bonds, at least or up to 5 nitrogen-halogen covalent bonds, at least or up to 6 nitrogen-halogen covalent bonds, at least or up to 7 nitrogen-halogen covalent bonds, at least or up to 8 nitrogen-halogen covalent bonds, at least or up to 9 nitrogen-halogen covalent bonds, at least or up to 10 nitrogen-halogen covalent bonds, at least or up to about 15 nitrogen-halogen covalent bonds, or at least or up to about 20 nitrogen-halogen covalent bonds.

The polymers of the present invention can form a single type of N-halamine. Alternatively, the polymers can form a plurality of different types of N-halamines, for example, two or more different types of N-halamines. The different types of N-halamines can have different structures and/or different numbers of nitrogen-halogen covalent bonds.

An N-halamine precursor (or the N-halamine derivative thereof) can be a part of a side chain of a repeating unit of the polymer. The side chain can comprise any type of linker moiety between the N-halamine precursor and the backbone of the polymer. The linker moiety can be hydrophobic or hydrophilic. Non-limiting examples of the linker moiety include an ester, ether, thioether, ethyleneglycol, alkylene, alkenylene, alkynylene, heteroalkylene, cycloalkylene, heterocyclylene, arylene, heteroarylene, and heterocycloalkylene group, any of which can be substituted or unsubstituted. In some embodiments, a linker is not present.

In some embodiments, the N-halamine precursor comprises a nitrogen-containing heterocycle. A nitrogen-containing heterocycle can form at least or up to about 1 nitrogen-halogen covalent bond. A nitrogen-containing heterocycle can form at least or up to about 2 nitrogen-halogen covalent bonds. The N-halamine precursor can comprise at least or up to 1 nitrogen-containing heterocycle, at least or up to 2 nitrogen-containing heterocycles, at least or up to 3 nitrogen-containing heterocycles, at least or up to 4 nitrogen-containing heterocycles, at least or up to 5 nitrogen-containing heterocycles, at least or up to 6 nitrogen-containing heterocycles, at least or up to 7 nitrogen-containing heterocycles, at least or up to 8 nitrogen-containing heterocycles, at least or up to 9 nitrogen-containing heterocycles, or at least or up to 10 nitrogen-containing heterocycles.

The nitrogen-containing heterocycle can comprise a hydantoin group. The hydantoin group can have the structure:

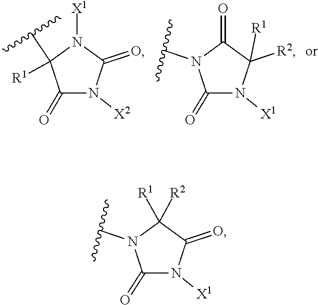

wherein: X¹ is H or halogen; X² is H or halogen; R¹ is H or C₁-C₄ alkyl; and R² is H or C₁-C₄ alkyl.

In some embodiments, the hydantoin group has the structure:

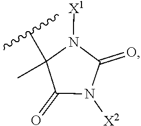

wherein: X¹ is H or halogen; and X² is H or halogen. In some embodiments, X¹ is H and X² is H. In some embodiments, X¹ is Cl and X² is Cl. In some embodiments, one of X¹ and X² is Cl and one of X¹ and X² is H.

In some embodiments, the nitrogen-containing heterocycle can be a six-membered ring with at least one heteroatom. In some embodiments, the nitrogen-containing heterocycle is an unsubstituted or substituted piperidinyl ring. In some embodiments, the nitrogen-containing heterocycle is 2,2,6,6-tetramethyl-4-piperidinyl methacrylate. In some embodiments, the nitrogen-containing heterocycle can have the structure:

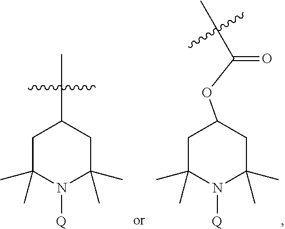

wherein Q is independently H, Cl, Br, or I. In some embodiments, the nitrogen-containing heterocycle can have the structure:

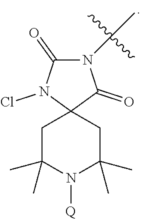

The polymers of the present invention can comprise at least one species of repeating unit. The polymers can comprise at least or up to 1 species of repeating unit, at least or up to 2 different species of repeating unit, at least or up to 3 different species of repeating unit, at least or up to 4 different species of repeating unit, at least or up to 5 different species of repeating unit, at least or up to 6 different species of repeating unit, at least or up to 7 different species of repeating unit, at least or up to 8 different species of repeating unit, at least or up to 9 different species of repeating unit, at least or up to 10 different species of repeating unit.

An average degree of polymerization of a species of repeating unit in a sample of a polymer can be at least or up to about 4, at least or up to about 5, at least or up to about 6, at least or up to about 7, at least or up to about 8, at least or up to about 9, at least or up to about 10, at least or up to about 11, at least or up to about 12, at least or up to about 13, at least or up to about 14, at least or up to about 15, at least or up to about 16, at least or up to about 17, at least or up to about 18, at least or up to about 19, at least or up to about 20, at least or up to about 25, at least or up to about 30, at least or up to about 35, at least or up to about 40, at least or up to about 45, at least or up to about 50, at least or up to about 60, at least or up to about 70, at least or up to about 80, at least or up to about 90, at least or up to about 100, at least or up to about 200, at least or up to about 300, at least or up to about 400, at least or up to about 500, at least or up to about 600, at least or up to about 700, at least or up to about 800, at least or up to about 900, at least or up to about 1,000, at least or up to about 2,000, at least or up to about 3,000, at least or up to about 4,000, at least or up to about 5,000, at least or up to about 6,000, at least or up to about 7,000, at least or up to about 8,000, at least or up to about 9,000, at least or up to about 10,000, at least or up to about 15,000, at least or up to about 20,000, at least or up to about 25,000, at least or up to about 30,000, at least or up to about 35,000, at least or up to about 40,000, at least or up to about 45,000, at least or up to about 50,000, or at least or up to about 100,000.

The polymers of the present invention can comprise homopolymers. The homopolymers can comprise a single species of repeating unit. In some embodiments, the single species of repeating unit forms any number of N-halamines as provided herein. For example, the single species of repeating unit comprises an N-halamine precursor (or the N-halamine derivative thereof). In another example, the single species of repeating unit comprises (i) an N-halamine precursor (or the N-halamine derivative thereof) and (ii) a non-fouling moiety, as disclosed herein. In some embodiments, the single species of repeating unit in the homopolymers does not comprise a non-fouling moiety.

The polymers of the present invention can comprise copolymers, for example, bipolymers, terpolymers, and quaterpolymers. The copolymers can comprise alternating copolymers, random copolymers, statistical copolymers, segmented polymers, block copolymers, multiblock copolymers, gradient copolymers, graft copolymers, star copolymers, branched copolymers, hyperbranched copolymers, and any combination thereof. The copolymers can comprise two or more species of repeating unit that are different from one another. The copolymers can comprise at least or up to 2 different species of repeating unit, at least or up to 3 different species of repeating unit, at least or up to 4 different species of repeating unit, at least or up to 5 different species of repeating unit, at least or up to 6 different species of repeating unit, at least or up to 7 different species of repeating unit, at least or up to 8 different species of repeating unit, at least or up to 9 different species of repeating unit, or at least or up to 10 different species of repeating unit.

A copolymer of the present invention can comprise a plurality (e.g., two or more) different species of repeating unit, wherein each species of the plurality of different species of repeating unit can form any number of N-halamines. In some embodiments, two different species of repeating unit can comprise different structures of N-halamine precursors (or the N-halamine derivative thereof). In some embodiments, two different species of repeating unit can comprise (i) the same structure of N-halamine precursor (or the N-halamine derivative thereof), but (ii) different monomeric derivatives and/or different linker moieties between the respective N-halamine precursor and the copolymer backbone.

A copolymer of the present invention can comprise (i) a first species of repeating unit that can form any number of N-halamines as provided herein and (ii) a second species of repeating unit that does not form an N-halamine (e.g., any one of the additional biocides, binders, etc.). In some embodiments, the second species of repeating unit lacks a side chain and is present to control a density of the N-halamine precursor (or the N-halamine derivative thereof) from the first species of repeating unit in a final copolymer molecule. In some embodiments, the second species of repeating unit comprises at least one functional moiety to endow at least one additional function (e.g., water-solubility, antimicrobial, and/or anti-fouling activity) to the final copolymer. The functional moiety can be a part of the backbone of the second species of repeating unit. Alternatively or additionally, the functional moiety can be a part of a side chain of the second species of repeating unit. In some embodiments, the second species of repeating unit can comprise any one of the binders as disclosed herein (e.g., one or more binders with vinyl functional groups).

In some embodiments, the molar ratio of the first species and the second species of the copolymer can be about the same (e.g., within a range that is 10%, 5%, 2%, or 1% greater or less than the numerical value) or substantially the same as feed ratio (e.g., molar ratio) of the respective monomers of the first species and the second species added during polymerization of the copolymer. The feed ratio can range between about 99:1 and about 1:99, e.g., at least or up to about 1:99, at least or up to about 5:95, at least or up to about 10:90, at least or up to about 15:85, at least or up to about 20:80, at least or up to about 25:75, at least or up to about 30:70, at least or up to about 35:65, at least or up to about 40:60, at least or up to about 45:55, at least or up to about 50:50, at least or up to about 55:45, at least or up to about 60:40, at least or up to about 65:35, at least or up to about 70:30, at least or up to about 75:25, at least or up to about 80:20, at least or up to about 85:15, at least or up to about 90:10, at least or up to about 95:5, or at least or up to about 99:1.

In some embodiments, a repeating unit of the polymer of the present invention can comprise a moiety usable for polymerization of the polymer. Non-limiting examples of moieties usable for polymerization include acrylonitrile, styrene, acrylamide, methyl-methacrylate, ethylene, propylene, butylenes, butadienes, other alkenes and dienes, moities and derivatives thereof (e.g., derivatives comprising any number of N-halamine precursors and/or N-halamines). Additional non-limiting examples of moities include (i) polar acrylate or acrylic moieties, such as those having nitrile functional groups including methacrylonitrile, 2-cyanoethylacrylate, and 2-cyanoethylmethacrylate, (ii) nonpolar acrylate moieties, such as methyl acrylate, ethyl acrylate, ethyl methacrylate, n-propyl acrylate, propyl methacrylate, n-butyl acrylate, n-butyl methacrylate, isobutyl acrylate, isobutyl methacrylate, t-butyl acrylate, pentyl acrylate, hexyl acrylate, cyclohexyl acrylate, and n-octyl acrylate, (iii) aldehydic moieties, such as acrolein and methacrolein, (iv) hydroxy-containing moieties, such as 2-hydroxyethyl acrylate (HEA), 2-hydroxyethyl methacrylate (HEMA), 2-hydroxypropylacrylate, and 2-hydroxypropylmethacrylate, (v) anhydride moieties, such as maleic anhydride and itaconic anhydride, (vi) aromatic moieties, such as alpha-methylstyrene, phenyl acrylate, phenyl methacrylate, benzyl acrylate, and benzyl methacrylate, and (vii) derivatives and/or combinations thereof.

In some embodiments, a repeating unit of the polymer of the present invention can be derived from an acrylamide monomer. Non-limiting examples of an acrylamide monomer include acrylamide and substituted acrylamides, such as methacrylamide, ethylacrylamide, crotonamide, N-methyl acrylamide, N-butyl acrylamide, and N-ethyl methacrylamide.

In some embodiments, a small molecule biocidal moiety (e.g., a non-polymeric biocidal moiety) of the present invention can be derived from a small molecule having the structure:

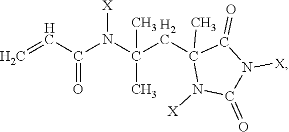

wherein X can be independently H atom, or halogen atom (e.g. Cl, Br, and I).

In some embodiments, a large molecule biocidal moiety (e.g., a polymeric biocidal moiety) of the present invention can be derived from a monomeric unit having the structure:

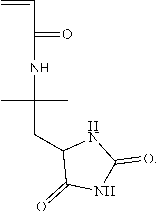 [SMILES: C=CC(=O)NC(C)(C)CC1NC(=O)NC1=O]

In some embodiments, a small molecule biocidal moiety (e.g., a non-polymeric biocidal moiety) of the present invention can be derived from a small molecule having the structure:

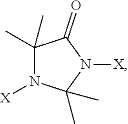

wherein X can be independently H atom, or halogen atom (e.g. Cl, Br, and I).

In some embodiments, a repeating unit of the polymer of the present invention can form at least one N-halamine and has the structure:

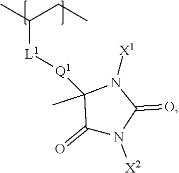

wherein: L¹ is an amide, ester, or arylene group; Q¹ is alkylene or absent; X¹ is H or halogen; and X² is H or halogen. In some embodiments, Q¹ is methylene, ethylene, propylene, or butylene. In some embodiments, Q¹ is methylene. In some embodiments, Q¹ is ethylene. In some embodiments, Q¹ is propylene. In some embodiments, Q¹ is butylene. In some embodiments, Q¹ is 1,1-dimethylethylene.

In some embodiments, the repeating unit of the polymer of the present invention has the structure:

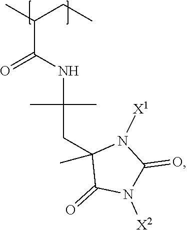

wherein: X¹ is H or halogen; and X² is H or halogen. In some embodiments, X¹ is H and X² is H. In some embodiments, X¹ is Cl and X² is Cl. In some embodiments, one of X¹ and X² is Cl and one of X¹ and X² is H.

In some embodiments, the second species of repeating unit of the copolymer can comprise a water-soluble moiety as provided herein as a side chain (e.g., quaternary amine compounds, amide compounds, carboxylic acid compounds, sulfonic acid compounds, phosphoric acid compounds, phosphonic acid compounds, etc.). In some embodiments, the second species of repeating unit can comprise (e.g., as part of the side chain) alcohol, ether, aldehyde, ketone, carboxylic acid, ester, amine (e.g., including heterocyclic amine), amide, imine, etc. In some embodiments, the second species of repeating unit can comprise a polymerizable bond (e.g., C═C double bond) and one or more of carboxylic acid functional group, sulfonic acid functional group, phosphoric acid functional group, phosphonic acid functional group, etc.

Non-limiting examples of the second species of repeating unit comprising a quaternary amine or quaternary ammonium functional group can include diallyldimethyl ammonium chloride quaternized (DADMAC), dimethylaminoethyl methacrylate quaternized (DMAEMA), dimethylaminoethyl acrylate (DMAEA), methacrylamidopropyltrimethylammonium chloride (MAPTAC), and diallyldiethylammonium chloride (DADDEAC), 2-(Methacryloyloxy)ethyl trimethylammonium chloride, 3-acrylamidopropyl trimethylammonium chloride, modifications thereof, derivatives thereof, and salts thereof.

Non-limiting examples of the second species of repeating unit comprising a carboxylic acid functional group can include acrylic acid, methacrylic acid, beta-carboxyethyl acrylate, crotonic acid, glutaconic acid, itaconic acid, fumaric acid, maleic acid, maleic anhydride, modifications thereof, derivatives thereof, and salts thereof.

Non-limiting examples of the second species of repeating unit comprising a sulfonic acid functional group can include vinylsulfonic acid, allylsulfonic acid, styrenesulfonic acid, sulfoethyl acrylate, sulfoethyl methacrylate, sulfopropyl acrylate, sulfopropyl methacrylate, 2-hydroxy-3-methacryloxypropyl sulfonic acid, 2-acrylamido-2-methyl-1-propanesulfonic acid, 3-allyloxy-2-hydroxy-1-propanesulfonic acid, 2-methyl-2-propene-1-sulfonic acid, modifications thereof, derivatives thereof, and salts thereof.

Non-limiting examples of the second species of repeating unit comprising a phosphoric acid or phosphonic acid functional group include methacryloyloxyethyl dihydrogen phosphate, phosphoethyl methacrylate, phosphopropyl methacrylate, vinylphosphonic acid, allylphosphonic acid, 2-acrylamido-2-methylpropanephosphonic acid, modifications thereof, derivatives thereof, and salts thereof.

In some embodiments, the second species of repeating unit can comprise a vinyl moiety as part of the polymerizable functional group (e.g., to copolymerize with the first species of repeating unit that also comprises a vinyl moiety). Non-limiting examples of the second species of repeating unit (e.g., that enhances water solubility or dissolvability of the resulting copolymer) can include acrylic acid, acrylamide, n-vinylpyrrolidione, 2-vinlypyridine, vinylphosphonic acid, N-vinylacetamide, methacrylamide, 3-allyloxy-1,2, propanediol, methacrylic acid, etc.

In some embodiments, the disclosure provides a copolymer comprising a plurality of units of a first repeating group and a plurality of units of a second repeating group, wherein: the first repeating group or a portion thereof is:

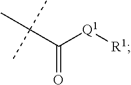

the second repeating group or a portion thereof is:

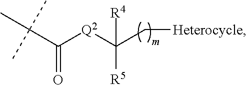

wherein Q¹ is O, NH, or N(C₁-C₃-alkyl); Q² is O, NH, or N(C₁-C₃-alkyl); R¹ is H, —C(R²)(R³)(CH₂)ₙ-Charged Group; R² is H or C₁-C₃-alkyl; R³ is H or C₁-C₃-alkyl; R⁴ is H or C₁-C₃-alkyl; R⁵ is H or C₁-C₃-alkyl; m is 0, 1, 2, 3, 4, or 5; n is 0, 1, 2, 3, 4, or 5; Charged Group is an ionized or ionizable moiety; and Heterocycle is a heterocyclic ring containing a nitrogen atom.

In some embodiments, the disclosure provides a copolymer comprising a plurality of units of a first repeating group and a plurality of units of a second repeating group, wherein: the first repeating group or a portion thereof is:

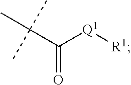

the second repeating group or a portion thereof is:

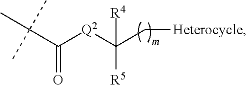

wherein
Q¹ is O, NH, or N(methyl); Q² is O, NH, or N(methyl); R¹ is H, —C(R²)(R³)(CH₂)ₙ-Charged Group; R² is H or methyl; R³ is H or methyl; R⁴ is H or methyl; R⁵ is H or methyl; m is 0, 1, 2, 3, 4, or 5; n is 0, 1, 2, 3, 4, or 5; Charged Group is an ionized or ionizable moiety; and Heterocycle is a heterocyclic ring containing a nitrogen atom.

In some embodiments, the disclosure provides a copolymer comprising a plurality of units of a first repeating group and a plurality of units of a second repeating group, wherein: the first repeating group or a portion thereof is:

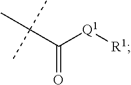

the second repeating group or a portion thereof is:

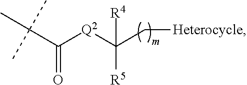

wherein Q¹ is O, NH, NCl, or N(C₁-C₃-alkyl); Q² is O, NCl, or N(C₁-C₃-alkyl); R¹ is H, Cl, —C(R²)(R³)(CH₂)ₙ-Charged Group; R² is H or C₁-C₃-alkyl; R³ is H or C₁-C₃-alkyl; R⁴ is H or C₁-C₃-alkyl; R⁵ is H or C₁-C₃-alkyl; m is 0, 1, 2, 3, 4, or 5; n is 0, 1, 2, 3, 4, or 5; Charged Group is an ionized or ionizable moiety; and Heterocycle is a heterocyclic ring containing a nitrogen atom that is substituted with a chlorine atom.

In some embodiments, the disclosure provides a copolymer comprising a plurality of units of a first repeating group and a plurality of units of a second repeating group, wherein: the first repeating group or a portion thereof is:

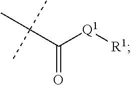

the second repeating group or a portion thereof is:

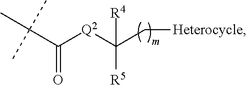

wherein Q¹ is O, NH, NCl, or N(methyl); Q² is O, NCl, or N(methyl); R¹ is H, Cl, —C(R²)(R³)(CH₂)ₙ-Charged Group; R² is H or methyl; R³ is H or methyl; R⁴ is H or methyl; R⁵ is H or methyl; m is 0, 1, 2, 3, 4, or 5; n is 0, 1, 2, 3, 4, or 5; Charged Group is an ionizable or ionized moiety; and Heterocycle is a heterocyclic ring containing a nitrogen atom that is substituted with a chlorine atom.

In some embodiments, the disclosure provides a method comprising combining: a sample of a compound of formula (I):

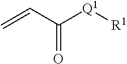

or an ionized form thereof; a sample of a compound of formula (II):

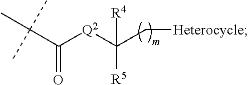

and a solvent under free radical polymerization conditions to provide a mixture, wherein: Q¹ is O, NH, or N(C₁-C₃-alkyl); Q² is O, NH, or N(C₁-C₃-alkyl); R¹ is H, —C(R²)(R³)(CH₂)ₙ-Charged Group; R² is H or C₁-C₃-alkyl; R³ is H or C₁-C₃-alkyl; R⁴ is H or C₁-C₃-alkyl; R⁵ is H or C₁-C₃-alkyl; m is 0, 1, 2, 3, 4, or 5; n is 0, 1, 2, 3, 4, or 5; Charged Group is an ionizable or ionized moiety; and Heterocycle is a heterocyclic ring containing a nitrogen atom.

In some embodiments, the disclosure provides a method comprising combining: a sample of a compound of formula (I):

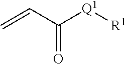

or an ionized form thereof; a sample of a compound of formula (II):

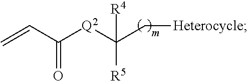

and a solvent under free radical polymerization conditions to provide a mixture, wherein: Q¹ is O, NH, or N(methyl); Q² is O, NH, or N(methyl); R¹ is H, —C(R²)(R³)(CH₂)ₙ-Charged Group; R² is H or methyl; R³ is H or methyl; R⁴ is H or methyl; R⁵ is H or methyl; m is 0, 1, 2, 3, 4, or 5; n is 0, 1, 2, 3, 4, or 5; Charged Group is an ionizable or ionized moiety; and Heterocycle is a heterocyclic ring containing a nitrogen atom.

In some embodiments, the biocidal molecule (e.g., copolymer) as provided herein can have a repeating unit comprising the structure:

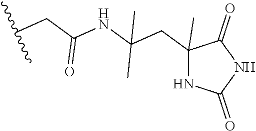

and an additional repeating unit comprising the structure:

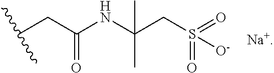

In some embodiments, the biocidal molecule (e.g., copolymer) as provided herein can have a repeating unit comprising the structure:

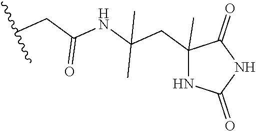

and an additional repeating unit comprising the structure:

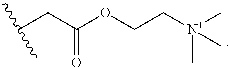

In some embodiments, the biocidal molecule (e.g., copolymer) as provided herein can have a repeating unit comprising the structure:

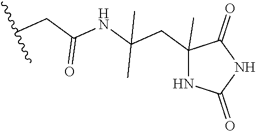

and an additional repeating unit comprising the structure:

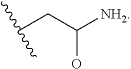

In some embodiments, the biocidal molecule (e.g., copolymer) as provided herein can have a repeating unit comprising the structure:

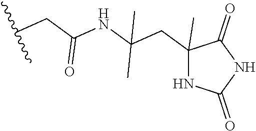

and an additional repeating unit comprising the structure:

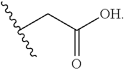

In some embodiments, the biocidal molecule (e.g., copolymer) as provided herein can have a repeating unit comprising the structure:

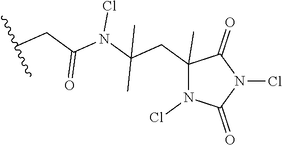

and an additional repeating unit comprising the structure:

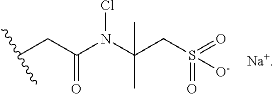

In some embodiments, the biocidal molecule (e.g., copolymer) as provided herein can have a repeating unit comprising the structure:

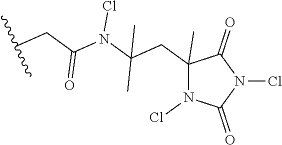

and an additional repeating unit comprising the structure:

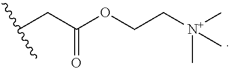

In some embodiments, the biocidal molecule (e.g., copolymer) as provided herein can have a repeating unit comprising the structure:

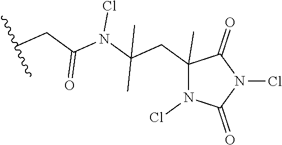

and an additional repeating unit comprising the structure:

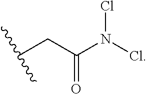

In some embodiments, the biocidal molecule (e.g., copolymer) as provided herein can have a repeating unit comprising the structure:

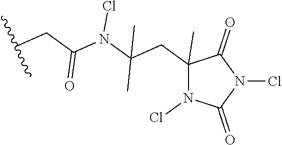

and an additional repeating unit comprising the structure:

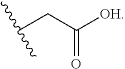

In some embodiments, a repeating unit of the polymer of the present invention can comprise an anti-fouling compound (e.g., zwitterion). The repeating unit can be derived from at least one species of monomer, and a monomer of the at least one species of monomer can comprise the anti-fouling compound (e.g., zwitterion). Non-limiting examples of such zwitterionic monomers include an acrylamide derivative (e.g., a methacrylamide derivative) that comprises phosphobetaine (PB), sulfobetaine (SB), carboxybetaine (CB), or phosphorylcholine (PC).

In some embodiments, the biocidal molecule (e.g., copolymer) as provided herein does not comprise any anti-fouling compound. In some embodiments, the biocidal copolymer is not synthetized from monomers comprising an anti-fouling compound. In some embodiments, the biocidal molecule (e.g., copolymer) as provided herein does not comprise any zwitterionic moiety. In some embodiments, the biocidal copolymer is not synthetized from zwitterionic monomers.

### Water Dissolvable Biocidal Molecules:

In some embodiments, a solid composition disclosed herein can comprise a copolymer dissolvable in an aqueous medium, wherein the copolymer comprises a first repeating unit and a second repeating unit, wherein: (i) the first repeating unit comprises a side chain, wherein the side chain comprises a N-chlorinated halamine; and (ii) the second repeating unit is not capable of forming a N-halamine.

In some embodiments, as described herein, a molecule comprising the biocidal moiety (e.g., small molecule or polymeric molecule comprising the N-halamine precursors or the N-halamine derivative thereof) can be soluble in aqueous medium. In some embodiments, the N-halamines or polymers comprising the N-halamines, as disclosed herein, can be dissolvable in water (or water soluble). For example, polymers comprising activated N-halamines (e.g., N-chlorinated halamines) can be readily dissolved in aqueous medium. For example, the N-halamines can be soluble in water.

In some embodiments, an aqueous coating composition in which the polymers comprising N-chlorinated halamines are dissolved can be applied on a surface of an object, to generate a biocidal coating on the surface (e.g., without having to apply a separate source of chlorine to the coating). In some embodiments, the coating comprising the polymers that are dissolvable in aqueous medium is more effective in killing microorganisms (e.g., pathogens, bacteria, etc.) than a control coating composition in which the polymers comprising N-chlorinated halamines are not water dissolvable or less water dissolvable, for at least the reason that the water dissolvable polymers from the coating can dissolve into an aqueous environment comprising the microorganisms (e.g., bacteria inoculum) and have a greater chance of interaction with the microorganisms to effect killing the microorganisms.

In some embodiments, additional moieties such as binders (e.g., any one of the water-soluble moieties provided herein) can be attached to the biocidal moiety to impart enhanced dissolvability in aqueous medium to the biocidal moiety. In some embodiments, the biocidal moiety can be a copolymer (e.g., a random copolymer, a block copolymer, etc.) comprising (i) a first repeating unit comprising the N-halamine precursors or activated N-halamines (e.g., N-chlorinated halamines) as a side-chain group and (ii) a second repeating unit comprising one or more water-soluble moieties as a side-chain group.

In some embodiments, water dissolvability of the molecule as provided herein (e.g., copolymer comprising the biocidal moiety and the binder) can be characterized as a concentration (e.g., weight of the molecule per volume of the aqueous medium or weight percentage, a number or average number of the molecule per volume of the aqueous medium) of the molecule dissolved or dispersed in the aqueous medium to form a substantially clear or transparent aqueous solution at room temperature (e.g., between about 22 degrees Celsius and about 28 degrees Celsius) in atmospheric pressure, e.g., without a substantial amount of precipitates. Transparency of a dispersion in an aqueous solution can be characterized as having at least about 80%, at least about 85%, at least about 90%, at least about 95%, at least about 99%, or substantially 100% light transmissibility of a light comprising a wavelength between 400 nanometers (nm) and 800 nm, e.g., at least or up to about 400 nm, at least or up to about 450 nm, at least or up to about 500 nm, at least or up to about 550 nm, at least or up to about 600 nm, at least or up to about 650 nm, at least or up to about 700 nm, at least or up to about 750 nm, or at least or up to about 800 nm.

In some embodiments, water dissolvability of the molecule can be characterized by a concentration of the molecule that is able to be dissolved (e.g., substantially without precipitation) in the aqueous medium as abovementioned. Such water-soluble concentration can be at least or up to about 0.010% weight per volume (w/v %, wherein 1 w/v % is equivalent to 1 gram of dissolvable material per 100 milliliters of liquid medium, or 10 milligrams of dissolvable material per 1 milliliter of liquid medium), at least or up to about 0.02 w/v %, at least or up to about 0.05 w/v 00 at least or up to about 0.1 w/v %, at least or up to about 0.2 w/v 00 at least or up to about 0.5 w/v %, at least or up to about 1 w/v %, at least or up to about 2 w/v 00 at least or up to about 3 w/v %, at least or up to about 4 w/v %, at least or up to about 5 w/v %, at least or up to about 6 w/v %, at least or up to about 7 w/v %, at least or up to about 8 w/v %, at least or up to about 9 w/v %, at least or up to about 10 w/v 00 at least or up to about 11 w/v 00 at least or up to about 12 w/v 00 at least or up to about 13 w/v 00 at least or up to about 14 w/v 00 at least or up to about 15 w/v 00 at least or up to about 16 w/v 00 at least or up to about 17 w/v 00 at least or up to about 18 w/v 00 at least or up to about 19 w/v 00 at least or up to about 20 w/v 00 at least or up to about 21 w/v 00 at least or up to about 22 w/v 00 at least or up to about 23 w/v 00 at least or up to about 24 w/v 00 at least or up to about 25 w/v 00 at least or up to about 26 w/v 00 at least or up to about 27 w/v 00 at least or up to about 28 w/v 00 at least or up to about 29 w/v 00 at least or up to about 30 w/v 00 at least or up to about 31 w/v 00 at least or up to about 32 w/v 00 at least or up to about 33 w/v 00 at least or up to about 34 w/v 00 at least or up to about 35 w/v 00 at least or up to about 36 w/v 00 at least or up to about 37 w/v 00 at least or up to about 38 w/v 00 at least or up to about 39 w/v 00 at least or up to about 40 w/v 00 at least or up to about 41 w/v 00 at least or up to about 42 w/v 00 at least or up to about 43 w/v 00 at least or up to about 44 w/v 00 at least or up to about 45 w/v 00 at least or up to about 46 w/v 00 at least or up to about 47 w/v 00 at least or up to about 48 w/v 00 at least or up to about 49 w/v 00 at least or up to about 50 w/v 00 at least or up to about 55 w/v 00 at least or up to about 60 w/v 00 at least or up to about 65 w/v 00 at least or up to about 70 w/v 00 at least or up to about 75 w/v 00 at least or up to about 80 w/v 00 at least or up to about 85 w/v 00 at least or up to about 90 w/v 00 or at least or up to about 95 w/v %.

In some embodiments, the aqueous medium utilized for assessing water dissolvability of the molecule can be a liquid medium comprising water by at least about 80%, at least about 85%, at least about 90%, at least about 95%, at least about 96%, at least about 97%, at least about 98%, at least about 99%, or substantially 100% by weight of the liquid medium (e.g., substantially free of other liquid solution such as ethanol). In some embodiments, measured pH value of the aqueous medium utilized for assessing water dissolvability of the molecule (e.g., measured prior to dissolving the molecule) can range between about 5 and about 8, between about 5 and about 7.5, between about 5 and about 7, between about 5 and about 6.5, between about 5 and about 6, between about 6 and about 8, between about 6 and about 7.5, between about 6 and about 7, between about 6 and about 6.5, or between about 7 and about 8. For example, the aqueous medium can be deionized water (e.g., exhibiting a pH between about 6 and about 7). For example the aqueous medium can be deionized water. In some embodiments, measured pH value of the aqueous medium utilized for assessing dissolvability of the molecule (e.g., measured prior to dissolving the molecule) can range between about 10 and about 14, between about 10 and about 13.5, between about 10 and about 13, between about 10 and about 12.5, between about 10 and about 12, between about 10 and about 11.5, between about 10 and about 11, between about 10 and between about 10.5, between about 11 and about 14, about 11 and about 13.5, between about 11 and about 13, between about 11 and about 12.5, between about 11 and about 12, between about 11 and about 11.5, between about 12 and about 14, between about 12 and about 13.5, between about 12 and about 13, between about 12 and about 12.5, or between about 13 and about 14. For example, the aqueous medium can be alkaline water (e.g., exhibiting a pH between about 12 and about 14).

In some embodiments, the molecule (or a sample of the molecule) as provided herein can be dissolved in water (e.g., deionized water) at about 1 w/v % and exhibit a target pH value or range thereof (e.g., in absence of any adjustment of the pH value of the mixture). The target pH value range can be less than about 14, less than about 13, less than about 12, less than about 11, less than about 10, less than about 9, less than about 8, less than about 7, or less than about 6. The target pH value range can be between about 3 and about 6, between about 3 and about 5.5, between about 3 and about 5, between about 3 and about 4.5, between about 3 and about 4, between about 3 and about 3.5, between about 3.5 and about 6, between about 3.5 and about 5.5, between about 3.5 and about 5, between about 3.5 and about 4.5, between about 3.5 and about 4, between about 4 and about 6, between about 4 and about 5.5, between about 4 and about 5, between about 4 and about 4.5, between about 5 and about 6, or between about 5.5 and about 6.

In some embodiments, the water dissolvable molecule (e.g., dissolvable in deionized water having a pH value between about 6 and about 7) can have an average molar mass (e.g., a number average molar mass as determined by gel permeation chromatography (GPC)) of at least or up to about 1 kDa, at least or up to about 2 kDa, at least or up to about 3 kDa, at least or up to about 4 kDa, at least or up to about 5 kDa, at least or up to about 6 kDa, at least or up to about 7 kDa, at least or up to about 8 kDa, at least or up to about 9 kDa, at least or up to about 10 kDa, at least or up to about 11 kDa, at least or up to about 12 kDa, at least or up to about 13 kDa, at least or up to about 14 kDa, at least or up to about 15 kDa, at least or up to about 16 kDa, at least or up to about 17 kDa, at least or up to about 18 kDa, at least or up to about 19 kDa, at least or up to about 20 kDa, at least or up to about 50 kDa, at least or up to about 100 kDa, at least or up to about 150 kDa, at least or up to about 200 kDa, at least or up to about 300 kDa, at least or up to about 400 kDa, or at least or up to about 500 kDa.

In some embodiments, the average molar mass of the water dissolvable molecule can range between about 100 kDa to about 200 kDa, about 100 kDa to about 110 kDa, about 100 kDa to about 120 kDa, about 100 kDa to about 130 kDa, about 100 kDa to about 140 kDa, about 100 kDa to about 150 kDa, about 100 kDa to about 160 kDa, about 100 kDa to about 170 kDa, about 100 kDa to about 180 kDa, about 100 kDa to about 190 kDa, about 110 kDa to about 120 kDa, about 110 kDa to about 130 kDa, about 110 kDa to about 140 kDa, about 110 kDa to about 150 kDa, about 110 kDa to about 160 kDa, about 110 kDa to about 170 kDa, about 110 kDa to about 180 kDa, about 110 kDa to about 190 kDa, about 110 kDa to about 200 kDa, about 120 kDa to about 130 kDa, about 120 kDa to about 140 kDa, about 120 kDa to about 150 kDa, about 120 kDa to about 160 kDa, about 120 kDa to about 170 kDa, about 120 kDa to about 180 kDa, about 120 kDa to about 190 kDa, about 120 kDa to about 200 kDa, about 130 kDa to about 140 kDa, about 130 kDa to about 150 kDa, about 130 kDa to about 160 kDa, about 130 kDa to about 170 kDa, about 130 kDa to about 180 kDa, about 130 kDa to about 190 kDa, about 130 kDa to about 200 kDa, about 140 kDa to about 150 kDa, about 140 kDa to about 160 kDa, about 140 kDa to about 170 kDa, about 140 kDa to about 180 kDa, about 140 kDa to about 190 kDa, about 140 kDa to about 200 kDa, about 150 kDa to about 160 kDa, about 150 kDa to about 170 kDa, about 150 kDa to about 180 kDa, about 150 kDa to about 190 kDa, about 150 kDa to about 200 kDa, about 160 kDa to about 170 kDa, about 160 kDa to about 180 kDa, about 160 kDa to about 190 kDa, about 160 kDa to about 200 kDa, about 170 kDa to about 180 kDa, about 170 kDa to about 190 kDa, about 170 kDa to about 200 kDa, about 180 kDa to about 190 kDa, about 180 kDa to about 200 kDa, or about 190 kDa to about 200 kDa.

In some embodiments, the average molar mass of the water dissolvable molecule can range between about 50 kDa to about 100 kDa, about 50 kDa to about 60 kDa, about 50 kDa to about 70 kDa, about 50 kDa to about 80 kDa, about 50 kDa to about 90 kDa, about 60 kDa to about 70 kDa, about 60 kDa to about 80 kDa, about 60 kDa to about 90 kDa, about 60 kDa to about 100 kDa, about 70 kDa to about 80 kDa, about 70 kDa to about 90 kDa, about 70 kDa to about 100 kDa, about 80 kDa to about 90 kDa, about 80 kDa to about 100 kDa, or about 90 kDa to about 100 kDa.

In some embodiments, the average molar mass of the water dissolvable molecule can range between about 5 kDa to about 50 kDa, about 5 kDa to about 10 kDa, about 5 kDa to about 15 kDa, about 5 kDa to about 20 kDa, about 5 kDa to about 30 kDa, about 5 kDa to about 40 kDa, about 10 kDa to about 15 kDa, about 10 kDa to about 20 kDa, about 10 kDa to about 30 kDa, about 10 kDa to about 40 kDa, about 10 kDa to about 50 kDa, about 15 kDa to about 20 kDa, about 15 kDa to about 30 kDa, about 15 kDa to about 40 kDa, about 15 kDa to about 50 kDa, about 20 kDa to about 30 kDa, about 20 kDa to about 40 kDa, about 20 kDa to about 50 kDa, about 30 kDa to about 40 kDa, about 30 kDa to about 50 kDa, or about 40 kDa to about 50 kDa.

In some embodiments, the average molar mass of the water dissolvable molecule can range between about 2 kDa to about 20 kDa, about 2 kDa to about 3 kDa, about 2 kDa to about 4 kDa, about 2 kDa to about 5 kDa, about 2 kDa to about 6 kDa, about 2 kDa to about 7 kDa, about 2 kDa to about 8 kDa, about 2 kDa to about 9 kDa, about 2 kDa to about 10 kDa, about 2 kDa to about 12 kDa, about 2 kDa to about 15 kDa, about 3 kDa to about 4 kDa, about 3 kDa to about 5 kDa, about 3 kDa to about 6 kDa, about 3 kDa to about 7 kDa, about 3 kDa to about 8 kDa, about 3 kDa to about 9 kDa, about 3 kDa to about 10 kDa, about 3 kDa to about 12 kDa, about 3 kDa to about 15 kDa, about 3 kDa to about 20 kDa, about 4 kDa to about 5 kDa, about 4 kDa to about 6 kDa, about 4 kDa to about 7 kDa, about 4 kDa to about 8 kDa, about 4 kDa to about 9 kDa, about 4 kDa to about 10 kDa, about 4 kDa to about 12 kDa, about 4 kDa to about 15 kDa, about 4 kDa to about 20 kDa, about 5 kDa to about 6 kDa, about 5 kDa to about 7 kDa, about 5 kDa to about 8 kDa, about 5 kDa to about 9 kDa, about 5 kDa to about 10 kDa, about 5 kDa to about 12 kDa, about 5 kDa to about 15 kDa, about 5 kDa to about 20 kDa, about 6 kDa to about 7 kDa, about 6 kDa to about 8 kDa, about 6 kDa to about 9 kDa, about 6 kDa to about 10 kDa, about 6 kDa to about 12 kDa, about 6 kDa to about 15 kDa, about 6 kDa to about 20 kDa, about 7 kDa to about 8 kDa, about 7 kDa to about 9 kDa, about 7 kDa to about 10 kDa, about 7 kDa to about 12 kDa, about 7 kDa to about 15 kDa, about 7 kDa to about 20 kDa, about 8 kDa to about 9 kDa, about 8 kDa to about 10 kDa, about 8 kDa to about 12 kDa, about 8 kDa to about 15 kDa, about 8 kDa to about 20 kDa, about 9 kDa to about 10 kDa, about 9 kDa to about 12 kDa, about 9 kDa to about 15 kDa, about 9 kDa to about 20 kDa, about 10 kDa to about 12 kDa, about 10 kDa to about 15 kDa, about 10 kDa to about 20 kDa, about 12 kDa to about 15 kDa, about 12 kDa to about 20 kDa, or about 15 kDa to about 20 kDa.

In some embodiments, the water dissolvable molecule can comprise a plurality of N-halamine precursor sites, and one or more of the plurality of N-halamine precursor sites can be activated (e.g., as N-chlorinated halamines) prior to and/or while being dissolved in the aqueous medium. In some embodiments, at least or up to about 1%, at least or up to about 2%, at least or up to about 5%, at least or up to about 10%, at least or up to about 15%, at least or up to about 20%, at least or up to about 25%, at least or up to about 30%, at least or up to about 35%, at least or up to about 40%, at least or up to about 45%, at least or up to about 50%, at least or up to about 55%, at least or up to about 60%, at least or up to about 65%, at least or up to about 70%, at least or up to about 75%, at least or up to about 80%, at least or up to about 85%, at least or up to about 90%, at least or up to about 95%, at least or up to about 99%, or substantially about 100% of the plurality of N-halamine precursor sites can be activated (e.g., as N-chlorinated halamines) in the molecule that is being dissolved or has been dissolved in the aqueous medium. In some embodiments, the molecule that is being dissolved or has been dissolved in the aqueous medium can have, on average, at least or up to about 1 activated N-halamine (e.g., N-chlorinated halamine), at least or up to about 2 activated N-halamines, at least or up to about 3 activated N-halamines, at least or up to about 4 activated N-halamines, at least or up to about 5 activated N-halamines, at least or up to about 6 activated N-halamines, at least or up to about 7 activated N-halamines, at least or up to about 8 activated N-halamines, at least or up to about 9 activated N-halamines, at least or up to about 10 activated N-halamines, at least or up to about 11 activated N-halamines, at least or up to about 12 activated N-halamines, at least or up to about 13 activated N-halamines, at least or up to about 14 activated N-halamines, at least or up to about 15 activated N-halamines, at least or up to about 16 activated N-halamines, at least or up to about 17 activated N-halamines, at least or up to about 18 activated N-halamines, at least or up to about 19 activated N-halamines, at least or up to about 20 activated N-halamines, at least or up to about 25 activated N-halamines, at least or up to about 30 activated N-halamines, at least or up to about 35 activated N-halamines, at least or up to about 40 activated N-halamines, at least or up to about 45 activated N-halamines, at least or up to about 50 activated N-halamines, at least or up to about 70 activated N-halamines, at least or up to about 80 activated N-halamines, at least or up to about 90 activated N-halamines, at least or up to about 100 activated N-halamines, at least or up to about 120 activated N-halamines, at least or up to about 140 activated N-halamines, at least or up to about 150 activated N-halamines, at least or up to about 160 activated N-halamines, at least or up to about 80 activated N-halamines, at least or up to about 200 activated N-halamines, at least or up to about 220 activated N-halamines, at least or up to about 240 activated N-halamines, at least or up to about 250 activated N-halamines, at least or up to about 260 activated N-halamines, at least or up to about 280 activated N-halamines, at least or up to about 300 activated N-halamines, at least or up to about 350 activated N-halamines, at least or up to about 400 activated N-halamines, at least or up to about 450 activated N-halamines, or at least or up to about 500 activated N-halamines.

In some embodiments, the amount (e.g., average amount) of chlorine conjugated to (or extracted from) the water dissolvable molecule comprising the plurality of N-chlorinated halamines as provided herein (e.g., as characterized by measuring the amount of Cl₂ via iodometric/thiosulfate titration) can be at least or up to about 100 parts per million of each molecule (e.g., each copolymer on average) (ppm), at least or up to about 200 ppm, at least or up to about 500 ppm, at least or up to about 1,000 ppm, at least or up to about 2,000 ppm, at least or up to about 4,000 ppm, at least or up to about 5,000 ppm, at least or up to about 6,000 ppm, at least or up to about 8,000 ppm, at least or up to about 10,000 ppm, at least or up to about 15,000 ppm, at least or up to about 20,000 ppm, at least or up to about 30,000 ppm, at least or up to about 40,000 ppm, at least or up to about 50,000 ppm, at least or up to about 60,000 ppm, at least or up to about 70,000 ppm, at least or up to about 80,000 ppm, at least or up to about 90,000 ppm, at least or up to about 100,000 ppm, at least or up to about 120,000 ppm, at least or up to about 150,000 ppm, at least or up to about 200,000 ppm, at least or up to about 210,000 ppm, at least or up to about 220,000 ppm, at least or up to about 230,000 ppm, at least or up to about 240,000 ppm, at least or up to about 250,000 ppm, at least or up to about 300,000 ppm, at least or up to about 400,000 ppm, at least or up to about 500,000 ppm, at least or up to about 600,000 ppm, at least or up to about 700,000 ppm, at least or up to about 800,000 ppm, at least or up to about 900,000 ppm, at least or up to about 1,000,000 ppm, at least or up to about 0.1 percent per weight of the molecule (wt %), at least or up to about 0.2 wt %, at least or up to about 0.5 wt %, at least or up to about 1 wt %, at least or up to about 2 wt %, at least or up to about 3 wt %, at least or up to about 4 wt %, at least or up to about 5 wt %, at least or up to about 6 wt %, at least or up to about 7 wt %, at least or up to about 8 wt %, at least or up to about 9 wt %, at least or up to about 10 wt %, at least or up to about 11 wt %, at least or up to about 12 wt %, at least or up to about 13 wt %, at least or up to about 14 wt %, at least or up to about 15 wt %, at least or up to about 16 wt %, at least or up to about 17 wt %, at least or up to about 18 wt %, at least or up to about 19 wt %, at least or up to about 20 wt %, at least or up to about 21 wt %, at least or up to about 22 wt %, at least or up to about 23 wt %, at least or up to about 24 wt %, at least or up to about 25 wt 00 at least or up to about 26 wt 00 at least or up to about 27 wt 00 at least or up to about 28 wt 00 at least or up to about 29 wt 00 at least or up to about 30 wt 00 at least or up to about 35 wt 00 at least or up to about 40 wt 00 at least or up to about 45 wt 00 at least or up to about 50 wt 0 at least or up to about 55 wt %, at least or up to about 60 wt 00 at least or up to about 65 wt 00 at least or up to about 70 wt 00 at least or up to about 75 wt 00 or at least or up to about 80 wt %.

In some embodiments, the amount (e.g., average amount) of chlorine of the water dissolvable molecule comprising the plurality of N-chlorinated halamines as provided herein (e.g., as characterized by a spectrometer method using N,N-diethyl-p-phenylenediamine (DPD) as an indicator) can be measured as a molar ratio of the molecule (e.g., each copolymer on average) over Cl₂ from the molecule (molecule:Cl₂), and such ratio can be at least or up to about 1:1, at least or up to about 1:2, at least or up to about 1:3, at least or up to about 1:4, at least or up to about 1:5, at least or up to about 1:6, at least or up to about 1:7, at least or up to about 1:8, at least or up to about 1:9, at least or up to about 1:10, at least or up to about 1:15, at least or up to about 1:20, at least or up to about 1:25, at least or up to about 1:30, at least or up to about 1:40, at least or up to about 1:50, at least or up to about 1:60, at least or up to about 1:70, at least or up to about 1:80, at least or up to about 1:90, at least or up to about 1:100, at least or up to about 1:200, at least or up to about 1:300, at least or up to about 1:400, at least or up to about 1:500, at least or up to about 1:1,000, at least or up to about 1:2,000, or at least or up to about 1:5,000.

In some embodiments, prior to or at the time of assessing water dissolvability, the water dissolvable molecule can be a copolymer comprising (i) a first species of repeating unit that comprises activated N-halamines (e.g., comprises N-chlorinated halamines) and (ii) a second species of repeating unit that is not capable of forming N-halamines (e.g., instead comprises additional moieties that impart water dissolvability to the molecule, such as any of the water-soluble moieties). The molar ratio of the first species and the second species of such N-halamine activated copolymer (e.g., as estimated by the initial feed ratio of the two respective monomers during synthesis of the copolymer) can be characterized by the following equation:

$$Water disssolvable molar ratio = \frac{M F}{M F + M S}$$

wherein (i) “MF” is a molar amount of the first species or the first repeating unit and (ii) “MS” is the molar amount of the second species of the second repeating unit. In some embodiments, the water dissolvable molar ratio can be less than or equal to about 0.9, less than or equal to about 0.85, less than or equal to about 0.8, less than or equal to about 0.75, less than or equal to about 0.7, less than or equal to about 0.65, less than or equal to about 0.6, less than or equal to about 0.55, less than or equal to about 0.5, less than or equal to about 0.45, less than or equal to about 0.4, less than or equal to about 0.35, less than or equal to about 0.3, less than or equal to about 0.25, less than or equal to about 0.2, less than or equal to about 0.15, or less than or equal to about 0.1.

In some embodiments, the molecule as provided herein can comprise (e.g., prior to and/or while being dissolved in the deionized water) (i) the first species of repeating unit comprising N-chlorinated halamine and (ii) the second species of repeating unit comprising a functional group selected from sulfonic acid (e.g., from 2-acrylamido-2-methyl-1-propanesulfonic acid monomer) and quaternary ammonium compound (e.g., from [2-(methacryloyloxy)ethyl]trimethylammonium monomer), at the water dissolvable molar ratio of less than or equal to about 0.8, less than or equal to about 0.75, less than or equal to about 0.7, less than or equal to about 0.65, less than or equal to about 0.6, less than or equal to about 0.55, less than or equal to about 0.5, less than or equal to about 0.45, or less than or equal to about 0.4. Such molecule comprising N-chlorinated halamines can dissolve in deionized water (e.g., exhibiting a pH between about 6 and about 7) at a concentration of at least or up to about 0.1 w/v %, at least or up to about 0.2 w/v %, at least or up to about 0.5 w/v %, at least or up to about 1 w/v %, at least or up to about 2 w/v %, at least or up to about 3 w/v 00 at least or up to about 4 w/v 00 at least or up to about 5 w/v 00 at least or up to about 6 w/v 00 at least or up to about 7 w/v 00 at least or up to about 8 w/v 00 at least or up to about 9 w/v 00 at least or up to about 10 w/v %, at least or up to about 12 w/v %, at least or up to about 15 w/v 00 at least or up to about 16 w/v 00 at least or up to about 17 w/v %, at least or up to about 18 w/v 00 at least or up to about 19 w/v 00 or at least or up to about 20 w/v %, and the resulting mixture can exhibit a pH value that is less than or equal to about 7, less than or equal to about 6, less than or equal to about 5, or less than or equal to about 4.

In some embodiments, the aqueous medium (e.g., water such as deionized water) usable for dissolving the molecule comprising the biocidal moiety (e.g., a sample of polymers comprising N-halamine precursors or activated N-halamines) can be substantially free of the halogen source (e.g., electrophilic chlorine, such as from sodium hypochlorite, hypochlorous acid, etc.) for activating the N-halamine precursors. In some embodiments, the aqueous medium usable for dissolving the molecule comprising the biocidal moiety can comprise the halogen source, e.g., at least or up to about 0.1 w/v 00 at least or up to about 0.2 w/v %, at least or up to about 0.5 w/v %, at least or up to about 1 w/v 00 at least or up to about 2 w/v %, at least or up to about 3 w/v %, at least or up to about 4 w/v 00 at least or up to about 5 w/v 00 at least or up to about 6 w/v 00 at least or up to about 7 w/v 00 at least or up to about 8 w/v 00 at least or up to about 9 w/v 00 at least or up to about 10 w/v 00 at least or up to about 15 w/v 00 at least or up to about 20 w/v %, at least or up to about 30 w/v 00 at least or up to about 40 w/v 00 or at least or up to about 50 w/v %.

### Cross-Linkers for Coating Composition:

In some embodiments, the coating composition provided herein can comprise a molecule comprising a biocidal moiety (e.g., small molecule or polymeric molecule comprising the N-halamine precursors or the N-halamine derivative thereof) (or “biocidal molecule”) and one or more binders (e.g., at least 1 type of binder, at least 2 types of binders, at least 3 types of binders, at least 4 types of binders, at least 5 types of binders, etc.).

In some embodiments, a binder of the coating composition can bind or trap the molecule comprising the biocidal moiety on a surface of an object (e.g., upon application and drying of the coating composition) to generate a biocidal coating on the surface. In some embodiments, the binder can generate a cross-linked network (e.g., non-covalently or covalently cross-linked network) of materials as part of the biocidal coating, and thus such binder (or binders) can be referred to as a cross-linking moiety.

Non-limiting example of such surface can include glass, silicon, alumina, quartz, polymer (e.g., polycarbonate), steel (e.g., stainless steel), and metal oxide substrates. In some embodiments, the at least the portion of the surface can comprise one or more reactive functional groups, e.g., hydroxyl group, thiol group, amine group, and/or carboxylic acid. In some embodiments, the surface can be abundant of the one or more reactive functional groups such as hydroxyl groups.

In some embodiments, the binder (e.g., the cross-linking moiety) can crosslink at least a portion of the molecule to at least a portion of the surface. In some embodiments, the binder can have a plurality of reacting groups comprising (i) a first reacting group that couples to at least a portion of the molecule comprising the biocidal moiety (e.g., covalently or non-covalently) and (ii) a second reacting group that couples to the surface (e.g., covalently or non-covalently) to bind or trap the biocidal moiety on the surface. In some embodiments, the first reacting group and the second reacting group of such binder can be different types of reacting groups that utilize different cross-linking chemistries. In some embodiments, the binder can be configured to covalently couple to at least a portion of the molecule comprising the biocidal moiety and also covalently couple to at least a portion of the surface.

In some embodiments, the binder (e.g., the cross-linking moiety) can comprise an organosilane moiety as provide herein (e.g., 3-aminopropyltriethoxysilane (APTES), 3-chloropropyltrimethoxysilane, 3-aminopropyl(diethoxy)methylsilane, etc.). In some embodiments, the organosilane moiety can be utilized to achieve silanization of the surface, to facilitate generation of the biocidal coating on the surface. In some embodiments, the biocidal molecule can be a polymer, and the cross-linking moiety may not be part of a repeating unit of the polymeric biocidal molecule. In some embodiments, the polymeric biocidal molecule is not synthesized in the presence of monomers comprising an organosilane (e.g., as a functional group). In some embodiments, the cross-linking moiety (e.g., prior to mixing with the biocidal molecule) does not comprise or is not a polymerized derivative of 3-(trimethoxysilyl)propyl methacrylate, 3-(triethoxysilyl)propyl acrylate, or 3-(triethoxysilyl)propyl methacrylate. In some embodiments, the cross-linking moiety can be part of a repeating unit of the polymeric biocidal molecule.

In some embodiments, the binder (e.g., the cross-linking moiety) can comprise silsesquioxane oligomers with aminopropyl functional groups, titanate coupling agents with amino functional groups, or zirconate coupling agents with amino functional groups.

In some embodiments, the cross-linking moiety (e.g., organosilane) can be added to or mixed with the biocidal molecule when substantially all of the N-halamine precursors of the biocidal molecule are not activated (e.g., hydrogenated as opposed to halogenated). In some embodiments, the cross-linking moiety can be added to or mixed with the biocidal molecule when substantially all of the N-halamine precursors of the biocidal molecule are activated (e.g., halogenated to form N-chlorinated halamines). In some embodiments, the cross-linking moiety can be added to or mixed with the biocidal molecule when the biocidal molecule is in a solid-phase (e.g., not dispersed or dissolved in a liquid medium). In some embodiments, the cross-linking moiety can be added to or mixed with the biocidal molecule when the biocidal molecule is in a liquid phase (e.g., dispersed or dissolved in a liquid medium, such as water, organic solvent, or a mixture thereof). In some embodiments, the cross-linking moiety can be added to the surface (e.g., where a biocidal coating would be generated), and subsequently a separate coating composition comprising the biocidal molecule having the N-halamine precursors or the activated N-halamine derivative thereof can be added to the surface that has been pre-treated (or functionalized) with the cross-linking moiety.

In some embodiments, the cross-linking moiety and the biocidal molecule can be mixed in a liquid formulation comprising an organic solvent (e.g., alcohols such as ethanol, isopropyl alcohol, propanol, methanol, butanol, acetone, etc. as provided herein). Such liquid formulation can be generated prior to applying the liquid formulation to a surface to generate a biocidal coating. The liquid formulation (or liquid solvent) can be substantially free of aqueous solvent or can further comprise aqueous solvent. In some embodiments, the volume ratio between the organic solvent and the aqueous solvent (organic:aqueous) in the liquid formulation can be at least or up to about 10:90, at least or up to about 20:80, at least or up to about 30:70, at least or up to about 40:60, at least or up to about 50:50, at least or up to about 60:40, at least or up to about 70:30, at least or up to about 75:25, at least or up to about 80:20, at least or up to about 85:15, at least or up to about 90:10, at least or up to about 95:5, or at least or up to about 99:1. In some embodiments, the volume ratio (organic:aqueous) can range between about 50:50 and about 99:1, about 60:40 and about 99:1, about 70:30 and about 99:1, about 80:20 and about 99:1, or about 90:10 and about 99:1.

In some embodiments, an average molar mass (e.g., a number average molar mass as determined by gel permeation chromatography (GPC)) of the cross-linking moiety can be at least or up to about 100 Dalton (Da), at least or up to about 120 Da, at least or up to about 140 Da, at least or up to about 150 Da, at least or up to about 160 Da, at least or up to about 180 Da, at least or up to about 200 Da, at least or up to about 220 Da, at least or up to about 240 Da, at least or up to about 250 Da, at least or up to about 260 Da, at least or up to about 280 Da, at least or up to about 300 Da, at least or up to about 350 Da, at least or up to about 400 Da, at least or up to about 450 Da, at least or up to about 500 Da, at least or up to about 600 Da, at least or up to about 700 Da, at least or up to about 800 Da, at least or up to about 900 Da, at least or up to about 1,000 Da, at least or up to about 2,000 Da, at least or up to about 3,000 Da, at least or up to about 4,000 Da, or at least or up to about 5,000 Da. In some embodiments, the average molar mass of the cross-linking moiety can range between about 100 Da and about 500 Da, about 100 Da and about 400 Da, or about 100 Da and about 300 Da.

In some embodiments, an average molar mass (e.g., a number average molar mass as determined by gel permeation chromatography (GPC)) of the cross-linking moiety can be at least or up to about 1 kDa, at least or up to about 2 kDa, at least or up to about 3 kDa, at least or up to about 4 kDa, at least or up to about 5 kDa, at least or up to about 6 kDa, at least or up to about 7 kDa, at least or up to about 8 kDa, at least or up to about 9 kDa, at least or up to about 10 kDa, at least or up to about 15 kDa, at least or up to about 20 kDa, at least or up to about 30 kDa, at least or up to about 40 kDa, at least or up to about 50 kDa, at least or up to about 60 kDa, at least or up to about 70 kDa, at least or up to about 80 kDa, at least or up to about 90 kDa, or at least or up to about 100 kDa.

In some embodiments of the coating composition of the present disclosure, a molar ratio between (i) the molecule comprising a biocidal moiety and (ii) the cross-linking moiety (biocidal molecule:cross-linking moiety) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments of the coating composition of the present disclosure, a molar ratio between (i) the cross-linking moiety and (ii) the molecule comprising a biocidal moiety (cross-linking moiety:biocidal molecule) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments of the coating composition of the present disclosure, a molar ratio between (i) the repeating unit comprising a biocidal moiety and (ii) the cross-linking moiety (biocidal repeating unit:cross-linking moiety) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments of the coating composition of the present disclosure, a molar ratio between (i) the cross-linking moiety and (ii) the repeating unit comprising the biocidal moiety (cross-linking moiety:biocidal repeating unit) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments, the amount (e.g., weight) of the cross-linking moiety per weight of the coating composition (wt %) can be at least or up to about 0.001 wt %, at least or up to about 0.002 wt %, at least or up to about 0.004 wt %, at least or up to about 0.005 wt %, at least or up to about 0.006 wt %, at least or up to about 0.008 wt %, at least or up to about 0.01 wt %, at least or up to about 0.02 wt %, at least or up to about 0.04 wt %, at least or up to about 0.05 wt %, at least or up to about 0.06 wt %, at least or up to about 0.08 wt %, at least or up to about 0.1 wt %, at least or up to about 0.2 wt %, at least or up to about 0.4 wt %, at least or up to about 0.5 wt %, at least or up to about 0.8 wt %, at least or up to about 1 wt %, at least or up to about 2 wt %, at least or up to about 3 wt %, at least or up to about 4 wt %, at least or up to about 5 wt %, at least or up to about 6 wt %, at least or up to about 7 wt %, at least or up to about 8 wt %, at least or up to about 9 wt %, or at least or up to about 10 wt %.

In some embodiments, the amount (e.g., weight) of the cross-linking moiety per volume of the coating composition (w/v %) can be at least or up to about 0.001 wt %, at least or up to about 0.002 wt %, at least or up to about 0.004 wt %, at least or up to about 0.005 wt %, at least or up to about 0.006 wt %, at least or up to about 0.008 wt %, at least or up to about 0.01 w/v %, at least or up to about 0.02 w/v %, at least or up to about 0.04 w/v %, at least or up to about 0.05 w/v %, at least or up to about 0.06 w/v %, at least or up to about 0.08 w/v %, at least or up to about 0.1 w/v %, at least or up to about 0.2 w/v %, at least or up to about 0.4 w/v %, at least or up to about 0.5 w/v %, at least or up to about 0.8 w/v %, at least or up to about 1 w/v %, at least or up to about 2 w/v %, at least or up to about 3 w/v %, at least or up to about 4 w/v %, at least or up to about 5 w/v %, at least or up to about 6 w/v %, at least or up to about 7 w/v %, at least or up to about 8 w/v %, at least or up to about 9 w/v %, or at least or up to about 10 w/v %.

In some embodiments, the volume of the cross-linking moiety per volume of the coating composition can be at least or up to about 0.01 milliliters (ml) of cross-linking moiety per 1 liter (L) of the coating composition, at least or up to about 0.02 ml/L, at least or up to about 0.05 ml/L, at least or up to about 1 ml/L, at least or up to about 1.5 ml/L, at least or up to about 2 ml/L, at least or up to about 3 ml/L, at least or up to about 4 ml/L, at least or up to about 5 ml/L, at least or up to about 6 ml/L, at least or up to about 7 ml/L, at least or up to about 8 ml/L, at least or up to about 9 ml/L, at least or up to about 10 ml/L, at least or up to about 12 ml/L, at least or up to about 15 ml/L, at least or up to about 20 ml/L, at least or up to about 30 ml/L, at least or up to about 40 ml/L, at least or up to about 50 ml/L, or at least or up to about 100 ml/L. In some embodiments, the cross-linking moiety (e.g., APTES) can be provided as a liquid, and a given volume of the cross-linking moiety can have a density of the cross-linking moiety of at least or up to about 0.5 grams per milliliter (g/mL), at least or up to 0.6 g/mL, at least or up to 0.7 g/mL, at least or up to 0.8 g/mL, at least or up to 0.85 g/mL, at least or up to 0.9 g/mL, at least or up to 0.95 g/mL, at least or up to 0.99 g/mL, at least or up to 1 g/mL, at least or up to 1.1 g/mL, at least or up to 1.2 g/mL, at least or up to about 2 g/mL, or at least or up to about 5 g/mL. In some embodiments, a molar concentration of the cross-linking moiety in the coating composition can be at least or up to about 10 micromolar, at least or up to about 20 micromolar, at least or up to about 50 micromolar, at least or up to about 100 micromolar, at least or up to about 200 micromolar, at least or up to about 500 micromolar, at least or up to about 1 millimolar, at least or up to about 2 millimolar, at least or up to about 5 millimolar, at least or up to about 10 millimolar, at least or up to about 20 millimolar, at least or up to about 50 millimolar, or at least or up to about 100 millimolar.

In some embodiments, (i) an adhesion strength between a surface and a biocidal coating generated from a coating composition comprising the cross-linking moiety can be greater than (ii) an adhesion strength between the surface and a control biocidal coating generated from a coating composition lacking the cross-linking moiety, by at least or up to about 1%, at least or up to about 2%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 100%, at least or up to about 200%, at least or up to about 300%, at least or up to about 400%, at least or up to about 500%, or at least or up to about 1,000%. For example, the adhesion strength can be measured by shear strength test (e.g., as measured by ASTM D2197 scrape adhesion test or ASTMD3359 tape adhesion test) or tensile strength test (e.g., as measured by the ATSM D4541 pull-off adhesion test).

In some embodiments, (i) durability or persistency of the biocidal coating generated from a coating composition comprising the cross-linking moiety on a surface can be greater than (ii) durability or persistency of a control biocidal coating generated from a coating composition lacking the cross-linking moiety, by at least or up to about 1%, at least or up to about 2%, at least or up to about 5%, at least or up to about 10%, at least or up to about 15%, at least or up to about 20%, at least or up to about 30%, at least or up to about 40%, at least or up to about 50%, at least or up to about 60%, at least or up to about 70%, at least or up to about 80%, at least or up to about 90%, at least or up to about 100%, at least or up to about 200%, at least or up to about 300%, at least or up to about 400%, at least or up to about 500%, or at least or up to about 1,000%. For example, the durability or persistency can be measured via mass spectrometry or indirectly via biocidal activity.

The durability or persistency of the biocidal coating generated from a coating composition comprising the cross-linking moiety can be at least or up to about 1 day, at least or up to about 2 days, at least or up to about 1 week, at least or up to about 2 weeks, at least or up to about 3 weeks, at least or up to about 4 weeks, at least or up to about 2 months, at least or up to about 3 months, at least or up to about 4 months, at least or up to about 5 months, at least or up to about 6 months, or at least or up to about 1 year.

In some embodiments, the coating composition can comprise a plurality of types of binders. In some embodiments, the plurality of types of binders can comprise the cross-linking moiety (e.g., organosilane moiety) and an additional type of binder. In some embodiments, the additional type of binder can be a part of the biocidal molecule, to provide a reactive site of the biocidal molecule to which the first reacting group of the cross-linking moiety can couple to (e.g., via covalent conjugation).

In some embodiments, the biocidal molecule can comprise (i) the biocidal moiety as provided herein that is coupled to (ii) a plurality of dopamine moieties (e.g., polydopamines). In some embodiments, the plurality of dopamine moieties can be the reactive sites to which the cross-linking moiety can couple. In some embodiments, the cross-linking moiety can be an organosilane moiety (e.g., 3-aminopropyltriethoxysilane), and the organosilane moiety can be utilized to react with (i) the catechol ring of one or more dopamine moieties of the biocidal molecule and (ii) the surface, to bind or trap the biocidal molecule to the surface.

In some embodiments, the one or more dopamine moieties of the biocidal molecule can be oxidized by an oxidizing agent (e.g., via Michael's addition or Schiff base), such that the cross-linking moiety (e.g., organosilane moiety) can react with and couple covalently to the oxidized dopamine. In some embodiments, the coating composition can comprise one oxidizing agent. In some embodiments, the coating composition can comprise a plurality of types of oxidizing agent. Non-limiting examples of an oxidizing agent can include hydrogen peroxide (e.g., 30% hydrogen peroxide), sodium periodate, ozone, ammonium potassium, sodium perchlorate, sodium persulfate, sodium permanganate, sodium dichromate, etc. Non-limiting examples of a combination of two or more types of oxidizing agents can include hydrogen peroxide and sodium periodate, ammonium potassium and sodium perchlorate, ammonium potassium and sodium persulfate, ammonium potassium and sodium permanganate, ammonium potassium and sodium dichromate, etc.

In some embodiments, the coating composition can be a single composition comprising the biocidal molecule, the one or more oxidizing agents, and the one or more cross-linking moieties. In some embodiments, the coating composition can be provided in two or more compositions. In some embodiments, the coating composition can comprise (a) a first composition comprising the biocidal molecule and the one or more oxidizing agents and (b) a second composition comprising the one or more cross-linking moieties. In some embodiments, the coating composition can comprise (a) a first composition comprising the biocidal molecule and the one or more cross-linking moieties and (b) a second composition comprising the one or more oxidizing agents. In some embodiments, the two or more compositions as provided herein can be provided in two or more separate housings. In some embodiments, the two or more separate housings are not coupled together (e.g., are not part of a single unit). In some embodiments, the two or more separate housings are two different chambers within a single housing.

In some embodiments, the molar ratio between (i) the one or more dopamine moieties (e.g., an average number of dopamine-comprising repeating units in the coating composition) and (ii) the one or more oxidizing agents in the coating composition (DOPA:oxidizing agent) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments, the molar ratio in the coating composition (DOPA:oxidizing agent) can be at least or up to about 1:50, at least or up to about 1:40, at least or up to about 1:30, at least or up to about 1:20, at least or up to about 1:15, at least or up to about 1:10, at least or up to about 1:9, at least or up to about 1:8, at least or up to about 1:7, at least or up to about 1:6, at least or up to about 1:5, at least or up to about 1:4, at least or up to about 1:3, at least or up to about 1:2, at least or up to about 1:1, at least or up to about 2:1, at least or up to about 3:1, at least or up to about 4:1, at least or up to about 5:1, at least or up to about 6:1, at least or up to about 7:1, at least or up to about 8:1, at least or up to about 9:1, at least or up to about 10:1, at least or up to about 15:1, at least or up to about 20:1, at least or up to about 30:1, at least or up to about 40:1, or at least or up to about 50:1. In some embodiments, the molar ratio in the coating composition (DOPA:oxidizing agent) can range between about 1:50 and about 50:1, between about 1:40 and about 20:1, or between about 1:20 and about 10:1.

In some embodiments, the volume of the one or more oxidizing agents per volume of the coating composition can be at least or up to about 0.01 milliliters (ml) of cross-linking moiety per 1 liter (L) of the coating composition, at least or up to about 0.02 ml/L, at least or up to about 0.05 ml/L, at least or up to about 1 ml/L, at least or up to about 1.5 ml/L, at least or up to about 2 ml/L, at least or up to about 3 ml/L, at least or up to about 4 ml/L, at least or up to about 5 ml/L, at least or up to about 6 ml/L, at least or up to about 7 ml/L, at least or up to about 8 ml/L, at least or up to about 9 ml/L, at least or up to about 10 ml/L, at least or up to about 12 ml/L, at least or up to about 15 ml/L, at least or up to about 20 ml/L, at least or up to about 30 ml/L, at least or up to about 40 ml/L, at least or up to about 50 ml/L, or at least or up to about 100 ml/L. In some embodiments, the one or more oxidizing agents can be provided as a liquid (e.g., hydrogen peroxide) a given volume of the one or more oxidizing agents can have a density of the one or more oxidizing agents of at least or up to about 0.5 grams per milliliter (g/mL), at least or up to 0.6 g/mL, at least or up to 0.7 g/mL, at least or up to 0.8 g/mL, at least or up to 0.85 g/mL, at least or up to 0.9 g/mL, at least or up to 0.95 g/mL, at least or up to 0.99 g/mL, at least or up to 1 g/mL, at least or up to 1.1 g/mL, at least or up to 1.2 g/mL, at least or up to about 2 g/mL, or at least or up to about 5 g/mL. In some embodiments, a molar concentration of the one or more oxidizing agents in the coating composition can be at least or up to about 10 micromolar, at least or up to about 20 micromolar, at least or up to about 50 micromolar, at least or up to about 100 micromolar, at least or up to about 200 micromolar, at least or up to about 500 micromolar, at least or up to about 1 millimolar, at least or up to about 2 millimolar, at least or up to about 5 millimolar, at least or up to about 10 millimolar, at least or up to about 20 millimolar, at least or up to about 50 millimolar, at least or up to about 100 millimolar, at least or up to about 200 millimolar, at least or up to about 500 millimolar, at least or up to about 1 molar, at least or up to about 2 molar, or at least or up to about 5 molar.

In some embodiments, the biocidal molecule can comprise a polymer comprising a plurality of biocidal molecules as provided herein (e.g., a biocidal polymer). In some embodiments, the additional type of binder (e.g., comprising the plurality of dopamine moieties) can be coupled to the biocidal polymer after synthesis of the biocidal polymer. In some embodiments, the biocidal molecule can comprise a copolymer comprising (i) a first species of repeating unit that comprises a biocidal moiety (e.g., N-halamine precursors or activated N-halamines) and (ii) a second species of repeating unit that is not capable of forming N-halamines and comprises the additional type of binder (e.g., one or more dopamine moieties).

In some embodiments, when generating or synthesizing the biocidal molecule, a first monomer species comprising a biocidal moiety (e.g., N-halamine monomer) and a second monomer species comprising a dopamine (e.g., dopamine monomer) can be mixed at a feed ratio (HA:DOPA) that ranges between about 99:1 and about 1:99, e.g., at least or up to about 1:99, at least or up to about 5:95, at least or up to about 10:90, at least or up to about 15:85, at least or up to about 20:80, at least or up to about 25:75, at least or up to about 30:70, at least or up to about 35:65, at least or up to about 40:60, at least or up to about 45:55, at least or up to about 50:50, at least or up to about 55:45, at least or up to about 60:40, at least or up to about 65:35, at least or up to about 70:30, at least or up to about 75:25, at least or up to about 80:20, at least or up to about 85:15, at least or up to about 90:10, at least or up to about 95:5, or at least or up to about 99:1. In some embodiments, the feed ratio (HA:DOPA) can be about 9.6:0.4, about 9.5:0.5, about 9.4:0.6, about 9.3:0.7, about 9.2:0.8, about 9.1:0.9, about 9.0:1.0, about 8.9:1.1, about 8.8:1.2, about 8.7:1.3, about 8.6:1.4, about 8.5:1.5, about 8.4:1.6, about 8.3:1.7, about 8.2:1.8, about 8.1:1.9, about 8.0:2.0, about 7.9:2.1, about 7.8:2.2, about 7.7:2.3, about 7.6:2.4, about 7.5:2.5, about 7.4:2.6, about 7.3:2.7, about 7.2:2.8, about 7.1:2.9, about 7.0:3.0, about 6.9:3.1, about 6.8:3.2, about 6.7:3.3, about 6.6:3.4, about 6.5:3.5, about 6.4:3.6, about 6.3:3.7, about 6.2:3.8, about 6.1:3.9, about 6.0:4.0, about 5.9:4.1, about 5.8:4.2, about 5.7:4.3, about 5.6:4.4, about 5.5:4.5, about 5.4:4.6, about 5.3:4.7, about 5.2:4.8, about 5.1:4.9, about 5.0:5.0, about 4.9:5.1, about 4.8:5.2, about 4.7:5.3, about 4.6:5.4, about 4.5:5.5, about 4.4:5.6, about 4.3:5.7, about 4.2:5.8, about 4.1:5.9, about 4.0:6.0, about 3.9:6.1, about 3.8:6.2, about 3.7:6.3, about 3.6:6.4, about 3.5:6.5, about 3.4:6.6, about 3.3:6.7, about 3.2:6.8, about 3.1:6.9, about 3.0:7.0, about 2.9:7.1, about 2.8:7.2, about 2.7:7.3, about 2.6:7.4, about 2.5:7.5, about 2.4:7.6, about 2.3:7.7, about 2.2:7.8, about 2.1:7.9, about 2.0:8.0, about 1.9:8.1, about 1.8:8.2, about 1.7:8.3, about 1.6:8.4, about 1.5:8.5, about 1.4:8.6, about 1.3:8.7, about 1.2:8.8, about 1.1:8.9, about 1.0:9.0, about 0.9:9.1, about 0.8:9.2, about 0.7:9.3, about 0.6:9.4, about 0.5:9.5, or about 0.4:9.6. In some embodiments, the molar ratio of the first monomer species and the second monomer species of the copolymer can be about the same (e.g., within a range that is 10%, 5%, 2%, or 1% greater or less than the numerical value) or substantially the same as the feed ratio.

Non-limiting examples of dopamine monomers suitable for incorporation into the copolymers as provided herein can include natural analogues of dopamine such as epinephrine, norepinephrine, L-dihydroxyphenylalanine, and synthetic analogues and derivatives thereof. Non-limiting examples of dopamine monomers can include:

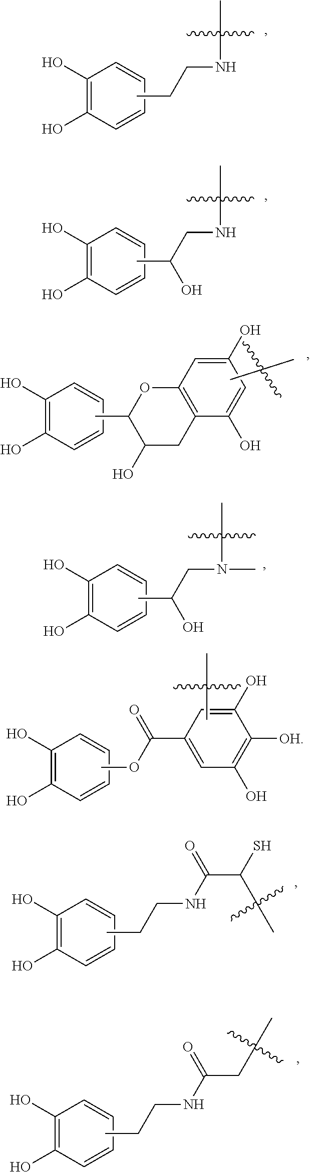

and derivatives thereof.

In some embodiments, the coating composition as provided herein can comprise (i) a biocidal molecule comprising biocidal moieties (e.g., one or more N-halamine precursors or activated derivatives thereof) coupled to a plurality of dopamine moieties; and (ii) a cross-linking moiety. In some embodiments, the coating composition as provided herein can comprise (i) a copolymer comprising (i-a) a first repeating unit comprising a biocidal moiety (e.g., N-halamine precursor or activated N-halamines) and (i-b) a second repeating unit comprising a dopamine or derivative thereof; and (ii) a cross-linking moiety that that chemically cross-links the dopamine or derivative thereof of the second repeating unit to a surface, to enhance formation of a biocidal coating on the surface or a duration of the formed biocidal coating on the surface. In some embodiments of such coating composition, the biocidal moiety can comprise N-halamine precursors (e.g., substantially free of activated N-halamines) when being stored or when being applied to the surface. Alternatively, the biocidal moiety can comprise activated N-halamines (e.g., at least about 50%, at least about 60%, at least about 70%, at least about 80%, at least about 90%, at least about 95%, or substantially about 100% of activatable N-halamines being activated, e.g., as N-chlorinated halamines) when being stored or when being applied to the surface.

In some embodiments, the biocidal molecule (e.g., copolymer) as provided herein can have a repeating unit comprising the structure:

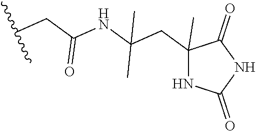

and an additional repeating unit comprising the structure:

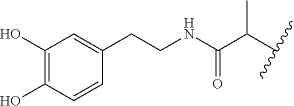

In some embodiments, the biocidal molecule (e.g., copolymer) as provided herein can have a repeating unit comprising the structure:

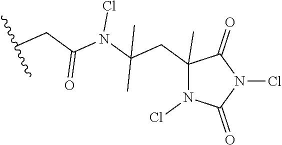

and an additional repeating unit comprising the structure:

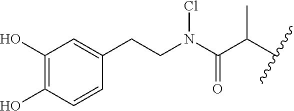

In some embodiments of the coating composition of the present disclosure, a molar ratio between (i) the repeating unit comprising a dopamine or a derivative thereof and (ii) the cross-linking moiety (DOPA:cross-linking moiety) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments of the coating composition of the present disclosure, a molar ratio between (i) the cross-linking moiety and (ii) the repeating unit comprising a dopamine moiety or a derivative thereof (cross-linking moiety:DOPA) can be at least or up to about 1,000:1, at least or up to about 1,000:2, at least or up to about 1,000:5, at least or up to about 1,000:10 (or 100:1), at least or up to about 100:2, at least or up to about 100:5, at least or up to about 100:10 (or 10:1), at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 9:10, at least or up to about 8:10, at least or up to about 7:10, at least or up to about 6:10, at least or up to about 5:10, at least or up to about 4:10, at least or up to about 3:10, at least or up to about 2:10, at least or up to about 1:10 (or 10:100), at least or up to about 5:100, at least or up to about 2:100, at least or up to about 1:100 (or 10:1,000), at least or up to about 5:1,000, at least or up to about 2:1,000, at least or up to about 1:1,000.

In some embodiments, the binder (e.g., the cross-linking moiety) is not polyethyleneimine (PEI). In some embodiments, the binder (e.g., the cross-linking moiety) is not a polymer. In some embodiments, the binder comprises PEI.

In some embodiments, the binder (e.g., the cross-linking moiety) can comprise a plurality of types of binders that can couple to one another (e.g., via hydrogen bonds, electrostatic interaction, and/or chemical bonding). In some embodiments, the plurality of types of binders can include two types of oppositely charged binders, such that at least the electrostatic interaction between the two types of oppositely charged binders (e.g., a cationic binder and an anionic binder) can generate a matrix that can bind or trap at least the biocidal molecule as provided herein. Alternatively or in addition to, the plurality of types of binders can be configured to couple chemically to each other to generate a cross-linked matrix that can bind or trap at least the biocidal molecule as provided herein. In some embodiments, the plurality of types of binders can comprise cationic molecules (e.g., in an aqueous medium exhibiting a pH value or range as provided herein), such as cationic polymers including, but not limited to, PEI, polyamidoamine, polylysine, poly(allylamine), poly(diallyldimethylammonium chloride), etc. In some embodiments, the plurality of types of binders can comprise anionic molecules (e.g., in an aqueous medium exhibiting a pH value or range as provided herein) comprising anionic functional groups including, but not limited to, carboxylate, sulfonate, sulfate, phosphonate, phosphate, nitrate, etc. Non-limiting examples of an anionic molecule can include tannic acid, polyacrylate, and polyacrylamide.

In some embodiments, the plurality of types of binders of the coating composition can comprise PEI and tannic acid. In some embodiments, PEI and tannic acid can generate a cross-linked matrix via (i) electrostatic interaction and/or (i) covalent bonding (e.g., via Michael addition or Schiff base reaction).

In some embodiments, the plurality of types of binders of the coating composition can comprise a first type of binder (e.g., PEI) and a second type of binder (e.g., tannic acid). The ratio (e.g., weight ratio, molar ratio, etc.) between the amount of the first type of binder and the second type of binder in the coating composition can range between about 10:1 and about 1:10, about 10:1 and about 1:8, about 10:1 and about 1:6, about 10:1 and about 1:5, about 10:1 and about 1:4, about 10:1 and about 1:2, about 10:1 and about 1:1, about 10:1 and about 8:1, about 10:1 and about 6:1, about 10:1 and about 5:1, about 10:1 and about 4:1, about 10:1 and about 2:1, about 10:1 and about 1:1, about 9:1 and about 1:10, about 8:1 and about 1:10, about 7:1 and about 1:10, about 6:1 and about 1:10, about 5:1 and about 1:10, about 4:1 and about 1:10, about 3:1 and about 1:10, about 2:1 and about 1:10, or about 1:1 and about 1:10. The ratio (e.g., weight ratio, molar ratio, etc.) between the amount of the first type of binder and the second type of binder in the coating composition can be at least or up to about 10:1, at least or up to about 10:2, at least or up to about 10:3, at least or up to about 10:4, at least or up to about 10:5, at least or up to about 10:6, at least or up to about 10:7, at least or up to about 10:8, at least or up to about 10:9, at least or up to about 10:10 (or 1:1), at least or up to about 2:10, at least or up to about 3:10, at least or up to about 4:10, at least or up to about 5:10, at least or up to about 6:10, at least or up to about 7:10, at least or up to about 8:10, or at least or up to about 9:10.

In some embodiments, a coating generated by a coating composition comprising the biocidal molecule and the cross-linking moiety can be abrasion resistant.

### Biocidal Coatings:

In some embodiments, the coating composition as disclosed herein can be utilized to generate the coating exhibiting the biocidal activity. The coating can be generated on surfaces, such as dried surfaces (e.g., water filtration beads, textiles, etc.). As provided herein, additional non-limiting examples of the surface can include glass, silicon, alumina, quartz, polymer (e.g., polycarbonate), steel (e.g., stainless steel), and metal oxide substrates.

In some embodiments, the coating composition as disclosed herein can be utilized to generate the coating exhibiting the biocidal activity. The coating can be generated on the surface of an object. As provided herein, non-limiting examples of the object include medical devices and applications (e.g., a stent, a catheter, needles, syringes, surgical instruments, surgical implants, a topical antiseptic, an antifungal agent, band aids, wound cleaners, or wound dressings), objects involved in food preparation (e.g., a deli slicer, a microwave oven, a microwave, a cutting board, or cutlery), personal hygiene products (e.g., nail cutters, a nail file, a footbath, a personal massager, a toothbrush, a hair brush), electronic devices (e.g., a video game controller, a mobile device, a keyboard, a mouse, a television screen), household objects (e.g., a door handle, a light switch, a cabinet, a countertop, a vacuum cleaner, a shower curtain, exercise equipment, a chair, or a sofa), personal protective equipment (e.g., gloves, hairnets, helmets, gowns, boots, or glasses), a pipe, a rotor (e.g. a rotor of a boat), or manufacturing articles (e.g., a conveyer belt, a container, or automobile industry plastics).

In some embodiments, the biocidal activity of the coating can be characterized or measured by the ability to kill or reduce (e.g., prevent) colonization of a microorganism. In some embodiments, the microorganism can be a bacterial, fungal (e.g., yeast), protozoal microorganism.

Non-limiting examples of a genus of a bacteria can include Staphylococcus, Acinetobacter, Corynebacterium, Streptococcus, Escherichia, Mycobacterium, Enterococcus, Bacillus, Klebsiella, and Pseudomonas. Non-limiting examples of a bacteria can include Staphylococcus aureus, Staphylococcus epidermidis, Staphylococcus chromogenes, Staphylococcus simulans, Staphylococcus saprophyticus, Staphylococcus haemolyticus, Staphylococcus hyicus, Acinetobacter baumanni, Streptococcus pyogenes, Streptococcus agalactiae, Streptococcus dysgalactiae, Streptococcus uberis, Escherichia coli, Mammary Pathogenic Escherichia coli (MPEC), Bacillus cereus, Bacillus hemolysis, Mycobacterium tuberculosis, Mycobacterium bovis, Mycoplasma bovis, Enterococcus faecalis, Enterococcus faecium, Corynebacterium bovis, Corynebacterium amycolatum, Corynebacterium ulcerans, Klebsiella pneumonia, Klebsiella oxytoca, Enterobacter aerogenes, Arcanobacterium pyogenes, Trueperella pyogenes, Pseudomonas aeruginosa.

Non-limiting limiting examples of a fungal microorganism can include Alternaeria spp, Aspergillus spp, Candidia spp, Fusarium spp, Trichophyton spp, Cryptococcus spp. Histoplasma spp, Microsporum spp, Penicillium spp, Pneumocystis spp Trichosporon spp, Scedos porium spp, Paeciliomyces spp, Acremonium spp, Stachybotrys spp, and Dermatiaceous molds.

Non-limiting examples of a protozoal microorganism can include Neospora Species (e.g. Neospora caninum; Neospora hughesi), Toxoplasma species (e.g. Toxoplasma gondii), Hammondia species (e.g. Hammondia heydorni), Besnoitia species, Cystoisospora species, Frenkelia species, Nephroisospora species, Sarcocystis species, and Hyaloklossia species.

In some embodiments, the microorganism can be an acellular microorganism, such as a virus. Non-limiting examples of a RNA virus can include Coronavirus, Semliki Forest virus, Sindbis virus, Poko virus, Rabies virus, Influenza virus, SV5, Respiratory Syncytial virus. Venezuela equine encephalitis virus, Kunjin virus, Sendai virus, Vesicular stomatitisvirus, and Retroviruses. Non-limiting examples of a DNA virus can include cytomegalo virus, Herpes Simplex, Epstein-Barr virus, Simian virus 40, Bovine papillomavirus, Adeno-associated virus, Adenovirus, Vaccinia virus, and Baculo virus.

In some embodiments, the biocidal coating can be generated on a surface (i) with the N-halamine precursors activated (e.g., as N-chlorinated halamines) in the coating composition prior to the coating or (ii) with non-activated N-halamine precursors which are then activated (e.g., chlorinated) subsequent to the formation of the biocidal coating. For example, a solution comprising the halogen source (e.g., electrophilic chlorines) can be sprayed over the biocidal coating. In some embodiments, the biocidal coating comprising the activated N-halamines can exhibit one or more of the following characteristics and further described herein: durability, persistency, chlorine retention, and reduction microorganism inoculum.

In some embodiments, a coating composition comprising the biocidal molecule of the present disclosure (e.g., in absence of a binder such as a cross-linking moiety that is capable of making a chemical bond to a surface in need of a biocidal coating) can be applied to the surface to generate a biocidal coating, and the resulting biocidal coating can exhibit durability or persistency on the surface for a short duration of time (e.g., less than about 10 days, less than about 5 days, less than about 2 days, less than about 1 day, less than about 12 hours, etc.), thereby exhibiting short-term residual biocidal activity. Thus, the resulting biocidal coating may not be a permanent coating on the surface. In some embodiments, the resulting biocidal coating may be removed with minimal force (e.g., minimal shear force from wiping the surface).

In some embodiments, a coating composition comprising the biocidal molecule and at least one binder (e.g., the cross-linking moiety that is capable of making a chemical bond to a surface in need of a biocidal coating) of the present disclosure can be applied to the surface to generate a biocidal coating, and the resulting biocidal coating can exhibit enhanced durability or persistency on the surface (e.g., for at least or up to about 1 week, at least or up to about 2 weeks, at least or up to about 3 weeks, at least or up to about 4 weeks, at least or up to about 6 weeks, at least or up to about 2 months, or at least or up to about 3 months), thereby exhibiting enhanced residual biocidal activity. In some embodiments, the resulting biocidal coating is not a permanent coating on the surface.

In some embodiments, chlorine retention of the biocidal coating of the present disclosure can be observed for at least or up to about 12 hours, at least or up to about 24 hours, at least or up to about 2 days, at least or up to about 3 days, at least or up to about 4 days, at least or up to about 5 days, at least or up to about 6 days, at least or up to about 7 days, at least or up to about 8 days, at least or up to about 9 days, at least or up to about 10 days, at least or up to about 11 days, at least or up to about 12 days, at least or up to about 13 days, at least or up to about 14 days, at least or up to about 3 weeks, at least or up to about 4 weeks, at least or up to about 2 months, at least or up to about 3 months, at least or up to about 4 months, or at least or up to about 6 months. In some embodiments, chlorine retention can be characterized as retaining at least about 70%, at least about 80%, at least about 85%, at least about 90%, at least about 95%, or at least about 99% of the initial amount of chlorine. In some embodiments, changing concentration(s) of the content(s) of the coating composition (e.g., biocidal molecule, binder, additives, etc.) can effectively yield a target duration of chlorine retention in the biocidal coating.

In some embodiments, the coating composition can be a liquid formulation. In the liquid formation as disclosed herein, an amount of the N-halamine precursors and/or the activated N-halamine derivatives thereof can be sufficient to pass the standard disinfecting testing and the residual disinfecting testing, or contain enough biocidal agents (e.g., N-halamines and/or other biocides, such as QACs) to pass the standard disinfecting testing and utilize the N-halamine molecules to pass the residual disinfecting testing. In some examples, the biocidal agent used to pass the disinfecting testing can be chlorine, either alone or in combination with N-halamine, because excess chlorine can stabilize the chlorine bound to the activated N-halamine. For example, the liquid formulation can comprise an amount of chlorine that is greater than is the molar equilibrium of N-halamines. Alternatively, when chlorine is not used as the primary biocide for the standard disinfectant testing, one or more additives as disclosed herein can be used, e.g., to ensure that the chlorine bound to the N-halamine molecules are stable over the product life.

In some embodiments, the coating generated by the compositions and methods of the present invention can meet one or more requirements for a disinfectant product exhibiting residual efficacy (e.g., biocidal activity beyond the time of application or generation of the coating), e.g., in accordance with the Interim Guidance by the EPA. For example, the coating as disclosed herein can yield effective reduction of microorganism inoculum, such as, for example, about 5-log reduction of bacteria and/or 3-log reductions of viruses in 10 minutes or less. In another example, the coating as disclosed herein can provide at least about 24-hour residual claim against microorganisms (e.g., bacteria and/or viruses). In some embodiments, the coating as disclosed herein can meet the EPA's requirements under both (i) standard disinfecting testing to qualify as a disinfectant and (ii) the residual disinfecting testing, wherein the standards for (i) and (ii) are different.

In some embodiments, the coating (or biocidal coating) as disclosed herein can yield at least about 1-log reduction, at least about 2-log reduction, at least about 3-log reduction, at least about 4-log reduction, at least about 5-log reduction, at least about 6-log reduction, at least about 7-log reduction, at least about 8-log reduction, at least about 9-log reduction, at least about 10-log reduction, at least about 11-log reduction, at least about 12-log reduction, at least about 13-log reduction, at least about 14-log reduction, at least about 15-log reduction, at least about 16-log reduction, at least about 17-log reduction, at least about 18-log reduction, at least about 19-log reduction, at least about 20-log reduction, at least about 25-log reduction, at least about 30-log reduction, at least about 40-log reduction, at least about 50-log reduction, or more of microorganism (e.g., bacteria and/or viruses) within a given time. Such given time can be at most about 2 weeks, at most about 1 week, at most about 6 days, at most about 5 days, at most about 4 days, at most about 3 days, at most about 2 days, at most about 1 day, at most about 12 hours, at most about 11 hours, at most about 10 hours, at most about 9 hours, at most about 8 hours, at most about 7 hours, at most about 6 hours, at most about 5 hours, at most about 4 hours, at most about 3 hours, at most about 2 hours, at most about 1 hour, at most about 30 minutes, 2 at most about 0 minutes, at most about 15 minutes, at most about 14 minutes, at most about 13 minutes, at most about 12 minutes, at most about 11 minutes, at most about 10 minutes, at most about 9 minutes, at most about 8 minutes, at most about 7 minutes, at most about 6 minutes, at most about 5 minutes, at most about 4 minutes, at most about 3 minutes, at most about 2 minutes, at most about 1 minute, at most about 30 seconds, or less. For example, the coating can yield at least about 8-log reduction of bacteria in at most about 10 minutes (e.g., at most about 9 minutes, at most about 5 minutes, at most about 1 minute, or at most about 30 seconds, or less). For example, the coating can yield at least about 6-log reduction of bacteria in at most about 10 minutes (e.g., at most about 9 minutes, at most about 5 minutes, or less). In another example, the coating can yield at least about 3-log reduction of viruses in at most about 10 minutes (e.g., at most about 9 minutes, at most about 5 minutes, or less). Such biocidal activity can be ascertained by performing cytotoxicity assay against the microorganism (e.g., bacteria and/or viruses) in vitro at a temperature of at least or up to about −10 degrees Celsius, at least or up to about −5 degrees Celsius, at least or up to about 0 degree Celsius, at least or up to about 4 degrees Celsius, at least or up to about 5 degrees Celsius, at least or up to about 10 degrees Celsius, at least or up to about 15 degrees Celsius, at least or up to about 20 degrees Celsius, at least or up to about 25 degrees Celsius, at least or up to about 30 degrees Celsius, at least or up to about 40 degrees Celsius, or at least or up to about degrees Celsius.

In some embodiments, an amount of one or more biocidal moieties (e.g., a N-halamine precursors or the activated N-halamine derivative thereof) required to achieve the biocidal activity of the coating as disclosed herein (e.g., as measured in log reduction of target bacteria or viruses) can be less than an amount of control biocides (e.g., quaternary ammonium compounds (QACs)) needed in a control coating to yield a similar level of the biocidal activity. Such amounts can be (i) a concentration (e.g., weight percent) of the one or more biocidal moieties in the coating and (ii) a concentration (e.g., weight percent) of the control biocides in the control coating. The amount of the one or more biocidal moieties in the coating can be less than the amount of the control biocides in the control coating by at least about 0.5-fold, at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, at least about 50-fold, at least about 60-fold, at least about 70-fold, at least about 80-fold, at least about 90-fold, at least about 100-fold, or more. The amount of the one or more biocidal moieties in the coating can be less than the amount of the control biocides in the control coating by at least about 1%, at least about 2%, at least about 3%, at least about 4%, at least about 5%, at least about 10%, at least about 15%, at least about 20%, at least about 30%, at least about 40%, at least about 50%, at least about 60%, at least about 70%, at least about 80%, at least about 90%, at least about 95%, at least about 99%, or more.

In some embodiments, an amount of an activator of the biocidal moiety (e.g., a halogen, such as chlorine) required to achieve the biocidal activity of the coating as disclosed herein (e.g., as measured in log reduction of target bacteria or viruses) can be less than an amount of control biocides (e.g., QACs) needed in a control coating to yield a similar level of the biocidal activity. Such amounts can be (i) a concentration (e.g., weight percent) of the activator in the coating and (ii) a concentration (e.g., weight percent) of the control biocides in the control coating. The amount of the activator in the coating can be less than the amount of the control biocides in the control coating by at least about 0.5-fold, at least about 1-fold, at least about 2-fold, at least about 3-fold, at least about 4-fold, at least about 5-fold, at least about 6-fold, at least about 7-fold, at least about 8-fold, at least about 9-fold, at least about 10-fold, at least about 15-fold, at least about 20-fold, at least about 30-fold, at least about 40-fold, at least about 50-fold, at least about 60-fold, at least about 70-fold, at least about 80-fold, at least about 90-fold, at least about 100-fold, or more. The amount of the activator in the coating can be less than the amount of the control biocides in the control coating by at least about 1%, at least about 2%, at least about 3%, at least about 4%, at least about 5%, at least about 10%, at least about 15%, at least about 20%, at least about 30%, at least about 40%, at least about 50%, at least about 60%, at least about 70%, at least about 80%, at least about 90%, at least about 95%, at least about 99%, or more.

In some embodiments, the biocidal coating generated with the coating composition as provided herein can exhibit enhanced resistance to abrasion. In some embodiments, resistance to abrasion can be measured by EPA MB-40 method, in which the biocidal coating generated on a brushed stainless-steel surface is abraded one or more times by application of Chem A solution (e.g., 2,000 ppm NaOCl). In some embodiments, the biocidal coating can comprise N-chlorinated halamines (initial chlorine loading), and subsequent to the abrasion(s), the biocidal coating can comprise at least or up to about 70%, at least or up to about 75%, at least or up to about 80%, at least or up to about 85%, at least or up to about 90%, at least or up to about 95%, at least or up to about 99%, or about 100% of the initial chlorine loading. In some embodiments, when the abrasion is performed via a solution comprising a chlorine source (e.g., Chem A solution), the coating composition can trap or bind to the chlorine source (e.g., via available non-chlorinated N-halamine precursors). Accordingly, subsequent to the abrasion(s), the coating composition can comprise more chlorine content than the initial loading, by at least or up to about 1%, at least or up to about 2%, at least or up to about 5%, at least or up to about 10%, at least or up to about 15%, at least or up to about 20%, at least or up to about 30%, at least or up to about 40%, at least or up to about 50%, or at least or up to about 100%.

In some embodiments, the biocidal coating generated with the coating composition as provided herein can exhibit comparable biocidal activity (e.g., killing microorganisms) when compared prior to and subsequent to the abrasion(s). In some embodiments, the biocidal activity of the coating when measured subsequent to the abrasion(s) can be at least or up to about 70%, at least or up to about 75%, at least or up to about 80%, at least or up to about 85%, at least or up to about 90%, at least or up to about 95%, at least or up to about 99%, or about 100% of that of the biocidal activity of the coating when measured prior to any abrasion(s).

In some embodiments, the biocidal coating generated with the coating composition as provided herein can exhibit chlorine density (e.g., as measured prior to or subsequent to abrasion(s)) of at least or up to about 1 10\hat{ }10 chlorine atoms per centimeter squared (10\hat{ }10 Cl⁺ atoms/cm\hat{ }2), at least or up to about 2 10\hat{ }10 Cl⁺ atoms/cm\hat{ }2, at least or up to about 5 10\hat{ }10 Cl⁺ atoms/cm\hat{ }2, at least or up to about 1 10\hat{ }11 Cl⁺ atoms/cm\hat{ }2, at least or up to about 2 10\hat{ }11 Cl⁺ atoms/cm\hat{ }2, at least or up to about 5 10\hat{ }11 Cl⁺ atoms/cm\hat{ }2, at least or up to about 1 10\hat{ }12 Cl⁺ atoms/cm\hat{ }2, at least or up to about 2 10\hat{ }12 Cl⁺ atoms/cm\hat{ }2, at least or up to about 5 10\hat{ }12 Cl⁺ atoms/cm\hat{ }2, at least or up to about 1 10\hat{ }13 Cl⁺ atoms/cm\hat{ }2, at least or up to about 2 10\hat{ }13 Cl⁺ atoms/cm\hat{ }2, at least or up to about 5 10\hat{ }13 Cl⁺ atoms/cm\hat{ }2, at least or up to about 1 10\hat{ }14 Cl⁺ atoms/cm\hat{ }2, at least or up to about 2 10\hat{ }14 Cl⁺ atoms/cm\hat{ }2, at least or up to about 5 10\hat{ }14 Cl⁺ atoms/cm\hat{ }2, at least or up to about 1 10\hat{ }15 Cl⁺ atoms/cm\hat{ }2, at least or up to about 2 10\hat{ }15 Cl⁺ atoms/cm\hat{ }2, at least or up to about 5 10\hat{ }15 Cl⁺ atoms/cm\hat{ }2, at least or up to about 1 10\hat{ }16 Cl⁺ atoms/cm\hat{ }2, at least or up to about 2 10\hat{ }16 Cl⁺ atoms/cm\hat{ }2, at least or up to about 5 10\hat{ }16 Cl⁺ atoms/cm\hat{ }2, at least or up to about 1 10\hat{ }17 Cl⁺ atoms/cm\hat{ }2, at least or up to about 2 10\hat{ }17 Cl⁺ atoms/cm\hat{ }2, at least or up to about 5 10\hat{ }17 Cl⁺ atoms/cm\hat{ }2, at least or up to about 1 10\hat{ }18 Cl⁺ atoms/cm\hat{ }2, at least or up to about 2 10\hat{ }18 Cl⁺ atoms/cm\hat{ }2, at least or up to about 5 10\hat{ }18 Cl⁺ atoms/cm\hat{ }2, at least or up to about 1 10\hat{ }19 Cl⁺ atoms/cm\hat{ }2, at least or up to about 2 10\hat{ }19 Cl⁺ atoms/cm\hat{ }2, at least or up to about 5 10\hat{ }19 Cl⁺ atoms/cm\hat{ }2, at least or up to about 1 10\hat{ }20 Cl⁺ atoms/cm\hat{ }2, at least or up to about 2 10\hat{ }20 Cl⁺ atoms/cm\hat{ }2, or at least or up to about 5 10\hat{ }20 Cl⁺ atoms/cm\hat{ }2.

### EXAMPLES

### Example 1: Liquid Formulations

The coating composition as disclosed herein can be a liquid composition usable for forming the coating that exhibits biocidal activity.

### A. Polymeric Biocidal Moiety:

In some embodiments, an example liquid composition comprises a polymer comprising N-halamine precursors and/or activated N-halamines (e.g., chlorinated N-halamines).

In some embodiments, an example liquid composition comprises (i) a polymer comprising N-halamine precursors and/or activated N-halamines (e.g., chlorinated N-halamines) and (ii) a halogen source (e.g., excess halogen source) (e.g., chlorine source, such as sodium hypochlorite), such that a total number of chlorine atoms present in the liquid composition is greater than the number of chlorine atoms required to activate substantially all of the N-halamines in the liquid composition.

### B. Small Molecule Biocidal Moiety:

In some embodiments, an example liquid composition comprises N-halamine precursors and/or activated N-halamines (e.g., chlorinated N-halamines) and separately a binder (e.g., a polymeric binder). The N-halamine precursors and/or activated N-halamines are small molecules that are not covalently coupled to the binder.

In some embodiments, an example liquid composition comprises (i) N-halamine precursors and/or activated N-halamines (e.g., chlorinated N-halamines), (ii) a binder (e.g., a polymeric binder), and (iii) a halogen source (e.g., excess halogen source) (e.g., chlorine source, such as sodium hypochlorite), such that a total number of chlorine atoms present in the liquid composition is greater than the number of chlorine atoms required to activate substantially all of the N-halamines in the liquid composition. The activated N-halamines are small molecules that are not covalently coupled to the binder.

In some embodiments, an example liquid composition comprising N-halamine precursors and/or activated N-halamines (e.g., chlorinated N-halamines). The N-halamine precursors and/or activated N-halamines are small molecules that are not part of a polymer. The liquid composition does not comprise any binder, such as a polymeric binder.

In some embodiments, an example liquid composition comprises (i) N-halamine precursors and/or activated N-halamines (e.g., chlorinated N-halamines), and (ii) a halogen source (e.g., excess halogen source) (e.g., chlorine source, such as sodium hypochlorite), such that a total number of chlorine atoms present in the liquid composition is greater than the number of chlorine atoms required to activate substantially all of the N-halamines in the liquid composition. The N-halamine precursors and/or activated N-halamines are small molecules that are not part of a polymer. The liquid composition does not comprise any binder, such as a polymeric binder.

### Example 2: Solid Formulations

The coating composition as disclosed herein can be a solid composition (e.g., one or more tablets) usable (e.g., upon mixing with a solvent) for forming the coating that exhibits biocidal activity.

### A. Polymeric Biocidal Moiety:

In some embodiments, an example tablet composition comprises a polymer comprising N-halamine precursors and/or activated N-halamines (e.g., chlorinated N-halamines).

In some embodiments, an example tablet composition comprises (i) a polymer comprising N-halamine precursors and/or activated N-halamines (e.g., chlorinated N-halamines) and (ii) a halogen source (e.g., excess halogen source) (e.g., chlorine source, such as sodium hypochlorite), such that a total number of chlorine atoms present in the tablet composition is greater than the number of chlorine atoms required to activate substantially all of the N-halamines in the tablet composition.

### B. Small Molecule Biocidal Moiety:

In some embodiments, an example tablet composition comprises N-halamine precursors and/or activated N-halamines (e.g., chlorinated N-halamines) and separately a binder (e.g., a polymeric binder). The N-halamine precursors and/or activated N-halamines are small molecules that are not covalently coupled to the binder.

In some embodiments, an example tablet composition comprises (i) N-halamine precursors and/or activated N-halamines (e.g., chlorinated N-halamines), (ii) a binder (e.g., a polymeric binder), and (iii) a halogen source (e.g., excess halogen source) (e.g., chlorine source, such as sodium hypochlorite), such that a total number of chlorine atoms present in the tablet composition is greater than the number of chlorine atoms required to activate substantially all of the N-halamines in the tablet composition. The N-halamine precursors and/or activated N-halamines are small molecules that are not covalently coupled to the binder. In some embodiments, the N-halamine precursors and/or activated N-halamines, the binder, and the halogen source (e.g., the excess halogen source) can be mixed into a single tablet. Alternatively, (i) the N-halamine precursors and/or activated N-halamines and the binder can be mixed into a single tablet, and (ii) the halogen source can be provided in a separate tablet.

In some embodiments an example tablet composition comprises N-halamine precursors and/or activated N-halamines (e.g., chlorinated N-halamines). The N-halamine precursors and/or activated N-halamines are small molecules that are not part of a polymer. The tablet composition does not comprise any binder, such as a polymeric binder.

In some embodiments, an example tablet composition comprises (i) N-halamine precursors and/or activated N-halamines (e.g., chlorinated N-halamines), and (ii) a halogen source (e.g., excess halogen source) (e.g., chlorine source, such as sodium hypochlorite), such that a total number of chlorine atoms present in the tablet composition is greater than the number of chlorine atoms required to activate substantially all of the N-halamines in the tablet composition. The N-halamine precursors and/or activated N-halamines are small molecules that are not part of a polymer. The tablet composition does not comprise any binder, such as a polymeric binder. In some embodiments, the N-halamine precursors and/or activated N-halamines and the halogen source (e.g., the excess halogen source) can be mixed into a single tablet. Alternatively, (i) the N-halamine precursors and/or activated N-halamines can be in a tablet, and (ii) the halogen source can be provided in a separate tablet.

### Example 3: Synthesis of a Sample of Polymers Comprising N-Halamine Precursors or Derivatives Thereof

Free radical polymerization can be utilized to synthesize various copolymers comprising (i) a first repeating unit comprising N-halmine precursors or derivatives thereof and (ii) a second repeating unit that is not capable of forming an N-halamine. The second repeating unit can comprise a side group (e.g., one or more water-soluble moieties) that can impart to the resulting copolymers enhanced dissolvability in water. In some cases, free radical polymerization can be used to synthesize a sample of copolymers having a high number average molar mass (e.g., greater than or equal to 10 kDa, greater than or equal to 50 kDa, etc.). The resulting copolymers can be assessed for their dissolvability or solubility (e.g., maximum dissolvable concentration) in an aqueous medium, such as deionized water.

Synthesis of Copolymers Comprising a Monomer with a Sulfonic Acid Moiety

Copolymers with 2-Propenamide, N-[1,1-dimethyl-2-(4-methyl-2,5-dioxo-4-imidazolidinyl)ethyl]-(HA) and 2-acrylamido-2-methyl-1-propanesulfonic acid, sodium salt (SA) monomers p(HA-co-SA) were synthesized by free radical polymerization according to the reaction scheme below:

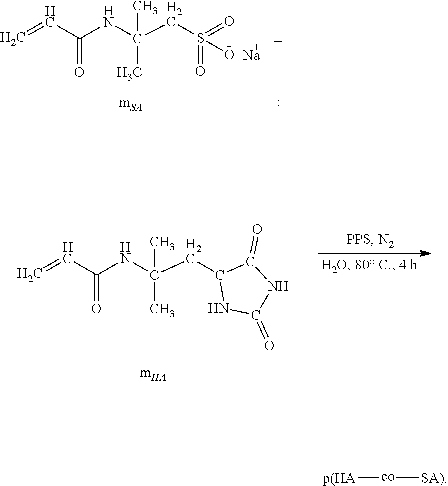

To determine the effect of monomer ratio on solubility of the polymer, various polymers were synthesized according to the monomer feed ratios detailed in TABLE 1. For example, to prepare a p(HA-co-SA) copolymer (HASA) with a 50:50 monomer feed ratio of HA:SA (HASA55), 23.9 g of HA and 45.9 g of SA (50 wt % solution in water) were added to 500 mL of deionized water in a 1 L round bottom flask. The reaction mixture was stirred with moderate mixing until complete dissolution of the monomers. Polymerization was initiated by adding 0.47 g of potassium persulfate (PPS) into the reaction flask and the resulting mixture purged with nitrogen gas for approximately 30 minutes with continuous stirring. The reaction mixture was heated to 80° C. for 4 hours to ensure polymerization of the monomers. After 4 hours, the reaction mixture was evaporated using a Rotovapor to isolate the HASA copolymer in a dry powder form. The isolated HASA copolymer was further dried in a vacuum oven at 30° C. for 24 hours to ensure complete removal of moisture from the sample.

TABLE 1

| Polymer ID | *m_{HA} | *m_{SA} |
|---|---|---|
| HASA55 | 0.5 | 0.5 |
| HASA64 | 0.6 | 0.4 |
| HASA73 | 0.7 | 0.3 |

*m_{HA} and m_{SA}: mole fraction of HA and SA monomers in the feed

Synthesis of Copolymers Comprising a Monomer with a Quaternary Ammonium Moiety

Copolymers containing HA and 2-(methacryloyloxy)ethyl]trimethylammonium chloride (Q) monomers, p(HA-co-Q), were synthesized according to the reaction scheme below.

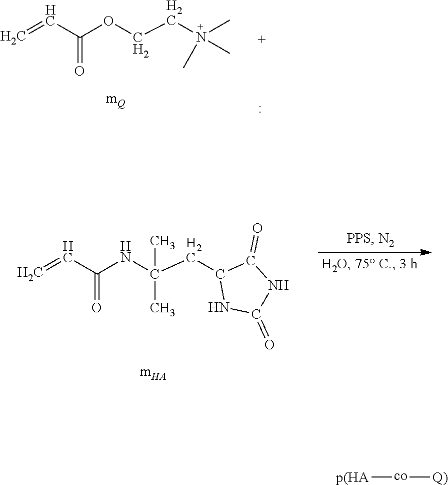

To determine the effect of monomer ratio on water solubility of the polymer, polymers with varying HA:Q monomer feed ratios were synthesized. For example, to prepare a p(HA-co-Q) copolymer with a 50:50 monomer feed ratio of HA:Q (HAQ55), 2.39 g of HA and 2.78 g of Q (75 wt % solution in water) were added to 50 mL of deionized water in a 50 mL round bottom flask. The reaction mixture was stirred with moderate mixing until complete dissolution of the monomers. Polymerization was initiated by adding 0.05 g of PPS to the reaction flask and the resulting mixture purged with nitrogen gas for approximately 30 minutes with continuous stirring. The reaction mixture was heated to 75° C. for 3 hours. After 3 hours, the reaction solvent was evaporated using a rotovapor to isolate the HAQ copolymer in a dry powder form. The isolated HAQ copolymer was further dried in a vacuum oven at 30° C. for 24 hours to ensure complete removal of moisture from the sample.
Copolymers Comprising a Monomer with an Acrylamide Moiety

Copolymers containing HA and acrylamide (AM) monomers, p(HA-co-AM), were synthesized according to the reaction scheme below.

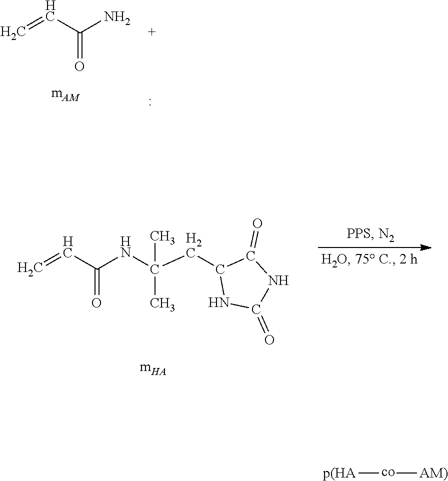

To determine the effect of monomer ratio on water solubility of the polymer, polymers with varying HA:AM monomer feed ratios were synthesized. To prepare a p(HA-co-AM) copolymer with a 50:50 monomer feed ratio of HA:AM (HAAM55), 5.98 g of HA and 1.78 g of AM were added to 100 mL of deionized water in a 200 mL round bottom flask. The reaction mixture was stirred with moderate mixing until complete dissolution of the monomers. Polymerization was initiated by adding 0.08 g of PPS to the reaction flask and the resulting mixture purged with nitrogen gas for approximately 30 minutes with continuous stirring. The reaction mixture was heated to 75° C. for 2 hours to. After 2 hours, the solvent was evaporated using a rotovapor to isolate the HAAM copolymer in a dry powder form. The isolated HAAM copolymer was further dried in a vacuum oven at 30° C. for 24 hours to ensure complete removal of moisture from the sample.
Copolymers Comprising a Monomer with an Acrylic Acid Moiety

Copolymers containing HA and acrylic acid (OH) monomers, p(HA-co-OH), were synthesized according to the reaction scheme below.

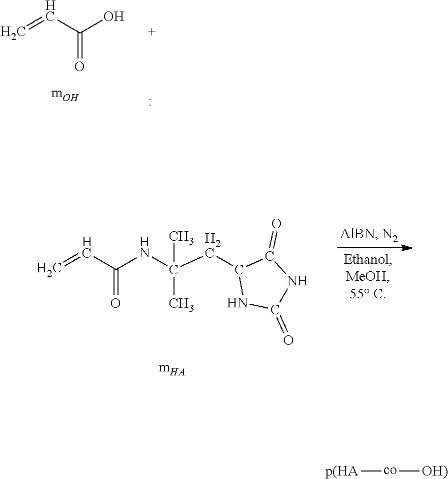

To determine the effect of monomer ratio on water solubility of the polymer, polymers with varying HA:OH monomer feed ratios were synthesized. For example, to prepare a p(HA-co-OH) copolymer with a 50:50 monomer feed ratio of HA:OH (HAOH55), 8.37 g of HA and 2.52 g of OH monomers were added to 250 mL of a mixture of methanol and ethanol in a 250 mL round bottom flask. The reaction mixture was stirred with moderate mixing until complete dissolution of the monomers. Polymerization was initiated by adding 0.11 g of azobisisobutyronitrile (AIBN) to the reaction flask and the resulting mixture purged with nitrogen gas for approximately 30 minutes with continuous stirring and the reaction mixture heated to 55° C. for 4 hours. After 4 hours, the solvent was evaporated using a rotovapor to isolate the HAOH copolymer. The isolated HAOH copolymer was further dried in a vacuum oven for 48 hours to ensure complete removal of moisture from the sample.

### Solubility of HA Copolymers in Water

The solubility of synthesized HA copolymers in water was assessed by dissolving a sample of each copolymer in water and observing the appearance of the copolymer solution. To assess the water solubility of HASA55, 0.41 g of isolated HASA55 copolymer was dissolved in 1 mL of deionized water at room temperature and the resulting mixture was stirred using a magnetic stir bar until complete dissolution of the copolymer in the water, yielding a 41% w/v HASA55 solution. The solution was assessed visually for the appearance of a clear solution and for the presence of insoluble particles. The 41% w/v HASA55 solution was observed to be a clear solution containing no insoluble particles. The 41% w/v HASA55 solution was observed to have high viscosity such that higher concentrations of HASA55 could not be assessed. Accordingly 41% w/v was determined to be the maximum soluble concentration of HASA55 copolymer in deionized water. The analysis was repeated for HASA64, HASA73, HAQ55, HAAM55, and HAOH55, and the pH of a 1 wt % copolymer solution measured using a Mettler Toledo pH meter. TABLE 2 summarizes the water solubility and pH of 1 wt % copolymer solutions.

TABLE 2

| | Concentration | Appearance in | pH of 1 wt % |
|---|---|---|---|
| Copolymer ID | w/v % | solution | solution |
| HASA55 | 41< | Clear | 4.9 |
| HASA64 | 33 | Clear | Not measured |
| HASA73 | 15 | Clear | 3.7 |
| HAQ55 | 17 | Clear | 4.1 |
| HAAM55 | NA | Not soluble | NA |
| HAOH55 | NA | Not soluble | NA |

HASA polymers with increasing monomer feed ratios of SA to HA were observed to have higher maximum soluble concentrations in deionized water. The observation indicates that altering the monomer composition of a N-halamine copolymer can affect copolymer properties, such as water solubility.

HAAM55 and HAOH55 did not dissolve in deionized water. To determine whether the pH of the solution affected polymer solubility, the solubility of HAAM55 and HAOH55 in alkaline water pH 13.2 was assessed and the pH of a 1 wt % solution measured using a Mettler Toledo pH meter. TABLE 3 summarizes the water solubility and pH of 1 wt % HAAM55 and HAOH55.

TABLE 3

| | | Appearance in | |
|---|---|---|---|
| Copolymer ID | Solubility | solution | pH of 1 wt % solution |
| HAAM55 | Soluble | Clear | 13 |
| HAOH55 | Soluble | Clear | Not tested |

Polymers insoluble in deionized water were observed to be soluble in alkaline water. The observation indicates that increasing the pH of a solution can increase the solubility of N-Halamine copolymers.

### Example 4: Synthesis of a Sample of Polymers Comprising N-Halamine Precursors or Derivatives Thereof

Reversible addition-fragmentation chain-transfer (RAFT) polymer chemistry can be utilized to synthesize various copolymers comprising (i) a first repeating unit comprising N-halamine precursors or derivatives thereof and (ii) a second repeating unit that is not capable of forming an N-halamine. The second repeating unit can comprise a side group (e.g., one or more water-soluble moieties) that can impart to the resulting copolymers enhanced dissolvability in water. In some cases, RAFT polymer chemistry can be used to synthesize a sample of copolymers having a low number average molar mass (e.g., less than or equal to 10 kDa, less than or equal to 50 kDa, etc.). The resulting copolymers can be assessed for their dissolvability or solubility (e.g., maximum dissolvable concentration) in an aqueous medium, such as deionized water.

### Screening of RAFT Reagents and RAFT Initiators

A panel of RAFT reagents and RAFT initiators were screened to determine a suitable combination of reagent and initiator for polymerization of HA and SA, AA, Q, or AM monomers. RAFT reagents and RAFT initiators were screened to determine the effective combinations of reagent and initiator for polymerization in aqueous solvent. To ensure that the aqueous solvent did not hydrolyze RAFT reagents, the pH of the aqueous solvent was adjusted with acetic acid to pH 5.0. Polymerization of HA with SA and Q monomers proceeded according to the reaction scheme below and the yield of the polymer assessed. 4-((((2-carboxyethyl)thio)carbonothioyl)thio)-4-cyanopentanoic acid and 4,4′-azobis(4-cyanovaleric acid) (ACVA) were identified as suitable RAFT reagent and RAFT initiator, respectively.

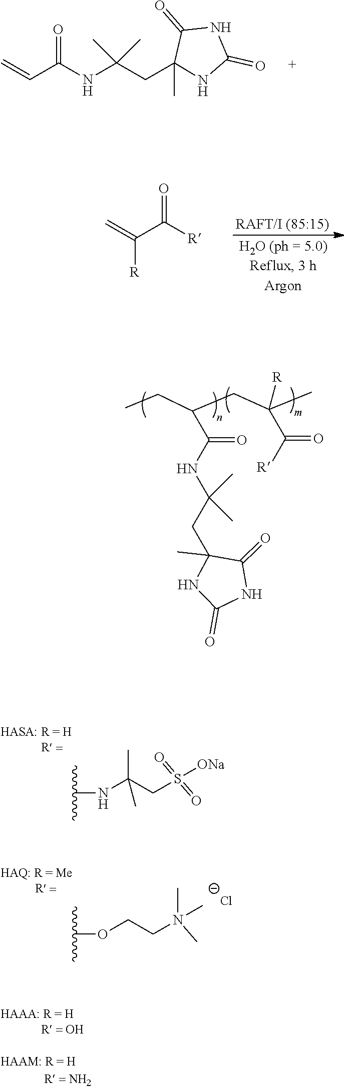

### Synthesis and Characterization of HASA55

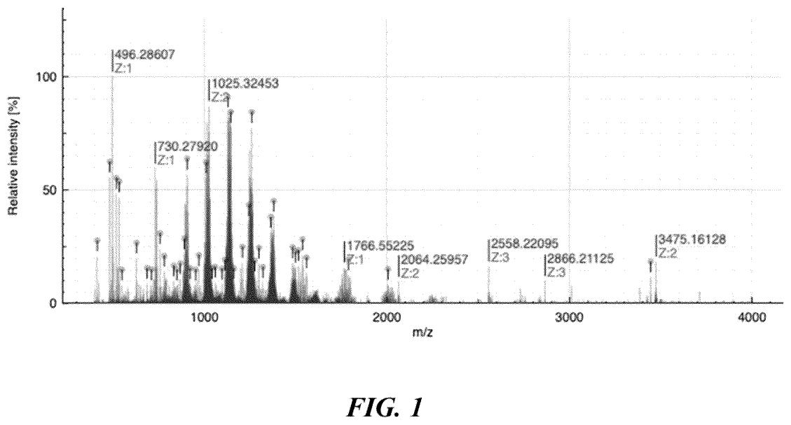

10.21 g HA and 19.58 g SA (50 wt % solution in water) were added to 200 mL of pH 5.0 water in a 500 mL round bottom flask. Following mixing and dissolution of the monomers, the reaction mixture was spagred with argon gas for 30 minutes and 2.99 g of 4-((((2-carboxyethyl)thio)carbonothioyl)thio)-4-cyanopentanoic acid 0.481 g of ACVA added. After 30 minutes, the reaction mixture was sealed with a stoppered reflux condenser and the reaction mixture heated to reflux for 3 hours. After 3 hours of reflux, the reaction was quenched in an ice bath with the addition of an excess of hydroquinone added to the reaction. Following quenching, the aqueous solvent was removed under vacuum to yield a yellow powder. The molecular weight of the synthesized polymer prepared in water was then analyzed by electron spray ionization (ESI) mass spectrometry. FIG. 1 shows an ESI mass spectrum of HASA55 in water. This result indicates that approximate molecular weight of the polymer was 2-3 kilodaltons (kDa).

### Synthesis and Characterization of HASA73

14.18 g HA and 11.65 g SA (50 wt % solution in water) were added to 200 mL of pH 5.0 water in a 500 mL round bottom flask. Following mixing and dissolution of the monomers, the reaction mixture was sparged with argon gas for 30 minutes and 2.99 g of 4-((((2-carboxyethyl)thio)carbonothioyl)thio)-4-cyanopentanoic acid 0.481 g of ACVA added. After 30 minutes, the reaction mixture was sealed with a stoppered reflux condenser and the reaction mixture heated to reflux for 3 hours. After 3 hours of reflux, the reaction was quenched in an ice bath with the addition of an excess of hydroquinone added to the reaction. Following quenching, the aqueous solvent was removed under vacuum to yield a yellow powder. The synthesized polymer was then characterized by ESI-mass spectrometry and the polymer was determined to have an approximate molecular weight of 2-3 kDa.

### Synthesis and Characterization of HAQ55

10.71 g of HA and 11.61 g Q (75 wt % solution in water) were added to 200 mL of pH 5.0 water in a 500 mL round bottom flask. Following mixing and dissolution of the monomers, the reaction mixture was sparged with argon gas for 30 minutes and 1.49 g of 4-((((2-carboxyethyl)thio)carbonothioyl)thio)-4-cyanopentanoic acid 0.240 g of ACVA added. After 30 minutes, the reaction mixture was sealed with a stoppered reflux condenser and the reaction mixture heated to reflux for 3 hours. After 3 hours of reflux, the reaction was quenched in an ice bath with the addition of an excess of hydroquinone added to the reaction. Following quenching, the aqueous solvent was removed under vacuum to yield a yellow powder. The synthesized polymer was then characterized by ESI-mass spectrometry and the polymer was determined to have an approximate molecular weight of 2 kDa.

### Solubility of HA Copolymers in Water.

The solubility of HASA55, HASA73, and HAQ55 synthesized by RAFT polymerization in deionized water was assessed according to EXAMPLE 3 and is summarized in TABLE 4.

TABLE 4

| | Concentration | Appearance |
|---|---|---|
| Copolymer ID | w/v % | in solution |
| HASA55-RAFT | 94 | Clear |
| HASA73-RAFT | 1.5 | Cloudy |
| HAQ55-RAFT | 60 | Clear |

HASA55 and HAQ55 were observed to have solubility in deionized water, while HASA73 was observed to have comparably lower. This data suggests that the ratio of HA to the second repeating unit can affect solubility of N-halamine copolymers synthesized by RAFT polymer chemistry.

The above data indicate that RAFT polymer chemistry can be utilized to synthesize low molecular weight polymers comprising N-halamine precursors or derivatives thereof that have high solubility in deionized water.

### Example 5: Preparation and Characterization of a Sample of Chlorinated N-Halamine Copolymers

A sample of various copolymers comprising (i) a first repeating unit comprising N-halamine precursors or derivates thereof and (ii) a second repeating unit that is not capable of forming a N-halamine can be chlorinated. The second repeating unit of the copolymer can comprise a side group (e.g., one or more water-soluble moieties) that can impart to the resulting copolymer a function (e.g., enhanced dissolvability in water). In some embodiments, a sample of a copolymer can be chlorinated and isolated as a powder. The resulting N-chlorinated halamine copolymers can be assessed for their dissolvability or solubility (e.g., maximum dissolvable concentration) in an aqueous medium, such as deionized water, and the amount of available chlorine in each copolymer solution assessed.

### Chlorination and Isolation of HASA Polymers

Synthesized HASA55 was chlorinated with electrophilic halogen sources. HASA polymers were contacted with electrophilic halogen sources HOCl or NaOCl at various pH and concentrations of halogen sources.

HASA55 was dissolved at room temperature in 1:10 diluted NaOCl solution at pH 7 adjusted with 4N HCl. The HASA55/NaOCl solution was mixed and the reaction allowed to proceed overnight. After reacting overnight, NaCl was added and the pH of the solution was decreased to pH 6 with 4N HCl to form a white coagulate. The solution was spun by centrifuge (e.g., at 10,000 rpm for 2 minutes) to isolate the chlorinated HASA55 (HASA55-Cl-A), and the isolated HASA55-Cl-A dried under vacuum oven to ensure removal of trapped moisture from the chlorinated polymer.

HASA55 was dissolved in aqueous HOCl at varying HASA55:Cl₂ stoichiometric molar ratios. For example, to prepare a reaction at 1:2 HASA55:Cl₂, 0.5 g HASA55 copolymer was added to 200 mL of HOCl (˜750 ppm Cl₂). The HASA55/HOCl solution was mixed and the reaction allowed to proceed overnight. After reacting overnight, chlorinated HASA55 (HASA55-Cl-B) was isolated and collected by rotovapor. The isolated HASA55-Cl-B was further dried under vacuum oven to ensure removal of trapped moisture from the chlorinated polymer.

HASA73 was dissolved at room temperature in 1:2 diluted NaOCl and the pH of the solution adjusted to pH 8.2 using sodium bicarbonate. The reaction mixture was mixed at room temperature (e.g. for 5 hours) prior to precipitating (e.g., by adding salt and lowering the pH of the mixture) the chlorinated HASA73 (HASA73-Cl). Precipitated HASA73-Cl was isolated and collected by vacuum filtration and washed with deionized water to remove excess unreacted chlorine from the sample.

### Chlorination and Isolation of HAQ55 Polymers

Synthesized HAQ55 was chlorinated in diluted, aqueous NaOCl. HAQ55 was dissolved at room temperature in 1:10 diluted, aqueous NaOCl solution at pH 11. The reaction mixture was mixed overnight. After reacting overnight, the pH of the solution was dropped to pH 3 with 4N HCl to form a white precipitate. The solution was spun by centrifuge (e.g., at 10,000 rpm for 2 minutes) to isolate chlorinated HAQ55 (HAQ55-Cl), and the isolated HAQ55-Cl dried under vacuum oven to ensure removal of trapped moisture from the chlorinated polymer.

### Chlorination and Isolation of HAAM Polymers

Synthesized HAAM55 was chlorinated in diluted, aqueous NaOCl. HAAM55 was dissolved at room temperature in 1:10 diluted, aqueous NaOCl solution at pH 11. The reaction mixture was mixed overnight. After reacting overnight, the pH of the solution was dropped to pH 3 with 4N HCl to from a white precipitate. The solution was spun by centrifuge (e.g., at 10,000 rpm for 2 minutes) to isolate chlorinated HAAM55 (HAAM55-Cl), and the isolated HAAM55-Cl dried under vacuum oven to ensure removal of trapped moisture from the chlorinated polymer.

### Solubility of Chlorinated N-Halamine Polymers

The solubility of the isolated chlorinated N-halamine polymers in water was assessed by dissolving a sample of each chlorinated polymer in water and observing the appearance of the copolymer solution according to the procedure detailed above. The maximum soluble concentration and pH of 1 wt % HASA55-Cl, HASA64-Cl, HASA73-Cl, HAQ55-Cl, and HAAM55-Cl copolymer solutions measured using a Mettler Toledo pH meter. TABLE 5 summarizes the water solubility and pH of 1 wt % copolymer solutions.

TABLE 5

| | | | pH of |
|---|---|---|---|
| | Concentration | Appearance | 1 wt % |
| Copolymer ID | w/v % | in solution | solution |
| HASA55-Cl-1 | 10< | Clear | 3 |
| HASA64-Cl | 3< | Clear | Not tested |
| HASA73-Cl | <0.1 | Clear | Not tested |
| HAQ55-Cl | 3< | Clear | 3.4 |
| HAAM55-Cl | NA | Not soluble | NA |

The three chlorinated HASA polymers were observed to be soluble in water with chlorinated HASA polymers with increasing monomer feed ratios of SA to HA observed to have higher maximum soluble concentrations in deionized water. HAQ55-Cl was observed to be soluble in deionized water while HAAM55 was observed to be not soluble. TABLE 6 summarizes the water solubility and the pH of 1 wt % solutions of HA polymers and chlorinated HA polymers.

TABLE 6

| | | | pH of |
|---|---|---|---|
| | Concentration | Appearance | 1 wt % |
| Copolymer ID | w/v % | in solution | solution |
| HASA55 | 41< | Clear | 4.9 |
| HASA64 | 33 | Clear | Not measured |
| HASA73 | 15 | Clear | 3.7 |
| HAQ55 | 17 | Clear | 4.1 |
| HAAM55 | NA | Not soluble | NA |
| HASA55-Cl-1 | 10< | Clear | 3 |
| HASA64-Cl | 3< | Clear | Not tested |
| HASA73-Cl | <0.1 | Clear | Not tested |
| HAQ55-Cl | 3< | Clear | 3.4 |
| HAAM55-Cl | NA | Not soluble | NA |

Compared to the non-chlorinated polymers, the chlorinated HA polymers were observed to have a decreased maximum soluble concentration and lower pH. Additionally, the solubility of HAQ55-Cl, HAAM55-Cl, and HASA73-Cl polymers in alkaline water, pH 13.2 and the pH of a 1 wt % polymer solution was assessed. TABLE 7 summarizes the water solubility of pH of 1 wt solutions of chlorinated HA polymers in alkaline medium, indicating that chlorinated HA copolymers can be dissolved in an alkaline medium.

TABLE 7

| | | | pH of |
|---|---|---|---|
| | | Appearance | 1 wt % |
| Copolymer ID | Solubility | in solution | solution |
| HAAA55 | Soluble | Clear | 13 |
| HAOH55 | Soluble | Clear | Not tested |
| HAQ55-Cl | Soluble | Clear | Not tested |
| HAAM55-Cl | Soluble | Clear | 12.7 |
| HASA73-Cl | Soluble | Clear | 12.7 |

### Determination of the Amount of Chlorine in Chlorinated HA Polymers by Iodometric Titration

The amount of available chlorine in HA polymers chlorinated with NaOCl as a chlorinating agent was assessed by iodometric/thiosulfate titration. For the iodometric titration, approximately 0.01 g of N-chlorinated HA copolymer was weighed and added to an Erlenmeyer flask with deionized water and excess potassium iodide (KI). Following dissolution of the N-chlorinated HA copolymer, the Erlenmeyer flasks were sealed (e.g. with stopper and parafilm) and agitated at room temperature (e.g. for 10 minutes) until a yellow solution was formed. To the yellow solution, 10 drops of 1% w/w starch was added to each flask and a blue colored solution was observed. To the blue solution, 0.001 N sodium thiosulfate (Na₂S₂O₃) was added until a clear solution was observed as the endpoint. The amount of available chlorine in ppm of each chlorinated HA copolymer was calculated according to the equation:

$$Total chlorine content ( ppm ) = \frac{N * V 1 * 70.9 * 1000}{2 * V 2} ,$$

Wherein N=concentration of Na₂S₂O₃, V1=volume of NA₂S₂O₃ added, and V2=the volume of the N-chlorinated polymer solution. TABLE 8 summarizes the amount of available chlorine in ppm and the wt % of chlorine for HASA73-Cl, HASA64-Cl, HASA55-Cl-A, HAQ55-Cl, and HAAM55-Cl. Chlorinated HA polymers were all observed to have available chlorine of approximately 50% ppm or approximately 5 wt %. This observation indicates that chlorinated N-halamine polymers retain available chlorine.

TABLE 8

| Sample Name | Cl₂ ppm | Cl₂ (wt %) |
|---|---|---|
| HASA73-Cl | 232957 | 23.3 |
| HASA64-Cl | 49925 | 4.99 |
| HASA55-Cl-A | 70031 | 7.00 |
| HAQ55-Cl | 88625 | 8.86 |
| HAAM55-Cl | 56667 | 5.67 |

### Determination of Available Chlorine in Chlorinated HA Polymers by Spectrophotometry

The amount of available chlorine in HASA polymers chlorinated with HOCl was determined by spectrophotometry with N,N-diethyl-p-phenylenediamine (DPD) as an indicator. 50 mg/mL stocks of HASA55-Cl at varying HASA55:Cl₂ ratios were prepared and diluted 4 times by 10-fold serial dilution using deionized water as a diluent to obtain 10 mL total solutions. To the diluted 10 mL solutions, 100 mg of potassium iodide (KI) and 3 drops of 4N acetic acid were added and the mixture agitated (e.g., at 120 rpm for 10 minutes on orbital shaker) prior to transferring into a spectrophotometer glass sample cell. To the glass sample cell, DPD reagent was dissolved and allowed to react with the chlorinated polymer solution for 1 minute, resulting in a pink colored-solution. Following zeroing of the spectrophotometer, the absorption of the DPD-chlorinated polymer solution was measured at 530 nm and the amount of available chlorine calculated using a standard chlorine calibration curve. TABLE 9 summarizes the amount of available chlorine in HASA55 polymers chlorinated with HOCl.

TABLE 9

| | HASA55:Cl₂ | Cl₂ | Cl₂ |
|---|---|---|---|
| Sample Name | eq mol ratio | ppm | (wt %) |
| HASA55-Cl-B | 1:4 | 105200 | 10.5 |
| | 1:2 | 125000 | 12.5 |
| | 1:1 | 108000 | 10.8 |

The above data indicate that N-halamine polymers can be chlorinated and that N-chlorinated halamine polymers are dissolvable in water and contain available chlorine.

### Example 6: Preparation and Characterization of a Sample of Chlorinated N-Halamine Copolymers

A sample of various copolymers comprising (i) a first repeating unit comprising N-halamine precursors or derivates thereof and (ii) a second repeating unit that is not capable of forming a N-halamine can be chlorinated. The second repeating unit of the copolymer can comprise a side group (e.g., one or more water-soluble moieties) that can impart to the resulting copolymer enhanced dissolvability in water. In some cases, a sample of a copolymer can be chlorinated and remain in solution. The resulting N-chlorinated halamine copolymer solutions can be analyzed and the amount and the stability of available chlorine assessed.

### Preparation of Chlorinated HA Monomer and HASA55 Solutions

Various aqueous electrophilic halogen solutions were used to dissolve HASA55 powder. Undiluted disinfexol stock solution was used as HOCl source, Clorox® germicidal bleach diluted 1:48 volumetrically was used as a NaOCl source, and a stock solution of Purtab prepared by dissolving 1 tablet in a quart of water was used as a NaDCC source. Various samples of HASA55 solutions chlorinated with HOCl, NaOCl, and NaDCC were prepared by dissolving HASA55 in the electrophilic halogen source solutions at stoichiometric molar ratios of 2:1, 1:1, 1:2, 1:4, and 1:8 HASA55:electrophilic halogen source for HOCl and NaOCl, and at stoichiometric molar ratios of 4:1, 2:1, 1:1, 1:2, and 1:4 HASA55:NaDCC. Various samples of HA monomers chlorinated with HOCl, NaOCl, and NaDCC were prepared by dissolving HA monomer in the electrophilic halogen source solutions at stoichiometric molar ratios of 2:1, 1:1, 1:2, 1:3, and 1:6 HA:electrophilic halogen source for HOCl and NaOCl, and at stoichiometric molar ratios of 4:1, 2:1, 1:1, 1:1.5, and 1:3 for HA:NaDCC. The resulting solutions were sealed and stored in air-tight bottles to assess the amount of available chlorine and the pH of the solution over time. Available chlorine concentrations were calculated according to a spectrophotometric method using a DPD indicator as detailed above and pH was calculated using a pH meter.

Chlorine Stability and pH of HA and HASA Solutions Chlorinated with HOCl

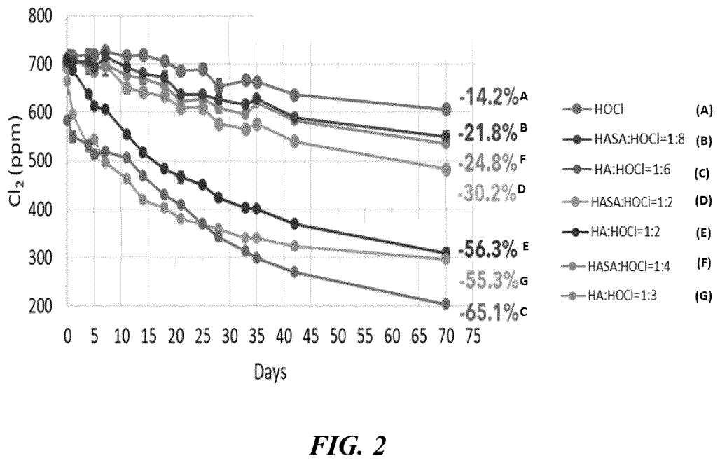

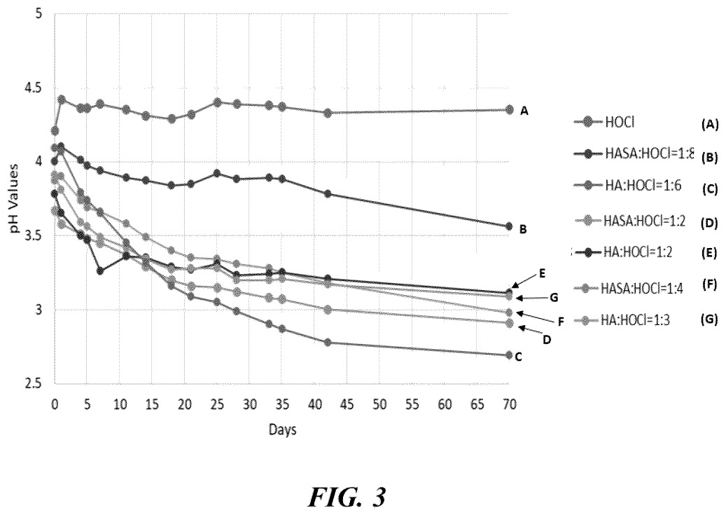

FIG. 2 illustrates the amount of available chlorine in HOCl, HASA/HOCl solutions, and HA/HOCl solutions over a 10 week duration. The HASA/HOCl and HA/HOCl solutions were prepared with stoichiometric molar ratios of HASA:HOCl and HA:HOCl less than 1. The amount of chlorine loss for each sample was calculated by comparing the baseline level of available chlorine to the amount of available chlorine at 10 weeks. Among the solutions tested, HOCl solution was observed to have the lowest chlorine loss over the 10 week period assessed. HASA/HOCl solutions at 1:2, 1:4, and 1:8 stoichiometric molar HASA:HOCl ratios were observed to have less chlorine loss than HA/HOCl solutions at 1:2, 1:4, and 1:6 stoichiometric molar HA:HOCl ratios, suggesting that the addition of a second repeating unit comprising a side group stabilizes can stabilize N-chlorinated halamines compared to N-chlorinated halamines alone. Additionally, among the HASA/HOCl solutions, the 1:8 HASA:HOCl solution was observed to have the lowest chlorine loss (21.8%) followed by the 1:4 (24.8%) and the 1:2 (30.2%) HASA:HOCl solutions. FIG. 3 illustrates the corresponding pH of the HOCl, HASA/HOCl, and HA/HOCl solutions over the 10 week period. Among the samples assessed, HOCl was observed to have a stable pH over 10 weeks, while the pH of the HASA/HOCl and HA/HOCl solutions decreased over time. Among the HASA/HOCl solutions, 1:8 HASA:HOCl was observed to have the most stable pH, indicating that pH stability could correlate chlorine stability over time.

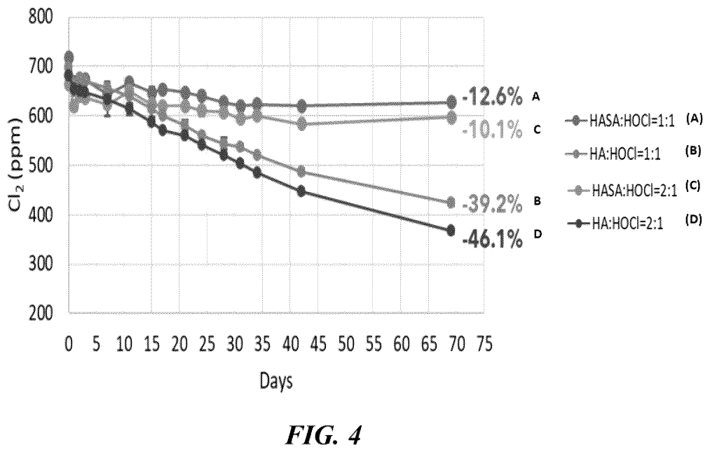

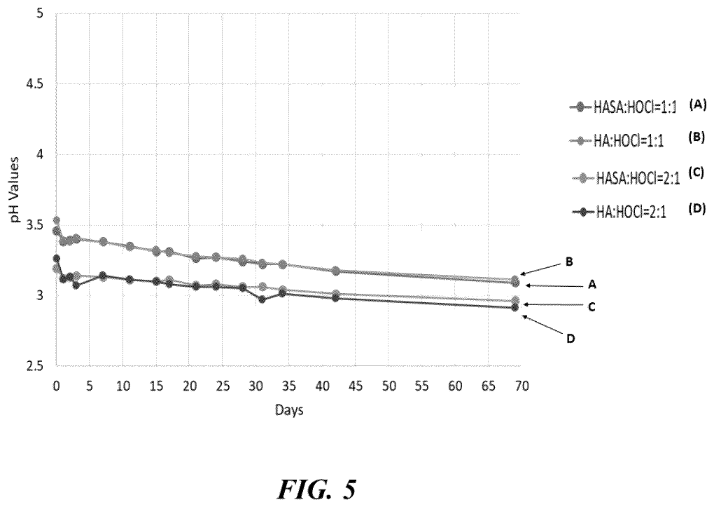

FIG. 4 illustrates the amount of available chlorine in HASA/HOCl and HA/HOCl solutions with a stoichiometric molar ratio of HASA:HOCl and HA:HOCl greater than 1. The addition of a second repeating unit appeared to stabilize chlorine levels in the HASA/HOCl solutions. Additionally, minimal chlorine loss was observed with the HASA/HOCl solutions; 1:1 HASA:HOCl was observed to have 12.6% loss of chlorine over 10 weeks while 2:1 HASA:HOCl was observed to have a 10.6% loss of chlorine over 10 weeks. FIG. 5 illustrates the corresponding pH of the HASA/HOCl and HA/HOCl solutions over the 10 week period, indicating that the pH of the solutions was stable across the 10 week period assessed.

TABLE 10 summarizes the available chlorine values in mg/L of the HOCl, HASA/HOCl and HA/HOCl solutions over the 10-week period assessed.

TABLE 10

| | | HASA:HOCl | | | | | HA:HOCl | | | | |
|---|---|---|---|---|---|---|---|---|---|---|---|
| | HOCl | 2:1 | 1:1 | 1:2 | 1:4 | 1:8 | 2:1 | 1:1 | 1:2 | 1:3 | 1:6 |
| Day 0 | 707 | 663 | 717 | 693 | 713 | 703 | 680 | 697 | 710 | 663 | 583 |
| W 0 | 727 | 623 | 643 | 697 | 700 | 716 | 633 | 657 | 607 | 497 | 520 |
| W 4 | 687 | 620 | 647 | 610 | 623 | 637 | 560 | 580 | 467 | 380 | 410 |
| W 6 | 637 | 583 | 620 | 540 | 583 | 590 | 447 | 487 | 370 | 323 | 270 |
| W 10 | 607 | 597 | 627 | 483 | 537 | 550 | 367 | 423 | 310 | 297 | 203 |

Chlorine Stability and pH of HA and HASA Solutions Chlorinated with NaOCl

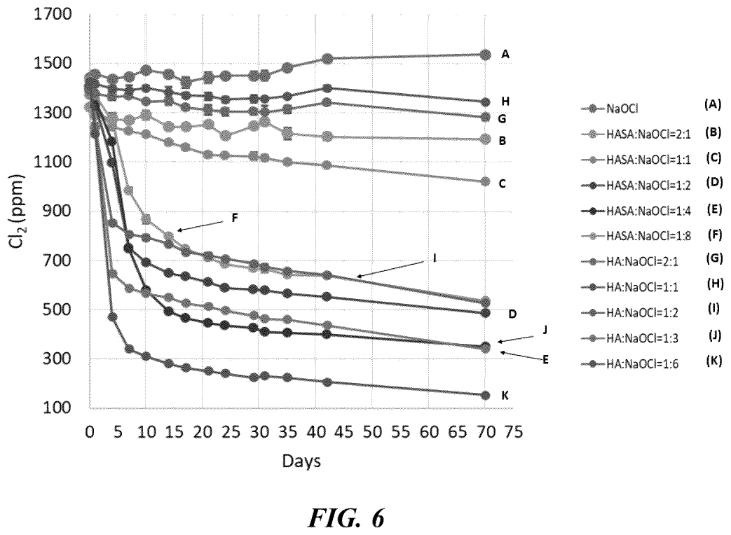

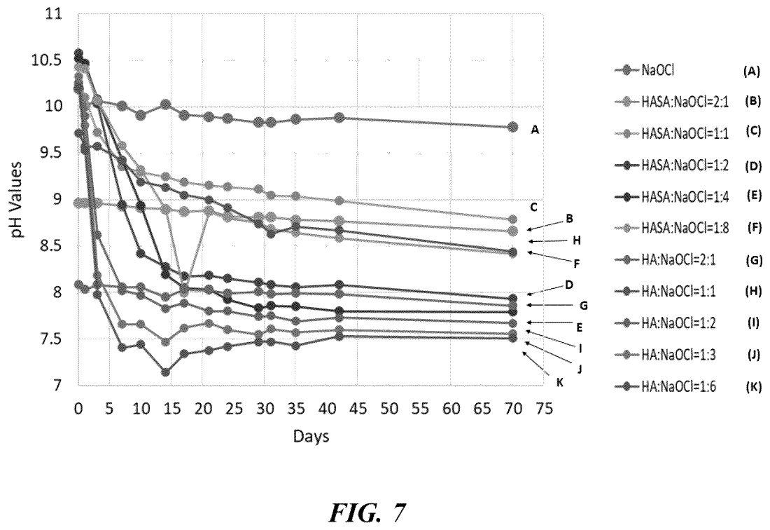

FIG. 6 illustrates the amount of available chlorine in NaOCl, HASA/NaOCl, and HA/NaOCl solutions over a 10 week period and FIG. 7 illustrates the pH of NaOCl, HASA/NaOCl, and HA/NaOCl solutions over the 10 week period. Assessing the amount of available chlorine and pH stability of the solutions allows for the stratification of the samples into three separate groups: the first characterized by stable chlorine levels and stable pH; the second comprising HASA/NaOCl solutions with intermediate chlorine loss and decreasing pH, and the third comprising HA/NaOCl solutions with high chlorine loss and lowest pH.

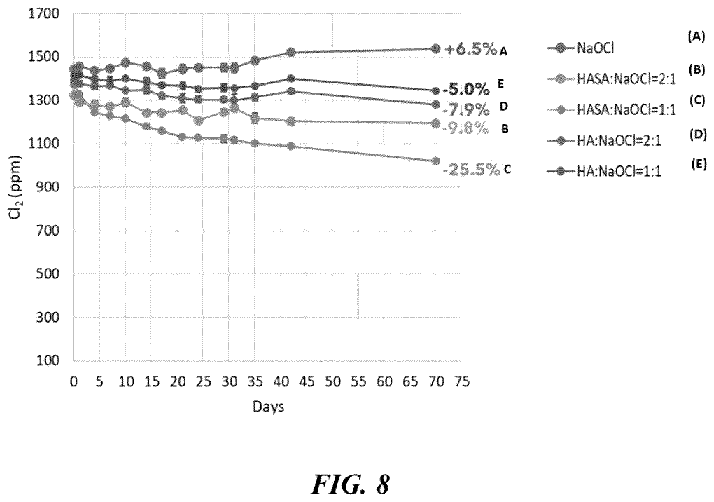

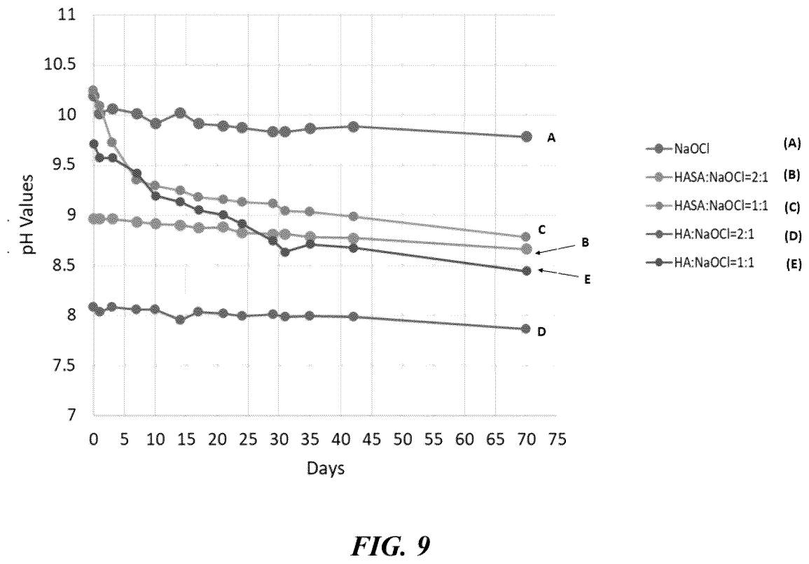

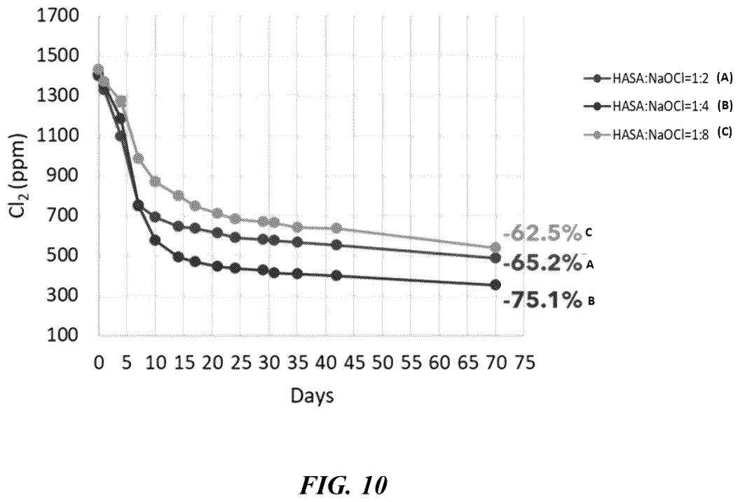

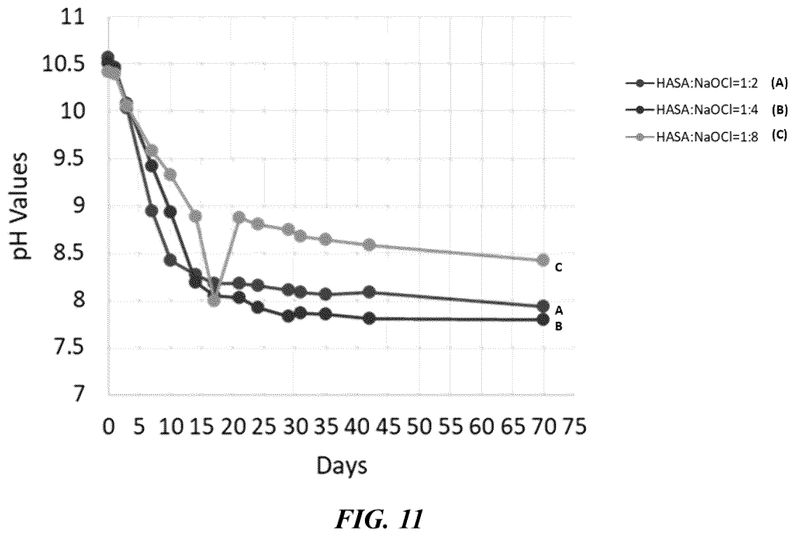

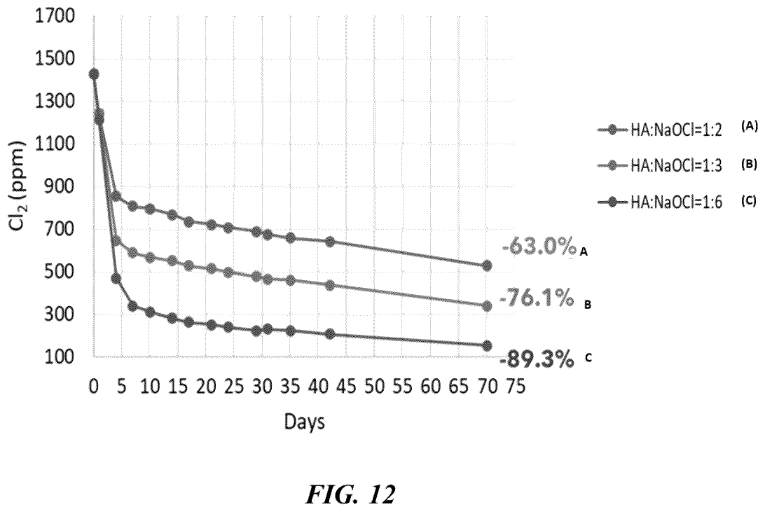

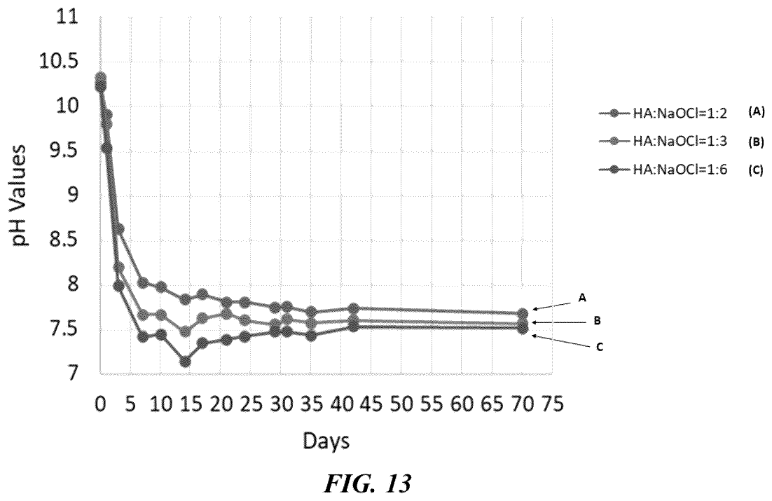

FIG. 8 illustrates chlorine levels of NaOCl, HASA/NaOCl, and HA/NaOCl solutions with stable chlorine levels and stable pH over time, while FIG. 9 illustrates the pH of NaOCl, HASA/NaOCl, and HA/NaOCl solution with stable chlorine levels and stable pH over time. NaOCl was observed to be stable over the 6-week period assessed, with no chlorine loss and no change in pH observed. HASA/NaOCl and HA/NaOCl solutions with a greater stoichiometric molar amount of HASA and HA than NaOCl (HASA:NaOCl=2:1, HASA:NaOCl=1:1, HA:NaOCl=2:1, HA:NaOCl=1:1) were observed to have stable chlorine levels and pH over the 6-week time period. FIG. 10 illustrates chlorine levels of HASA/NaOCl solutions with intermediate chlorine loss and decreasing pH over time, while FIG. 11 illustrates the pH of HASA/NaOCl solutions with intermediate chlorine loss and decreasing pH over time. HASA/NaOCl solutions with a stoichiometric molar amount of NaOCl greater than HASA (HASA:NaOCl=1:2, HASA:NaOCl=1:4, and HASA:NaOCl=1:8) were observed to have decreasing levels of available chlorine and decreasing pH over time. FIG. 12 illustrates chlorine levels of HA/NaOCl and solutions with the high chlorine loss over time, while FIG. 13 illustrates the pH of HA/NaOCl solutions with high chlorine loss and decreasing pH over time. HA/NaOCl solutions with greater stoichiometric molar amounts of NaOCl than HA (1:2 HA:NaOCl, 1:3 HA:NaOCl, and 1:6 HA:NaOCl) were observed to have high levels of chlorine loss and decreasing pH over time.

TABLE 11 summarizes the available chlorine values of the NaOCl, HASA/NaOCl, and HA/NaOCl solutions over the 10-week time period assessed.

TABLE 11

| | | HASA:NaOCl | | | | | HA:NaOCl | | | | |
|---|---|---|---|---|---|---|---|---|---|---|---|
| | HOCl | 2:1 | 1:1 | 1:2 | 1:4 | 1:8 | 2:1 | 1:1 | 1:2 | 1:3 | 1:6 |
| Day 0 | 1443 | 1323 | 1370 | 1397 | 1407 | 1430 | 1390 | 1413 | 1420 | 1423 | 1430 |
| W 1 | 1447 | 1270 | 1227 | 750 | 747 | 983 | 1367 | 1390 | 807 | 587 | 340 |
| W 3 | 1443 | 1253 | 1130 | 610 | 447 | 710 | 1310 | 1367 | 720 | 513 | 250 |
| W 6 | 1520 | 1203 | 1087 | 553 | 400 | 637 | 1340 | 1400 | 640 | 437 | 207 |
| W 10 | 1537 | 1193 | 1020 | 487 | 350 | 537 | 1280 | 1343 | 527 | 340 | 153 |

Chlorine Stability and pH of HA and HASA Solutions Chlorinated with NaDCC

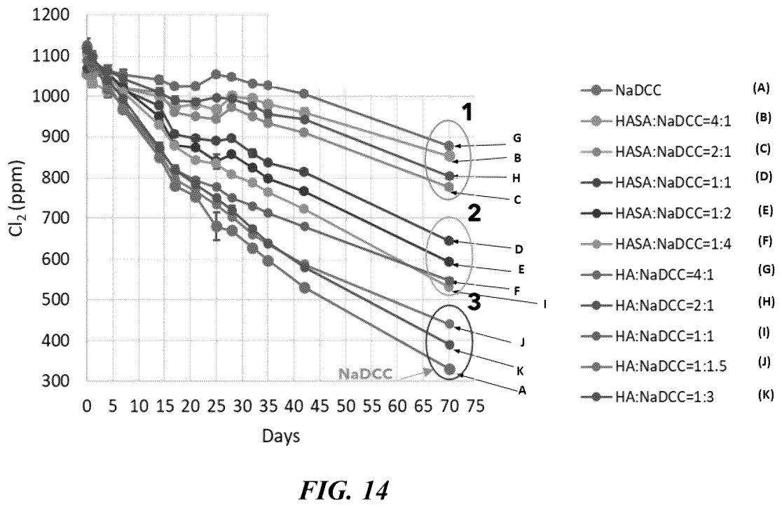

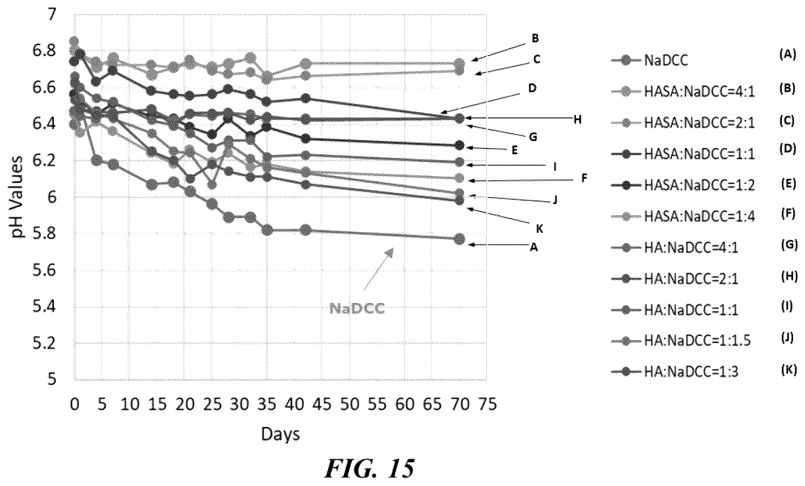

FIG. 14 illustrates available chlorine levels and FIG. 15 illustrates the pH of NaDCC, HASA/NaDCC, and HA/NaDCC solutions assessed over a 6-week period. Analysis of the available chlorine levels of the NaDCC, HASA/NaDCC, and HA/NaDCC samples results in the stratification of the solutions into one of three groups: the first group is characterized by having stable available chlorine levels over time, the second group is characterized by having decreasing available chlorine levels over time, and the third group is characterized by having the lowest available chlorine levels over time. HA:NaDCC=4:1, HASA:NaDCC=4:1. HA:NaDCC=2:1, and HASA:NaDCC=2:1 solutions were all observed to have relatively stable available chlorine amounts over the 6-week time period assessed and were stratified into the first group. HASA:NaDCC=1:1, HASA:NaDCC=1:2, and HASA:NaDCC=1:4 solutions were observed to have decreasing available chlorine amounts over time and were stratified into the second group. HA:NaDCC=1:1, HA:NaDCC=1:1.5, HA:NaDCC=1:3, and NaDCC were all observed to have low available chlorine levels over the 6-week time period assessed and were stratified into the third group. The pH of the HASA:NaDCC and HA:NaDCC solutions was observed to be stable over the 6-week time period assessed.

TABLE 12 summarizes available chlorine amounts of NaDCC, HASA:NaDCC, and HA:NaDCC solutions over the 10-week time period assessed.

TABLE 12

| | | HASA:NaDCC | | | | | HA:NaDCC | | | | |
|---|---|---|---|---|---|---|---|---|---|---|---|
| | NaDCC | 4:1 | 2:1 | 1:1 | 1:2 | 1:4 | 4:1 | 2:1 | 1:1 | 1:1.5 | 1:3 |
| Day 0 | 1120 | 1053 | 1053 | 1067 | 1107 | 1100 | 1087 | 1113 | 1127 | 1113 | 1113 |
| W 1 | 967 | 1020 | 1020 | 1017 | 1020 | 1010 | 1053 | 1043 | 977 | 970 | 993 |
| W 3 | 753 | 980 | 950 | 897 | 873 | 843 | 1023 | 997 | 777 | 733 | 750 |
| W 6 | 530 | 960 | 910 | 813 | 767 | 723 | 1007 | 943 | 680 | 587 | 580 |
| W 10 | 330 | 853 | 777 | 643 | 593 | 530 | 877 | 803 | 547 | 440 | 390 |

The above data indicate that chlorination of N-halamine polymers can result in stable amounts of available chlorine that persist for 10 weeks and above, even persisting beyond the electrophilic halogen source alone with NaDCC. Chlorinated N-halamine solutions that had stable amounts of available chlorine were also observed to have stable pH. This observation suggests that chlorine stability and pH stability for chlorinated N-halamine solutions are correlated. Additionally, chlorinated N-halamine polymer solutions with stoichiometric molar amounts of N-halamine monomers higher than stoichiometric molar amounts of electrophilic halogen source were observed to have stable available chlorine amounts and stable pH. This observation suggests that high stoichiometric molar amounts of N-halamine can stabilize chlorine and pH in N-chlorinated halamine solutions.

### Example 7: Biocidal Efficacy Testing of N-Chlorinated Halamine Polymer Solutions

A sample of a N-chlorinated halamine polymer solution can be prepared by (i) dissolving a N-halamine polymer in an electrophilic halogen source to chlorinate the copolymer, isolating the chlorinated polymer, and dissolving the chlorinated polymer in aqueous medium, or (ii) dissolving a N-halamine polymer in an electrophilic halogen source and utilizing the solution without further purification. The N-chlorinated halamine solution can be prepared from a N-halamine copolymer comprising (i) a first repeating unit comprising N-halamine precursors or derivatives thereof and (ii) a second repeating unit that is not capable of forming a N-halamine. The second repeating unit of the copolymer can comprise a side group (e.g., one or more water-soluble moieties) that can impart a function to the N-halamine copolymer. The resulting N-chlorinated halamine solutions can be assessed for biocidal efficacy against microorganisms (e.g., bacteria, viruses, fungi).

### Biocidal Testing of Chlorinated HASA

Solutions of HASA55-Cl at a Cl₂ concentration of 1000 rpm, NaDCC, and sterile deionized water were mixed 1:40 with suspensions of Staphylococcus aureus at a concentration of about 106 colony-forming units prepared in 100 mM phosphate buffer pH 7, for a total inoculum concentration of 6.36 log. After 1 minute and 5 minutes, samples were neutralized by diluting 1:20 in Dey-Engley broth to remove any oxidative chlorine. Serial dilutions of the neutralized solution were prepared, plated on Trypticase agar, and incubated (e.g., for 48 hours at 37° C.). Following the incubation, colonies were counted to determine the presence or absence of viable bacteria. TABLE 13 summarizes the results of the biocidal efficacy testing indicating that chlorinated N-halamine solutions have biocidal efficacy.

TABLE 13

Recovery of S. aureus
(log CFU/mL)

| Sample | 1 min | 5 min |
|---|---|---|
| Deionized water | 6.31 | 6.37 |
| NaDCC | 0.00 | 0.00 |
| HASA-Cl | 0.00 | 0.00 |

MIC and MBC Testing of chlorinated HASA

NaDCC, NaOC, HOC, and HASA-Cl solutions were prepared at chlorine concentrations of 300, 250, 200, 150, 100, and 50 ppm and mixed with a S. aureus suspension containing 5 FBS as an organic load for 30 seconds. After 30 seconds, the mixtures were neutralized with Na₂S₂O₃ to quench oxidative chlorine, added to tryptic soy broth (TSB), and incubated (e.g., for 48 hours at 37° C.). Following the incubation, samples were assessed for S. aureus growth inhibition to determine the minimum inhibitory concentration (MIC). TABLE 14 shows the minimum inhibitory concentrations of NaDCC, NaOCl, HOCl, and HASA-Cl. To determine the minimum biocidal concentration (MBC), samples were plated on agar and viable colonies counted. TABLE 15 shows the minimum biocidal concentrations of NaDCC, NaOCl, HOCl, and HASA-dl. The analysis was run in duplicate with a 8.34 log inoculum concentration of S. aureus in the first analysis and a 8.37 log inoculum concentration of S. aureus in the second analysis.

TABLE 14

MIC value (ppm)

| Formulation | Exp 1 | Exp 2 |
|---|---|---|
| NaDCC | 150 | 100 |
| NaOCl | 100 | 100 |
| HOCl | 150 | 100 |
| HASA-Cl | 150 | 150 |

TABLE 15

MBC value (ppm)

| Formulation | Exp 1 | Exp 2 |
|---|---|---|
| NaDCC | 150 | 150 |
| NaOCl | 200 | 250 |
| HOCl | 150 | 100 |
| HASA-Cl | 200 | 250 |

Comparing the MIC and MBC of HASA-Cl to NaDCC, NaOCl, and HOCl solutions indicates that HASA-Cr has similar biocidal performance as commercial electrophilic halogen sources.
MIC and MBC Testing of Chlorinated HASA with High Organic Load

NaDCC, NaOCl, HOC, and HASA-Cl solutions were prepared at chlorine concentrations of 800, 700, 600, 500, 400, 300, 200, and 100 ppm and mixed with a suspension of S. aureus containing 10% FBS or 15% as an organic load and reacted for 1 minute or 5 minutes. After reacting, the mixtures were neutralized with Na₂S₂O₃ to quench oxidative chlorine, added to tryptic soy broth (TSB), and incubated (e.g., for 48 hours at 37° C.). Following the incubation, samples were assessed for S. aureus growth inhibition to determine the MIC. TABLE 16 shows the MIC of NaDCC, NaOCl, HOCl, and HASA-Cl with 10% FBS and 15 FBS organic load. To determine the MBC, samples were plated on agar and viable colonies counted. TABLE 17 shows the minimum biocidal concentrations of NaDCC, NaOCl, HOCl, and HASA-Cl with 10% FBS and 15% FBS organic load. The analysis was run in duplicate with a 8.23 log inoculum concentration of S. aureus.

TABLE 16

| MIC value (ppm) | |
|---|---|
| 10% FBS | 15% FBS |

| Formulation | 1 min | 5 min | 1 min | 5 min |
|---|---|---|---|---|
| NaDCC | 200 | 200 | 300 | 200 |
| NaOCl | 400 | 100 | 500 | 100 |
| HOCl | 300 | 100 | 300 | 200 |
| HASA-Cl | 400 | 200 | 300 | 100 |

TABLE 17

| MBC value (ppm) | |
|---|---|
| 10% FBS | 15% FBS |

| Formulation | 1 min | 5 min | 1 min | 5 min |
|---|---|---|---|---|
| NaDCC | 200 | 200 | 300 | 200 |
| NaOCl | 400 | 200 | 500 | 400 |
| HOCl | 300 | 200 | 300 | 300 |
| HASA-Cl | 500 | 300 | 300 | 200 |

The chlorinated HASA solution was observed to have comparable biocidal activity to commercial electrophilic halogen sources in both the 10% FBS and 15% organic load conditions. This observation suggests that chlorinated N-halamine polymers can function as biocides in conditions with high organic content.
MIC and MBC Testing of HASA Copolymers Chlorinated with Various Electrophilic Halogen Sources.

Three solutions of HASA-Cl (HASA-Cl_D, HASA-Cl_E, and HASA-Cl_F) were prepared by chlorinating HASA55 in aqueous HOCl at varying HASA55:chlorine stoichiometric molar ratios, isolating the chlorinated HASA55-Cl polymer, and dissolving the chlorinated polymer in water. The three HASA-Cl solutions and HASA-HOCl, NaDCC, NaOCl, and HOCl solutions were diluted to chlorine concentrations of 300, 250, 200, 150, 100, and 50 ppm, mixed with a suspension of S. aureus with 5% FBS organic load, and reacted for 30 seconds. After reacting, the mixtures were neutralized to remove oxidative chlorine, added to tryptic soy broth, and incubated (e.g. for 48 hours at 37° C.). Following the incubation, samples were assessed for S. aureus growth inhibition to determine the MIC. To determine the MBC, samples were plated on agar and viable colonies counted. TABLE 18 shows the calculated MIC and MBC of NaDCC, NaOCl, HOCl, HASA-Cl_D, HASA-Cl_E, HASA-Cl_F, and HASA-HOCl. The analysis was run in duplicate with a 8.34 log inoculum concentration of S. aureus in the first experiment and a 8.37 log inoculum concentration of S. aureus in the second experiment.

TABLE 18

| | MIC | MBC |
|---|---|---|
| | value | value |
| Formulation | (ppm) | (ppm) |
| NaDCC | 100 | 150 |
| NaOCl | 200 | 200 |
| HOCl | 150 | 150 |
| HASA-Cl_D | 150 | 150 |
| HASA-Cl_E | 150 | 200 |
| HASA-Cl_F | 150 | 200 |
| HASA-HOCl | 150 | 150 |

The three HASA-Cl solutions prepared with various HASA55:Cl₂ stoichiometric molar ratios all had similar biocidal activity. The chlorinated HASA polymers were observed to have similar biocidal efficacy as the commercial electrophilic halogen sources.

The above data indicate that chlorinated N-halamine polymers have comparable biocidal efficacy to commercial electrophilic halogen sources. The biocidal activity is similar across chlorination procedures and sources, and has similar biocidal activity to commercial electrophilic halogen sources in conditions with high organic load. This result suggests that N-halamine precursors have wide usability for biocidal applications.

### Example 8: Preparation of Coatings Comprising a Sample of a Polymer Comprising N-Chlorinated Halamines

A sample of a N-chlorinated halamine polymer solution can be prepared by (i) dissolving a N-halamine polymer in an electrophilic halogen source to chlorinate the copolymer, isolating the chlorinated polymer, and dissolving the chlorinated polymer in aqueous medium, or (ii) dissolving a N-halamine polymer in an electrophilic halogen source and utilizing the solution without further processing. The N-chlorinated halamine solution can be prepared from a copolymer comprising (i) a first repeating unit comprising N-halamine precursors or derivatives thereof and (ii) a second repeating unit that is not capable of forming a N-halamine. The second repeating unit of the copolymer can comprise a side group (e.g., one or more water-soluble moieties) that can impart a function to the copolymer. The resulting N-chlorinated halamine copolymer solutions can be used as coating compositions, and the residual chlorine content of the coating composition assessed.

### Preparation of Chlorinated N-Halamine Coatings on SS304 Coupons

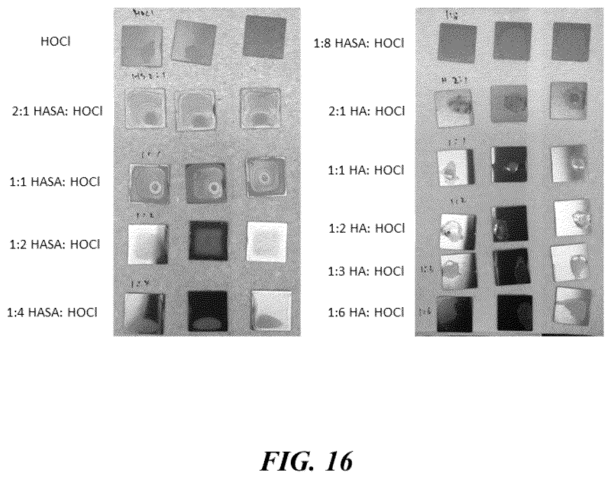

HASA-Cl solutions were prepared according to procedures detailed in EXAMPLE 6 above. Stainless steel 304 (SS304) coupons with a dimension of 1″×1″ and thickness of 0.024″ were scrubbed with a sponge and 1% detergent (e.g., Liquinox®), rinsed with deionized water, and dried. To the dried SS304 coupons, a 1 mL sample of a HASA-Cl, HA-Cl, or electrophilic halogen solution was pipetted using a micropipette without rinsing or wiping the coupon after pipetting. The sample coupons coated with HASA-Cl HA-Cl, and electrophilic halogen sources, were stored at ambient temperature and humidity with indoor light exposure. FIG. 16 shows the appearance of dried HASA/Cl and HA/HOCl solutions on SS304 coupons one day after application. HASA/HOCl solutions with high stoichiometric molar amounts of HASA (2:1 HASA:HOCl and 1:1 HASA:HOCl) formed coatings with a flaked dried polymer appearance, while the other solutions formed coatings with a stain-like appearance with a majority of the SS304 base substrate exposed.

### Determination of Residual Chlorine Content of Chlorinated N-Halamine Coatings on SS304 Coupons

To extract chlorine from the surface of a SS304 sample coupon, a sample coupon was added to a centrifuge tube containing 20 mL of deionized water, 200 mg of K1, and 10 drops of 4N acetic acid. The mixture containing the sample coupon was mixed by shaking (e.g. at 120 rpm for 10 minutes), and solution removed and added to a glass sample cell for analysis by spectrophotometry with a DPD indicator according to the procedure detailed above. The amount of chlorine was calculated against a chlorine standard curve. Chlorine density was calculated according to the following formula:

$$\frac{x mg {Cl}_{2}}{1 L {H}_{2} O} \times \frac{0.0 \; 20 L {H}_{2} O}{1} \times \frac{1 g {Cl}_{2}}{1000 mg {Cl}_{2}} \times \frac{1 mol {Cl}_{2}}{70.9 g {Cl}_{2}} \times \frac{6.02 \times 1 {0}^{23} molecules {Cl}_{2}}{1 mol {Cl}_{2}} \times \frac{1 atom {Cl}^{+}}{1 molecule {Cl}_{2}} \times \frac{1}{y {cm}^{2}} = z ( \frac{atom s}{{cm}^{2}} ) {Cl}^{+}$$

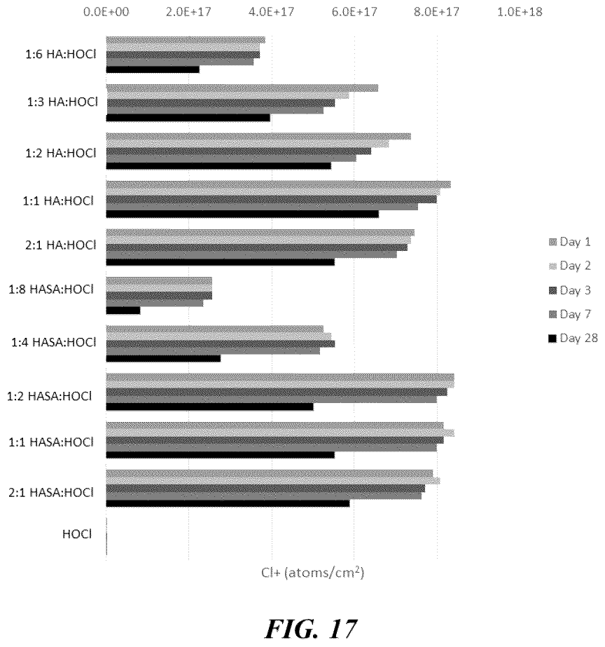

FIG. 17 shows the calculated chlorine density of various HA/HOCl and HASA/HOCl solutions assessed at 1, 2, 3, 7, and 28 days after coating. The bars are presented in the order Day 1, Day 2, Day 3, Day 7, and Day 28. SS304 coupons coated with HASA/HOCl and HA/HOCl solutions possessed high and stable chlorine densities observed across 1 week of storage. At 28 days, the chlorine density of HASA/HOCl and HA/HOCl solutions decreased, to around half of the Day 1 chlorine density. SS304 coupons coated with HOCl exhibited no residual chlorine density on Day 1. These results suggest that chlorinated N-halamines solutions have residual disinfectant activity that can persist for greater than 1 week. The chlorine density at 1 week appeared to saturate for HASA/HOCl solutions with stoichiometric molar ratios of HASA:HOCl higher than 1:2, suggesting that at this ratio all free chlorines from the electrophilic halogen source have been reacted into the form of HASA-Cl. Estimated residual chlorine percentages were calculated from the ratio of the amount of chlorine retrieved from the dried coating over the amount of chlorine deposited in the 1 mL solution. TABLE 19 summarizes the estimated residual chlorine percentages of HA/HOCl and HASA/HOCl solutions over the 28 days. Estimated residual chlorine percentages were stable for up to 1 week for HASA/HOCl solutions with stoichiometric molar ratios of HASA:HOCl higher than 1:2, aligning with the chlorine density data.

TABLE 19

| | Day 1 | Day 2 | Day 3 | Day 7 | Day 28 |
|---|---|---|---|---|---|
| | Esti- | Esti- | Esti- | Esti- | Esti- |
| | mated | mated | mated | mated | mated |
| | residual | residual | residual | residual | residual |
| | Cl (%) | Cl (%) | Cl (%) | Cl (%) | Cl (%) |
| HOCl | 0.1 | 0.2 | 0.3 | 0.1 | 0.2 |
| 2:1 | 90.5 | 92.8 | 88.2 | 87.1 | 67.4 |
| HASA:HOCl | | | | | |
| 1:1 | 86.9 | 89.0 | 86.9 | 84.8 | 58.6 |
| HASA:HOCl | | | | | |
| 1:2 | 92.1 | 92.1 | 89.9 | 87.7 | 54.8 |
| HASA:HOCl | | | | | |
| 1:4 | 56.5 | 57.5 | 58.6 | 55.4 | 29.5 |
| HASA:HOCl | | | | | |
| 1:8 | 28.1 | 28.1 | 28.1 | 25.9 | 8.9 |
| HASA:HOCl | | | | | |
| 2:1 HA:HOCl | 83.8 | 82.7 | 81.6 | 78.2 | 61.8 |
| 1:1 HA:HOCl | 90.5 | 88.3 | 87.2 | 81.8 | 71.7 |
| 1:2 HA:HOCl | 79.2 | 72.8 | 68.5 | 65.3 | 58.2 |
| 1:3 HA:HOCl | 75.6 | 67.6 | 63.0 | 60.7 | 45.4 |
| 1:6 HA:HOCl | 50.8 | 48.2 | 48.2 | 46.9 | 29.5 |

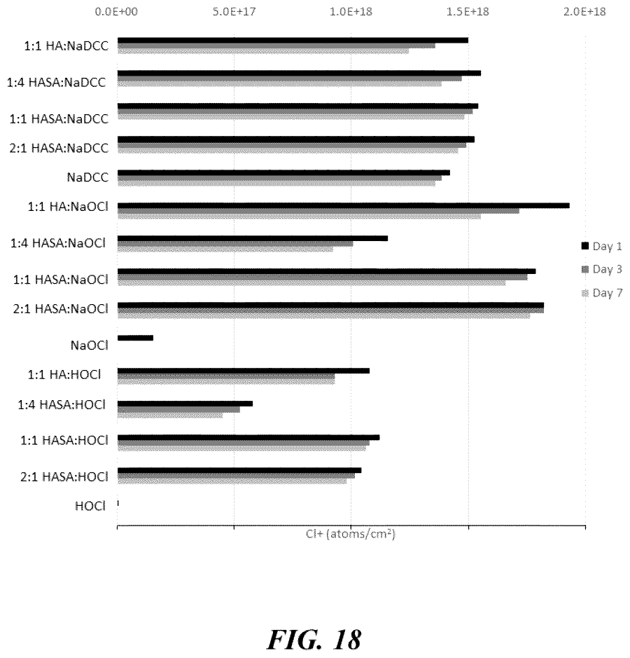

FIG. 18 shows calculated chlorine densities of HA and HASA solutions with HOCl, NaOCl, and NaDCC at varying N-halamine to electrophilic halogen source ratios assessed at 1, 3, and 7 days after coating. The bars are presented in the order Day 1, Day 3, and Day 28. Chlorine densities appeared to saturate when the stoichiometric molar ratios of HASA:electrophilic halogen source were higher than 1:1. This result suggests that free chlorines were reacted in the form of HASA-Cl. HOCl and NaOCl samples had lower chlorine densities than the corresponding HASA and HA samples. This results suggests that N-halamines are able to retain residual chlorine density over time than the commercial electrophilic halogen sources. The relative maximum chlorine densities were dependent on the properties of the electrophilic halogen source, with NaOCl having a higher chlorine concentration than HOCl and solid NaDCC having higher stability than a liquid form.

### Evaluation of the Effect of Rinsing on Chlorinated N-Halamine Coating Compositions

SS304 coupons coated with HOCl, 1:1 HASA:HOCl, 1:8 HASA:HOCl, 1:1 HA:HOCl, and 1:6 HA:HOCl were prepared according to the procedure detailed above. After air-drying for 2 days, sample coupons were rinsed three times with deionized water (e.g., by squirting the coupon with a squirt bottle). After washing, samples were air-dried (e.g., for 2 hours) prior to the assessment of the coating composition appearance and the chlorine density according to the procedure detailed above.

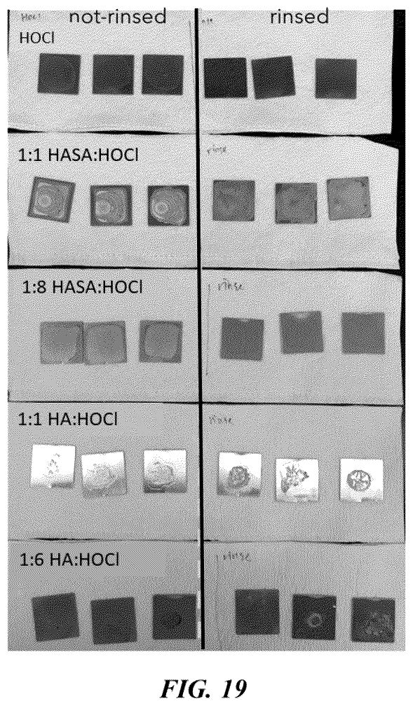

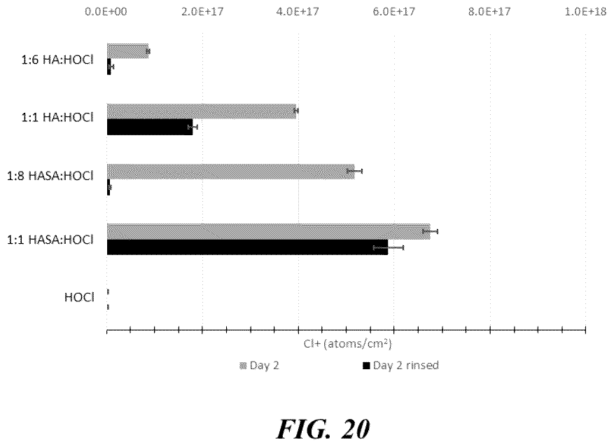

FIG. 19 illustrates the appearance of N-chlorinated halamine coating compositions on SS304 coupons after rinsing. HASA/HOCl solutions formed a coating that was not removed by rinsing with deionized water. HA/HOCl solutions formed a stain-like appearance that left the underlying substrate exposed and that was not completely removed following the rinsing procedure. FIG. 20 illustrates the chlorine density of SS304 sample coupons 2 days after drying with and without rinsing with deionized water. High stoichiometric molar amounts of N-halamine to electrophilic halogen source (1:1 HASA:HOCl and 1:1 HA:HOCl) had high chlorine densities that were decreased following rinsing. The loss of chlorine density following rinsing was less with 1:1 HASA:HOCl than the loss observed with 1:1 HA:HOCl. This result suggests that the addition of a second repeating unit can help to form a composition that forms a stable coating. Chlorine density was significantly decreased with 1:8 HASA:HOCl and 1:6 HA:HOCl solutions following rinsing, suggesting that high molar amounts of N-halamine to electrophilic halogen source allows for residual coatings that can withstand washing procedures.

The above results indicate that samples of N-chlorinated halamine polymers can form stable coatings with residual chlorine density that persist for up to 1 week. Compositions with high molar ratios of N-halamine to electrophilic halogen source can from stable coatings that withstand rinsing. Copolymers comprising N-chlorinated halamines and a second repeating unit appear to form coatings with higher and more stable chlorine densities suitable for coating a surface.

### Example 9: Preparation of Coatings Comprising a Sample of a Composition Comprising a N-Halamine

A coating composition can be prepared from a sample of a composition comprising a nitrogen-containing heterocycle configured to from an N-halamine. The coating composition can comprise a sample of a copolymer comprising (i) a first repeating unit comprising N-halamine precursors or derivatives thereof and (ii) a second repeating unit that is not capable for forming an N-halamine. The second repeating unit can comprise a side chain (e.g. one or more water-soluble monomers) that can impart a function to the copolymer (e.g., dissolvability in organic solvent). The composition can further comprise an additive (e.g., a crosslinker) that can impart a function to the copolymer (e.g., enhanced adhesion to a surface). The composition can further comprise an additive (e.g., an oxidizing agent) that can chemically modify the copolymer (e.g., oxidizing the copolymer). The composition can be used to coat a surface and the resulting coating be chlorinated by exposing the surface to an electrophilic halogen source. The chlorinated coating can be assessed for durability, chlorine content, and biocidal efficacy.

### Effect of Coating Composition Formulation on Chlorine Density and Biocidal Efficacy

A coating composition was prepared according to the concentrations in TABLE 20. Briefly, a 2.0 g/L copolymer comprising HA and dopamine methacrylamide (DMA) (HA/DMA) (e.g., at a ratio of 70:30) HA:DMA was dissolved in 70:30 ethanol:water overnight. To the dissolved HA/DMA solution, 4.0 g/L of polyethyleneimine and 0.4 g/L trizma base were added.

TABLE 20
Formula A

| Component | Concentration | |
|---|---|---|
| HA/DMA Copolymer | 2.0 | g/L |
| Polyethyleneimine | 4.0 | g/L |
| Trizma base | 0.4 | g/L |
| Ethanol | 700 | mL/L |
| Water | 297 | mL/L |

The resulting composition, Formula A, was then applied to stainless steel substrates and the substrates were dried overnight at room temperature. The coated substrates were then sprayed with NaOCl (e.g., Clorox® germicidal bleach) at pH about 7 and about 8,000 ppm Cl₂ with a total contact time of 10 minutes. The substrates were then rinsed with deionized water and dried for 24 hours. After drying, a sample of the substrates was abraded per the Environmental Protection Agency (EPA) interim method and EPA MB-40 protocols for anti-microbial efficacy. The chlorine density of the coated substrates was assessed by spectrophotometry according to the protocol detailed in EXAMPLE 5. Sample substrates were evaluated for biocidal efficacy against Staphylococcus aureus with a contact time of 2 hours. After two hours, bacteria were recovered from the substrate and the log reduction calculated compared to bacterial recovery at time 0. TABLE 21 summarizes the chlorine density and biocidal efficacy of Formula A.

TABLE 21

| | | Log |
|---|---|---|
| | | reduction against |
| | Chlorine density | Staphylococcus |
| Test method | (Cl+ atoms/cm2) | aureus in 2 hour |
| EPA Interim | 1.58E+16 | 3.98 |
| method | 2.20E+16 | 3.04 |
| EPA MB-40 | 1.87E+16 | 1.14 |
| method | | |

A coating composition, Formula B1, was prepared in two chambers according to the concentrations in TABLE 22. In the first chamber, PART A, HA/DMA copolymer (4.0 g/L) was dissolved in 70:30 ethanol:water overnight. To the dissolved copolymer solution, 30% hydrogen peroxide (H₂O₂) (5.24 mL/L) was added. In the second chamber, PART B, (3-aminopropyl)triethoxysilane (APTES) (1.0 mL/L) was dissolved in 100% ethanol. Using a two-chamber spray bottle, the composition was applied to stainless steel substrates and allowed to dry overnight at room temperature.

TABLE 22
Formula B1

| | Component | Concentration | |
|---|---|---|---|
| PART A | HA/DMA Copolymer | 4.0 | g/L |
| | 30% Hydrogen peroxide | 5.24 | mL/L |
| | Ethanol | 700 | mL/L |
| | Water | 295 | mL/L |
| PART B | APTES | 1 | mL/L |
| | Ethanol | 999 | mL/L |

Separately, a coating composition, Formula B2, was prepared according to the concentrations in TABLE 23. Briefly, HA/DMA copolymer (2.0 g/L) was dissolved in 70:30 ethanol:water overnight. 30% H₂O₂ (2.62 ml/L) was added to the copolymer solution and the solution allowed to react for 3 hours. After three hours, APTES (1 ml/L) was added to the solution. The composition was applied to stainless steel substrates and allowed to dry overnight at room temperature.

TABLE 23
Formula B2

| Component | Concentration | |
|---|---|---|
| HA/DMA Copolymer | 2.0 | g/L |
| 30% Hydrogen peroxide | 2.62 | mL/L |
| APTES | 1 | ml/L |
| Ethanol | 700 | mL/L |
| Water | 296 | mL/L |

The dry, coated substrates were sprayed with HOCl (e.g. Disinfexol) at pH 4.64 and about 800 ppm Cl₂ or 1:48 diluted NaOCl (e.g., Clorox® germicidal bleach) at pH about 10.5 and about 1,400 ppm Cl₂ with a contact time of ten minutes. After 10 minutes, the substrates were then rinsed with deionized water and dried for 24 hours. After drying, a sample of the substrates was abraded per the EPA MB-40 method with Chem A solution (2,000 ppm NaOCl). Chlorine density of the substrates was assessed by spectrophotometry with a DPD indicator detailed in EXAMPLE 5. Sample substrates were evaluated for biocidal efficacy against Staphylococcus aureus and/or Pseudomonas aeruginosa with a contact time of 2 hours. After two hours, bacteria were recovered from the substrate and the log reduction calculated compared to bacterial recovery at time 0. TABLE 24 summarizes the chlorine density and biocidal efficacy against S. aureus of Formula B1. TABLE 25 summarizes the chlorine density and biocidal efficacy against S. aureus of Formula B2. TABLE 26 summarizes the chlorine density and biocidal efficacy against P. aeruginosa of Formula B2.

TABLE 24

| | | | Log reduction against | |
|---|---|---|---|---|
| | Chlorine density | | Staphylococcus aureus | |
| | (Cl+ atoms/cm2) | | in 2 hour | |
| Chlorination | Pre- | Post- | Pre- | Post- |
| source | abrasion | abrasion | abrasion | abrasion |
| Disinefxol | 5.62E+16 | 4.47E+16 | Not | 3.76 |
| (800 ppm Cl2) | | | available | |
| CLX GB 1:48 dil | 5.36E+16 | 9.91E+16 | Not | 4.70 |
| (1400 ppm Cl2) | | | available | |
| CLX GB 1:48 dil | 2.63E+16 | 5.72E+16 | 4.22 | 4.71 |
| (1400 ppm Cl2) | | | | |

TABLE 25

| | | | Log reduction against | |
|---|---|---|---|---|
| | Chlorine density | | Staphylococcus aureus | |
| | (Cl+ atoms/cm2) | | in 2 hour | |
| Chlorination | Pre- | Post- | Pre- | Post- |
| source | abrasion | abrasion | abrasion | abrasion |
| CLX GB 1:48 dil | 4.56E+16 | 4.74E+16 | Not | 3.11 |
| (1400 ppm Cl2) | | | available | |
| CLX GB 1:48 dil | 4.70E+16 | 5.57E+16 | Not | 4.64 |
| (1400 ppm Cl2) | | | available | |
| CLX GB 1:48 dil | 5.48E+16 | 4.83E+16 | 4.63 | 4.62 |
| (1400 ppm Cl2) | | | | |
| CLX GB 1:10 dil | 8.62E+16 | 2.85E+16 | 3.98 | 4.56 |
| (8000 ppm Cl2, | | | | |
| pH = 7) | | | | |

TABLE 26

| | | | Log reduction against | |
|---|---|---|---|---|
| | Chlorine density | | Pseudomonas aeruginosa | |
| | (Cl+ atoms/cm2) | | in 2 hour | |
| Chlorination | Pre- | Post- | Pre- | Post- |
| source | abrasion | abrasion | abrasion | abrasion |
| CLX GB 1:10 dil | 8.46E+16 | 6.71E+16 | 4.44 | 4.44 |
| (8000 ppm Cl2, | | | | |
| pH = 7) | | | | |
| CLX GB 1:10 dil | 1.05E+17 | 5.09E+16 | 3.17 | 3.17 |
| (8000 ppm Cl2, | | | | |
| pH = 7) | | | | |

Formula A was observed to have lower chlorine density than Formulas B1 and B2. Additionally, Formula A was observed to have inconsistent biocidal efficacy against S. aureus depending on whether the sample was tested with EPA interim or EPA MB-40 methods. Formulas B1 and B2 both were observed to have higher chlorine density and at least 3 log reduction against bacteria. The observations suggest that Formulas B1 and B2 are more effective biocidal agents than Formula A.

### Effect of Oxidizing Agent Composition on Chlorine Density

To assess the effect of the oxidizing agent composition on the coating composition, various compositions were prepared according to the concentrations in TABLE 27. Briefly, HA/DMA copolymer (4.0 g/L) was dissolved in 70:30 ethanol:water in one chamber (PART A). To the dissolved HA/DMA, either 30% H₂O₂ (0.393 mL/L or 5.24 mL/L) or sodium periodate (54.7 mg/L or 109.4 mg/L) were added. In a separate chamber (PART B), APTES (7.5 mL/L) was dissolved in 100% ethanol. The compositions were applied to stainless steel substrates and dried overnight at room temperature.

TABLE 27

| | Component | Formula B3 | | Formula B4 | | Formula B5 | | Formula B6 | |
|---|---|---|---|---|---|---|---|---|---|
| PART | HA/DMA | 4.0 | g/L | 4.0 | g/L | 4.0 | g/L | 4.0 | g/L |
| A | Copolymer | | | | | | | | |
| | 30% Hydrogen | 0.393 | mL/L | 5.24 | mL/L | none | | none | |
| | peroxide | | | | | | | | |
| | Sodium | none | | none | | 54.7 | mg/L | 109.4 | mg/L |
| | periodate | | | | | | | | |
| | Ethanol | 700 | mL/L | 700 | mL/L | 700 | mL/L | 700 | mL/L |
| | Water | 299 | ml/L | 295 | ml/L | 299 | ml/L | 299 | ml/L |
| PART | APTES | 7.5 | mL/L | 7.5 | mL/L | 7.5 | mL/L | 7.5 | mL/L |
| B | Ethanol | 992.5 | mL/L | 992.5 | mL/L | 992.5 | mL/L | 992.5 | mL/L |

Following drying, the substrates were sprayed with HOCl (e.g., Disinfexol) at pH 4.64 and about 706 ppm Cl₂ with a total contact time of 10 minutes. After 10 minutes, the substrates were rinsed with deionized water and dried for 24 hours. Chlorine density of the dried substrates was assessed with spectrophotometry as detailed in EXAMPLE 5 with a total of 6 replicates assessed. TABLE 28 summarizes the chlorine densities of the formulas.

TABLE 28

| | Chlorine densities (Cl+ atoms/cm2) | | | |
|---|---|---|---|---|
| | Formula B3 | Formula B4 | Formula B5 | Formula B6 |
| Replicate 1 | 5.10E+16 | 7.49E+16 | 3.93E+16 | 6.20E+16 |
| Replicate 2 | 5.57E+16 | 1.22E+17 | 1.23E+17 | 5.90E+16 |
| Replicate 3 | 5.55E+16 | 7.82E+16 | 9.11E+16 | 6.76E+16 |
| Replicate 4 | 8.26E+16 | 9.15E+16 | 5.43E+16 | 5.59E+16 |
| Replicate 5 | 1.24E+17 | 8.69E+16 | 8.54E+16 | 1.00E+17 |
| Replicate 6 | 1.14E+17 | 1.29E+17 | 7.29E+16 | 6.52E+16 |
| Average | 8.04E+16 | 9.71E+16 | 7.76E+16 | 6.84E+16 |
| Standard | 2.92E+16 | 2.09E+16 | 2.68E+16 | 1.48E+16 |
| Deviation | | | | |

The our tested formulations a achieve high chlorine densities. The observation suggests that both H₂O₂ and sodium periodate are effective oxidizing agents to be used in preparing the coating composition.

### Effect of the Concentration of Crosslinker on Chlorine Density

To assess the effect of the concentration of crosslinker in the composition on chlorine density, various compositions were prepared according to the concentrations in TABLE 29. Briefly, HA/DMA copolymer (4.0 g/L) was dissolved in 70:30 ethanol:water in one chamber (PART A). To the dissolved HA/DMA, 30% H₂O₂ (5.24 mL/L) was added. In a separate chamber (PART B), APTES (1 mL/L or 0.6 mL/L) was dissolved in 100% ethanol. The compositions were applied to stainless steel substrates with a two-chamber spray bottle and dried overnight at room temperature.

TABLE 29

| | Component | Formula B1 | | Formula B6 | | Formula B7 | |
|---|---|---|---|---|---|---|---|
| PART | HA/DMA | 4.0 | g/L | 4.0 | g/L | 4.0 | g/L |
| | Copolymer | | | | | | |
| A | 30% Hydrogen | 5.24 | mL/L | 5.24 | mL/L | 5.24 | mL/L |
| | peroxide | | | | | | |
| | Ethanol | 700 | mL/L | 700 | mL/L | 700 | mL/L |
| | Water | 295 | mL/L | 295 | mL/L | 295 | mL/L |
| PART | APTES | 1 | mL/L | 0.6 | mL/L | 1.2 | mL/L |
| B | Ethanol | 999 | mL/L | 999.4 | mL/L | 998.8 | mL/L |

The coated substrates were then sprayed with HOCl (e.g., Disinfexol) at pH 4.64 and about 724 ppm Cl₂ with a total contact time of 10 minutes. The substrates were then rinsed with deionized water and dried for 24 hours. After drying, a sample of the substrates was abraded per the EPA interim method for anti-microbial efficacy. The chlorine density of the coated substrates was assessed by spectrophotometry according to the protocol detailed in EXAMPLE 5 with a total of 3 replicates. TABLE 30 summarizes the chlorine densities of the formulas.

TABLE 30

| | Chlorine densities (Cl+ atoms/cm2) | | | | | |
|---|---|---|---|---|---|---|
| | Formula B1 | | Formula B6 | | Formula B7 | |
| | Pre- | Post- | Pre- | Post- | Pre- | Post- |
| | abrasion | abrasion | abrasion | abrasion | abrasion | abrasion |
| Replicate 1 | 3.69E+16 | 4.82E+16 | 2.51E+16 | 4.41E+16 | 2.47E+16 | 5.63E+16 |
| Replicate 2 | 3.31E+16 | 5.75E+16 | 2.18E+16 | 3.46E+16 | 4.36E+16 | 6.28E+16 |
| Replicate 3 | 3.28E+16 | 4.70E+16 | 3.04E+16 | 4.09E+16 | 6.11E+16 | 5.95E+16 |
| Average | 3.43E+16 | 5.09E+16 | 2.58E+16 | 3.99E+16 | 4.32E+16 | 5.95E+16 |
| Standard | 1.84E+15 | 4.72E+15 | 3.53E+15 | 3.96E+15 | 1.49E+16 | 2.66E+15 |
| Deviation | | | | | | |

The three formulations assessed all were observed to have comparable chlorine densities following abrasion.

### Effect of HA/DMA and Crosslinker Concentration on Chlorine Density

To assess the effect of HA/DMA copolymer and crosslinker concentration on chlorine density, various compositions were prepared according to TABLE 31. Briefly, HA/DMA copolymer (2.0 g/L or 4.0 g/L) was dissolved in 70:30 ethanol:water overnight. To the HA/DMA copolymer solution, 30% H₂O₂ was added and the composition reacted for 3 hours. After 3 hours, APTES (0.1 mL/L or 0.2 mL/L) was added. The compositions were applied to stainless steel substrates and dried overnight at room temperature.

TABLE 31

| Component | Formula B8.1 | | Formula B8.2 | | Formula B8.3 | | Formula B8.4 | |
|---|---|---|---|---|---|---|---|---|
| HA-DMA | 4.0 | g/L | 4.0 | g/L | 2.0 | g/L | 2.0 | g/L |
| Copolymer | | | | | | | | |
| 30% Hydrogen | 2.62 | mL/L | 2.62 | mL/L | 2.62 | mL/L | 2.62 | mL/L |
| peroxide | | | | | | | | |
| APTES | 0.1 | mL/L | 0.2 | mL/L | 0.1 | mL/L | 0.2 | mL/L |
| Ethanol | 700 | mL/L | 700 | mL/L | 700 | mL/L | 700 | mL/L |
| Water | 297 | mL/L | 297 | mL/L | 297 | mL/L | 297 | mL/L |

The coated substrates were then sprayed with NaOCl (e.g., Clorox Pro® germicidal bleach) at pH 6.99 and about 8760 ppm with a contact time of 10 minutes. After 10 minutes, the substrates were rinsed with deionized water and dried for 24 hours. After drying, a sample of the substrates was abraded per the EPA MP-40 method. Chlorine density of the substrates was assessed by spectrophotometry according to the protocol detailed in EXAMPLE 5 with a total of 3 replicates. TABLE 32 summarizes the chlorine densities of the formulas.

TABLE 32

| | | Chlorine densities (Cl+ atoms/cm2) | | | |
|---|---|---|---|---|---|
| | | Formula | Formula | Formula | Formula |
| | | B8.1 | B8.2 | B8.3 | B8.4 |
| Un- | Replicate 1 | 7.82E+16 | 8.83E+16 | 5.55E+16 | 9.27E+16 |
| abraded | Replicate 2 | 8.27E+16 | 1.34E+17 | 1.26E+17 | 7.67E+16 |
| | Replicate 3 | 1.14E+17 | 8.79E+16 | 4.25E+16 | 3.56E+16 |
| | Average | 9.17E+16 | 1.03E+17 | 7.48E+16 | 6.84E+16 |
| Abraded | Replicate 1 | 6.24E+16 | 4.54E+16 | 2.92E+16 | 3.04E+16 |
| per EPA | Replicate 2 | 6.02E+16 | 5.90E+16 | 6.73E+16 | 9.93E+16 |
| MB-40 | Replicate 3 | 9.07E+16 | 1.11E+17 | 8.79E+16 | 6.64E+16 |
| method | Average | 7.11E+16 | 7.16E+16 | 6.14E+16 | 6.54E+16 |

All four formulations have high chlorine densities. Formulas B8.1 and B8.2 were observed to have higher chlorine densities than B8.3 and B8.4. The observation suggests that the concentration HA/DMA copolymer can affect the chlorine density in a coating of the composition.

### Effect of the Time Between Crosslinking and Applying to Chlorine Density.

A coating composition was prepared according to the concentrations in TABLE 33. Briefly, HA/DMA copolymer (2.0 g/L) was dissolved in 70:30 ethanol:water overnight. 30% H₂O₂ (2.62 ml/L) was added to the copolymer solution and the solution allowed to react for 3 hours. After three hours, APTES (1 ml/L) was added to the solution. Following addition of APTES, the solution was applied to stainless steel substrates at 0 minutes after adding APTES (T=0 min), at 10 minutes after adding APTES (T=10 min), at 30 minutes after adding APTES (T=30 min), at 60 minutes after adding APTES (T=60 min), and at 18 hours after adding APTES (T=18 hours). As a control, a formula without APTES was prepared and applied to a stainless steel substrate. The substrates were then dried overnight at room temperature.

TABLE 33

| Component | Formula B2 | |
|---|---|---|
| HA-DMA Copolymer | 2.0 | g/L |
| 30% Hydrogen peroxide | 2.62 | mL/L |
| APTES | 1 | mL/L |
| Ethanol | 700 | mL/L |
| Water | 296 | mL/L |

After drying, the substrates were sprayed with 1:48 diluted NaOCl (e.g. Clorox® germicidal bleach) at pH 10.5 and about 1400 ppm Cl₂ with a contact time of 10 minutes. After 10 minutes, the substrates were rinsed with deionized water and dried for 24 hours. After drying, a sample of the substrates was abraded per the EPA interim method for anti-microbial efficacy. Chlorine density of the substrates was assessed by spectrophotometry according to the protocol detailed in EXAMPLE 5 with a total of 3 replicates. TABLE 34 summarizes the chlorine densities at the different time-points.

TABLE 34

| | | Chlorine densities (Cl+ atoms/cm2) | | | | |
|---|---|---|---|---|---|---|
| Time between adding | | T = 0 | T = 10 | T = 30 | T = 60 | T = 18 |
| APTES and Spraying | | min | min | min | min | hours |
| Un- | Replicate 1 | 9.60E+16 | 7.29E+16 | 6.36E+16 | 7.86E+16 | 6.48E+16 |
| abraded | Replicate 2 | 9.63E+16 | 8.39E+16 | 7.93E+16 | 7.82E+16 | 8.42E+16 |
| | Replicate 3 | 7.21E+16 | 5.59E+16 | 7.82E+16 | 4.90E+16 | 5.18E+16 |
| | Average | 8.81E+16 | 7.09E+16 | 7.37E+16 | 6.86E+16 | 6.70E+16 |
| Abraded | Replicate 1 | 1.11E+17 | 8.95E+16 | 1.00E+17 | 1.01E+17 | 8.10E+16 |
| per EPA | Replicate 2 | 7.71E+16 | 1.20E+17 | 1.09E+17 | 9.70E+16 | 9.36E+16 |
| interim | Replicate 3 | 6.88E+16 | 1.09E+17 | 1.09E+17 | 7.09E+16 | 9.35E+16 |
| method | Average | 8.55E+16 | 1.06E+17 | 1.06E+17 | 8.97E+16 | 8.94E+16 |

The control formula was observed to lack film-forming capability and formed a powder-like deposition that was removed upon abrasion. At each of the time-points after adding APTES, coatings with high chlorine density were observed. The finding suggests that APTES is stable in the formulas and allows for the formation of stable film-forming coatings with high chlorine density.

### Abrasion Resistance of Coating Compositions

To assess the effect of the concentration of crosslinker in the composition on chlorine density and abrasion, various compositions were prepared according to the concentrations in TABLE 35. Briefly, HA/DMA copolymer (4.0 g/L) was dissolved in 70:30 ethanol:water in one chamber (PART A). To the dissolved HA/DMA, 30% H₂O₂ (5.24 mL/L) was added. In a separate chamber (PART B), APTES (7.5 mL/L, 1 mL/L) was dissolved in 100% ethanol. The compositions were applied to stainless steel substrates with a two-chamber spray bottle and dried overnight at room temperature.

TABLE 35

| | Components | Formulation B4 | | Formula B1 | |
|---|---|---|---|---|---|
| PART | HA-DMA Copolymer | 4.0 | g/L | 4.0 | g/L |
| A | 30% Hydrogen peroxide | 5.24 | mL/L | 5.24 | mL/L |
| | Ethanol | 700 | mL/L | 700 | mL/L |
| | Water | 295 | mL/L | 295 | mL/L |
| PART | APTES | 7.5 | mL/L | 1 | mL/L |
| B | Ethanol | 992.5 | mL/L | 999 | mL/L |

The coated substrates were then sprayed with HOCl (e.g., Disinfexol) at pH 4.64 and about 706 ppm Cl₂ with a total contact time of 10 minutes. The substrates were then rinsed with deionized water and dried for 24 hours. After drying, a sample of the substrates was abraded per the EPA interim method for anti-microbial efficacy. The chlorine density of the coated substrates was assessed by spectrophotometry according to the protocol detailed in EXAMPLE 5 with a total of 3 replicates. TABLE 36 summarizes the chlorine densities of the formulas.

TABLE 36

| | Chlorine densities (Cl+ atoms/cm2) | | | |
|---|---|---|---|---|
| | Formula B4 | | Formula B1 | |
| | Pre- | Post- | Pre- | Post- |
| | abrasion | abrasion | abrasion | abrasion |
| Replicate 1 | 7.49E+16 | 3.48E+16 | 3.52E+16 | 5.02E+16 |
| Replicate 2 | 4.93E+16 | 4.06E+16 | 4.78E+16 | 5.08E+16 |
| Replicate 3 | 3.69E+16 | 3.16E+16 | 5.43E+16 | 4.94E+16 |
| Average | 5.37E+16 | 3.567E+16 | 4.56E+16 | 5.01E+16 |
| Standard | 1.59E+16 | 1.41E+16 | 7.90E+15 | 5.58E+14 |
| Deviation | | | | |

Both compositions were observed to have chlorine density that withstood abrasion.

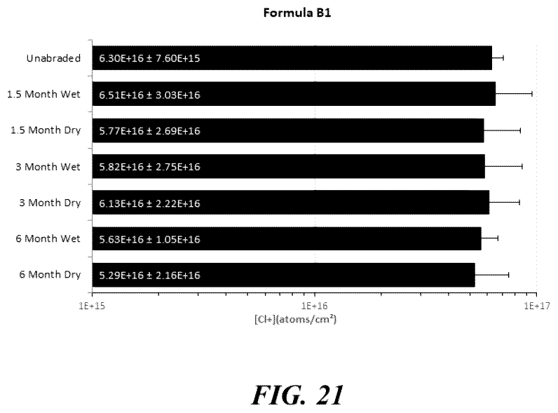

To assess the ability of coating compositions to withstand prolonged abrasion, Formula B1 was prepared according to the procedure previously disclosed and applied to stainless steel substrates using a two-chamber spray bottle. The substrates were dried overnight at room temperature. The abrasion resistance of the coated substrates was assessed using a modified EPA MB-40 protocol. Briefly, the coated substrates were abraded with a dry sponge or a sponge wetted by deionized water. The sponges were passed over the coated substrates for 260 passages, 520 passes, or 1040 passes corresponding to 1.5 months, 3 months, and 6 months of abrasion. A non-abraded substrate was used as a control. After abrasion, the substrates were sprayed with 1:10 diluted NaOCl (e.g., Clorox® germicidal bleach) at pH 7.0 and about 8000 ppm Cl₂ with a contact time of 10 minutes. After 10 minutes, the substrates were rinsed with deionized water and dried for 48 hours. After drying, the chlorine density of the substrates was assessed by spectrophotometry according to the protocol detailed in EXAMPLE 5 with a total of replicates. The chlorine density of the substrates is illustrated in FIG. 21 and summarized in TABLE 37.

TABLE 37

| | Chlorine densities (Cl+ atoms/cm2) | | | | | | |
|---|---|---|---|---|---|---|---|
| | | Wet Sponge | | | Dry Sponge | | |
| | Non- | 260 passes | 520 passes | 1040 passes | 260 passes | 520 passes | 1040 passes |
| | abraded | (1.5 month) | (3.0 month) | (6.0 month) | (1.5 month) | (3.0 month) | (6.0 month) |
| Replicate 1 | 6.82E+16 | 8.66E+16 | 7.45E+16 | 7.05E+16 | 7.19E+16 | 9.50E+16 | 8.53E+16 |
| Replicate 2 | 5.13E+16 | 2.90E+16 | 2.61E+16 | 5.13E+16 | 2.26E+16 | 4.58E+16 | 5.47E+16 |
| Replicate 3 | 6.13E+16 | 1.02E+17 | 9.45E+16 | 6.11E+16 | 9.32E+16 | 6.69E+16 | 4.66E+16 |
| Replicate 4 | 7.11E+16 | 4.24E+16 | 3.79E+16 | 4.24E+16 | 4.32E+16 | 3.76E+16 | 2.50E+16 |
| Average | 6.30E+16 | 6.51E+16 | 5.82E+16 | 5.63E+16 | 5.77E+16 | 6.13E+16 | 5.29E+16 |

The chlorine density was observed to be comparable across the abrasion conditions assessed. Substrates retained high chlorine density even after the equivalent of 6 months of abrasion. The finding indicates that coating compositions comprising N-halamines can form stable coatings that are capable of withstanding abrasion.

### Stability of Coating Compositions

To assess the shelf-stability of coating compositions, a sample of Formula B4 was prepared as previously disclosed. A sample of Formula B4 was applied to stainless steel substrates and the substrates dried overnight at room temperature. Separately, a sample of Formula B4 was stored for 1 week prior to applying to stainless steel substrates and the substrates dried overnight at room temperature. The dried substrates were sprayed with HOCl (e.g. Disinfexol) at pH 4.64 and about 706 ppm Cl₂ with a contact time of 10 minutes. After 10 minutes, the substrates were rinsed with deionized water and dried for 48 hours. After drying the chlorine density of coated substrates was assessed in triplicate by spectrophotometry according to the protocol in EXAMPLE 5. TABLE 38 summarizes the chlorine densities of substrates coated with Formula B4 and Formula B4 that was stored for 1 week prior to application.

TABLE 38

Chlorine densities (Cl+ atoms/cm2)

| | Formula B4 | Formula B4 |
|---|---|---|
| | (Fresh) | (Stored for 1 week) |
| Replicate 1 | 7.49E+16 | 3.97E+16 |
| Replicate 2 | 4.93E+16 | 5.19E+16 |
| Replicate 3 | 3.69E+16 | 6.84E+16 |
| Average | 5.37E+16 | 5.33E+16 |
| Standard Deviation | 1.59E+16 | 1.18E+16 |

Substrates coated with Formula B4 that had been stored for 1 week prior to application had comparably high chlorine densities to substrates coated with freshly prepared Formula B4. The finding suggests that Formula B4 is stable for at least 1 week.

Separately, to assess the shelf stability of coating compositions for an extended duration, a sample of Formulas B8.2 and B8.3 were prepared as previously described above. The formulas were stored at an elevated temperature of 50° C. for 2 weeks to simulate an accelerated aging process prior to applying to stainless steel substrates. After application, the substrates were dried overnight at room temperature and sprayed with NaOCl (e.g., Clorox Pro® germicidal bleach) with a contact time of 10 minutes. After 10 minutes, the samples were rinsed with deionized water and dried (e.g., 24 hours at room temperature). Following drying, the coating durability was assessed by abrasion with 2,000 ppm NaOCl according to the EPA MB-40 method. Following abrasion, the chlorine density of the coatings was assessed in triplicate by spectrophotometry according to the protocol in EXAMPLE 5. TABLE 39 summarizes the chlorine density of substrates coated with Formulas B8.2 and B8.3 after storage at 50° C. for 2 weeks.

TABLE 39

| | | Chlorine densities (Cl+ atoms/cm2) | |
|---|---|---|---|
| | | Formula | Formula |
| | | B8.2 | B8.3 |
| | | (Stored at 50° C. | (Stored at 50° C. |
| | | for 2 weeks) | for 2 weeks) |
| Un-abraded | Replicate 1 | 7.86E+16 | 5.02E+16 |
| | Replicate 2 | 9.44E+16 | 6.05E+16 |
| | Replicate 3 | 7.29E+16 | 4.78E+16 |
| | Average | 8.19E+16 | 5.29E+16 |
| Abraded per | Replicate 1 | 7.65E+16 | 3.48E+16 |
| EPA MB-40 | Replicate 2 | 7.67E+16 | 3.72E+16 |
| method | Replicate 3 | 9.52E+16 | 1.02E+17 |
| | Average | 8.28E+16 | 5.82E+16 |

Substrates coated with the Formulas B8.2 and B8.3 that a been store at 50° C. or 2 wee s were observed to have high chlorine densities that withstood abrasion. The finding suggests that compositions comprising N-halamines can form shelf-stable coatings that retain high chlorine density.

The above data indicate that coating comprising N-halamines can form durable, stable coatings that are shelf-stable for at least 2 weeks under conditions that replicate accelerated aging. The coating compositions were observed to have biocidal efficacy and have high chlorine density when applied to a surface. The findings suggest that N-halamines can form long-last coatings with biocidal activity.

### Example 10: Molecular Weight Analysis of a Compositions Comprising a N-Halamine

An assay can be performed to determine the molecular weight of any composition, polymer, or copolymer. The molecular weight can be determined by various forms of mass spectrometry (e.g., ESI-MS, MALDI-TOF mass spectrometry, CI mass spectrometry, APCI-MS, DART-MS, ASAP-MS, or EI mass spectrometry), or gel permeation chromatography (GPC). Given the significant molecular weights of compounds produced and the fact that polymers tend to be formed as a mixture of compounds, some techniques may be more reliable and reproducible for assessing the molecular weight of a product sample.

### EMBODIMENTS

The following non-limiting embodiments provide illustrative examples of the invention, but do not limit the scope of the invention.

Embodiment A1 A copolymer comprising a plurality of units of a first repeating group and a plurality of units of a second repeating group, wherein:
the first repeating group or a portion thereof is:

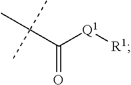

the second repeating group or a portion thereof is:

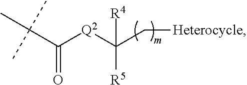

wherein
Q¹ is O, NH, or N(alkyl);
Q² is O, NH, or N(alkyl);
R¹ is H, —C(R²)(R³)(CH₂)ₙ-Charged Group;
R² is H or alkyl;
R³ is H or alkyl;
R⁴ is H or alkyl;
R⁵ is H or alkyl;
m is 0, 1, 2, 3, 4, or 5;
n is 0, 1, 2, 3, 4, or 5;
Charged Group is an ionized or ionizable moiety; and
Heterocycle is a heterocyclic ring containing a nitrogen atom.

Embodiment A2. The copolymer of embodiment A1, wherein the copolymer has a molecular mass of about 50 kilodaltons (kDa) to about 150 kDa.

Embodiment A3. The copolymer of embodiment A1, wherein the copolymer has a molecular mass of about 1 kDa to about 50 kDa.

Embodiment A4. The copolymer of embodiment A1, wherein the second repeating group and the first repeating group are present in a ratio of 10:1 to 1:10.

Embodiment A5. The copolymer of embodiment A1, wherein the second repeating group and the first repeating group are present in a ratio of 5:1 to 1:1.

Embodiment A6. The copolymer of embodiment A1, wherein the second repeating group and the first repeating group are present in a ratio of 7:3 to 1:1.

Embodiment A7. The copolymer of embodiment A1, wherein the second repeating group and the first repeating group are present in a ratio of about 7:3.

Embodiment A8. The copolymer of embodiment A1, wherein the second repeating group and the first repeating group are present in a ratio of about 3:2.

Embodiment A9. The copolymer of embodiment A1, wherein the second repeating group and the first repeating group are present in a ratio of about 1:1.

Embodiment A10. The copolymer of embodiment A1, further comprising a backbone, wherein the first repeating group and the second repeating groups are sidechains, or portions thereof, pendant to the backbone.

Embodiment A11. The copolymer of embodiment A1, wherein the first repeating group or a portion thereof is:

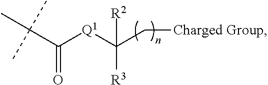

wherein n is 0, 1, 2, 3, 4, or 5.

Embodiment A12. The copolymer of embodiment A1, wherein the first repeating group is:

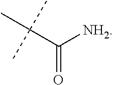

Embodiment A13. The copolymer of embodiment A1, wherein the first repeating group is:

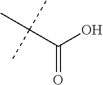

or an ionized form thereof.

Embodiment A14. The copolymer of embodiment A1, wherein the first repeating group is:

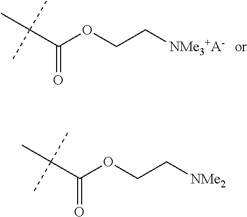

wherein A⁻ is an anion.

Embodiment A15. The copolymer of embodiment A1, wherein the first repeating group is:

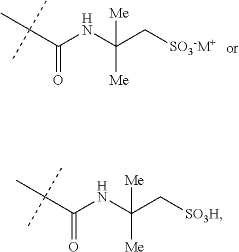

wherein M⁺ is a cation.

Embodiment A16. The copolymer of embodiment A1, wherein the second repeating group or a portion thereof is:

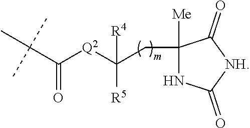

Embodiment A17. The copolymer of embodiment A1, wherein the second repeating group is:

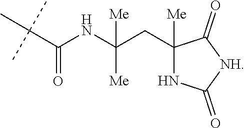

Embodiment A18. The copolymer of embodiment A1, wherein the first repeating group is:

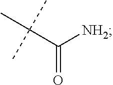

and the second repeating group is:

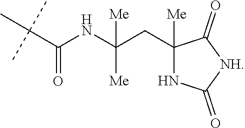

Embodiment A19. The copolymer of embodiment A1, wherein the first repeating group is:

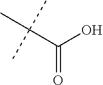

or an ionized form thereof; and the second repeating group is:

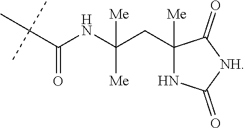

Embodiment A20. The copolymer of embodiment A1, wherein the first repeating group is:

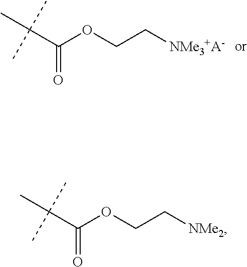

wherein A⁻ is an anion; and the second repeating group is:

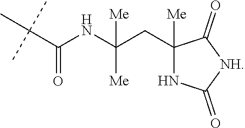

Embodiment A21. The copolymer of embodiment A1, wherein the first repeating group is:

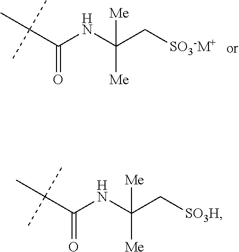

wherein M⁺ is a cation; and the second repeating group is:

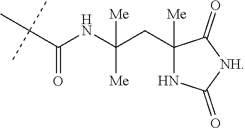

Embodiment A22. The copolymer of embodiment A1, further comprising a backbone and side chains pendant to the backbone, wherein the first repeating groups and the second repeating groups form portions of the backbone and of the sidechains.

Embodiment A23. The copolymer of embodiment A22, wherein the first repeating group or a portion thereof is:

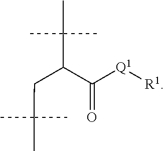

Embodiment A24. The copolymer of embodiment A22, wherein the first repeating group or a portion thereof is:

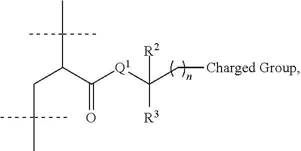

wherein n is 0, 1, 2, 3, 4, or 5.

Embodiment A25. The copolymer of embodiment A22, wherein the first repeating group is:

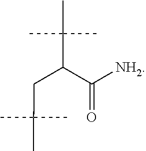

Embodiment A26. The copolymer of embodiment A22, wherein the first repeating group is:

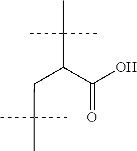

or an ionized form thereof.

Embodiment A27. The copolymer of embodiment A22, wherein the first repeating group is:

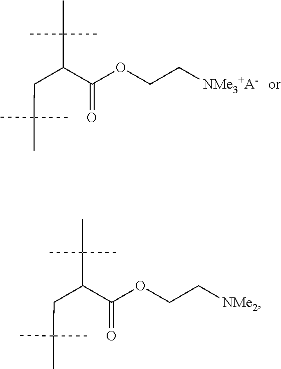

wherein A⁻ is an anion.

Embodiment A28. The copolymer of embodiment A22, wherein the first repeating group is:

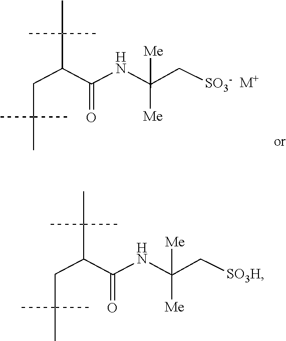

wherein M⁺ is a cation.

Embodiment A29. The copolymer of embodiment A22, wherein the second repeating group or a portion thereof is:

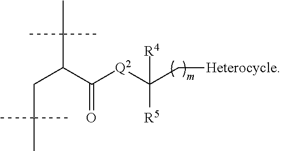

Embodiment A30. The copolymer of embodiment A22, wherein the second repeating group or a portion thereof is:

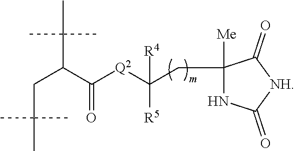

Embodiment A31. The copolymer of embodiment A22, wherein the second repeating group is:

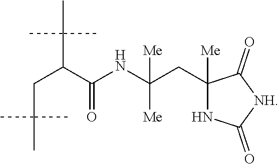

Embodiment A32. The copolymer of embodiment A22, wherein the first repeating group is:

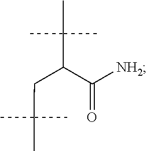

and the second repeating group is:

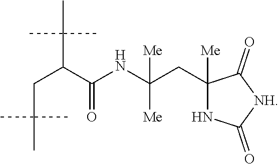

Embodiment A33. The copolymer of embodiment A22, wherein the first repeating group is:

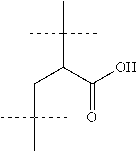

or an ionized form thereof; and the second repeating group is:

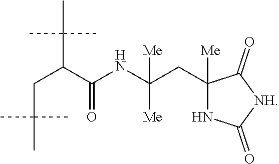

Embodiment A34. The copolymer of embodiment A22, wherein the first repeating group is:

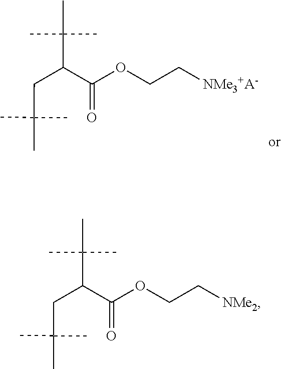

wherein A⁻ is an anion; and the second repeating group is:

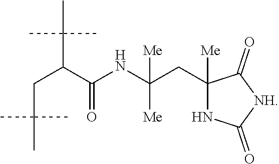

Embodiment A35. The copolymer of embodiment A22, wherein the first repeating group is:

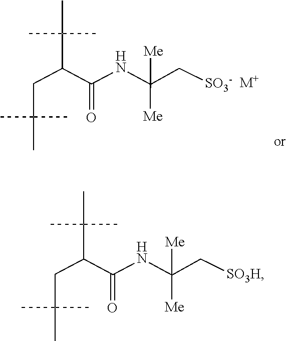

wherein M⁺ is a cation; and the second repeating group is:

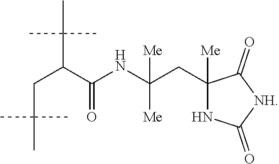

Embodiment A36. The composition of any one of embodiments A1-A35, wherein the copolymer is dissolvable in the aqueous medium at a concentration of at least about 0.1 w/v %.

Embodiment A37. The composition of any one of embodiments A1-A36, wherein the copolymer is dissolvable in the aqueous medium at a concentration of at least about 1 w/v %.

Embodiment A38. The composition of any one of embodiments A1-A37, wherein the copolymer is dissolvable in the aqueous medium at a concentration of at least about 3 w/v %.

Embodiment A39. The composition of any one of embodiments A1-A38, wherein the copolymer is dissolvable in the aqueous medium at a concentration of at least about 10 w/v %.

Embodiment A40. The composition of any one of embodiments A1-A39 wherein the copolymer is dissolvable in an aqueous medium.

Embodiment A41. The composition of embodiment A40, wherein the aqueous medium for dissolving the copolymer is substantially free of organic solvent.

Embodiment A42. The composition of embodiment A40, wherein the aqueous medium for dissolving the copolymer is substantially consisting of deionized water.

Embodiment A43. The composition of embodiment A40, wherein the aqueous medium for dissolving the copolymer has a pH value of about 5 and about 7.

Embodiment A44. The composition of embodiment A40, wherein upon dissolving the copolymer in the aqueous medium, a mixture comprising the copolymer and the aqueous medium has a pH value of about 3 and about 7.

Embodiment A45. The composition of embodiment A40, wherein upon dissolving the copolymer in the aqueous medium, a mixture comprising the copolymer and the aqueous medium has a pH value of about 3 and about 6.

Embodiment A46. The composition of embodiment A40, wherein upon dissolving the copolymer in the aqueous medium, a mixture comprising the copolymer and the aqueous medium has a pH value of about 4 and about 6.

Embodiment A47. The composition of embodiment A40, wherein the aqueous medium for dissolving the solid composition has a pH value of about 7 and about 10.

Embodiment A48. The composition of embodiment A40, wherein upon dissolving the copolymer in the aqueous medium, a mixture comprising the copolymer and the aqueous medium has a pH value of about 7 and about 10.

Embodiment A49. The composition of embodiment A40, wherein upon dissolving the copolymer in the aqueous medium, a mixture comprising the copolymer and the aqueous medium has a pH value of about 8 and about 10.

Embodiment A50. The composition of embodiment A40, wherein upon dissolving the copolymer in the aqueous medium, a mixture comprising the copolymer and the aqueous medium has a pH value of about 7 and about 9.

Embodiment A51. The composition of embodiment A40, wherein the aqueous medium for dissolving the solid composition has a pH value of at least about 10 and about 14.

Embodiment A52. The composition of embodiment A40, wherein upon dissolving the copolymer in the aqueous medium, a mixture comprising the copolymer and the aqueous medium a pH value of about 10 and about 14.

Embodiment A53. The composition of embodiment A40, wherein upon dissolving the copolymer in the aqueous medium, a mixture comprising the copolymer and the aqueous medium has a pH value of about 11 and about 14.

Embodiment A54. The composition of embodiment A40, wherein upon dissolving the copolymer in the aqueous medium, a mixture comprising the copolymer and the aqueous medium has a pH value of about 12 and about 14.

Embodiment B1. A copolymer comprising a plurality of units of a first repeating group and a plurality of units of a second repeating group, wherein:
the first repeating group or a portion thereof is:

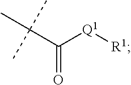

the second repeating group or a portion thereof is:

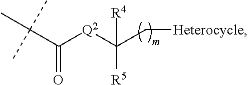

wherein
Q¹ is O, NCl, or N(alkyl);
Q² is O, NCl, or N(alkyl);
R¹ is H, Cl, —C(R²)(R³)(CH₂)ₙ-Charged Group;
R² is H or alkyl;
R³ is H or alkyl;
R⁴ is H or alkyl;
R⁵ is H or alkyl;
m is 0, 1, 2, 3, 4, or 5;
n is 0, 1, 2, 3, 4, or 5;
Charged Group is an ionizable or ionized moiety; and
Heterocycle is a heterocyclic ring containing a nitrogen atom that is substituted with a chlorine atom.

Embodiment B2. The copolymer of embodiment B1, wherein the copolymer has a molecular mass of about 50 kDa to about 150 kDa.

Embodiment B3. The copolymer of embodiment B1, wherein the copolymer has a molecular mass of about 1 kDa to about 50 kDa.

Embodiment B4. The copolymer of embodiment B1, wherein the second repeating group and the first repeating group are present in a ratio of 10:1 to 1:10.

Embodiment B5 The copolymer of embodiment B1, wherein the second repeating group and the first repeating group are present in a ratio of 5:1 to 1:1.

Embodiment B6. The copolymer of embodiment B1, wherein the second repeating group and the first repeating group are present in a ratio of 7:3 to 1:1.

Embodiment B7. The copolymer of embodiment B1, wherein the second repeating group and the first repeating group are present in a ratio of about 7:3.

Embodiment B8. The copolymer of embodiment B1, wherein the second repeating group and the first repeating group are present in a ratio of about 3:2.

Embodiment B9. The copolymer of embodiment B1, wherein the second repeating group and the first repeating group are present in a ratio of about 1:1.

Embodiment B10. The copolymer of embodiment B1, further comprising a backbone, wherein the first repeating group and the second repeating groups are sidechains, or portions thereof, pendant to the backbone.

Embodiment B11. The copolymer of embodiment B1, wherein the first repeating group or a portion thereof is:

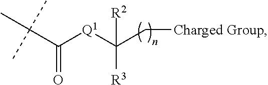

wherein n is 0, 1, 2, 3, 4, or 5.

Embodiment B12. The copolymer of embodiment B1, wherein the first repeating group is:

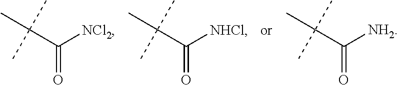

Embodiment B13. The copolymer of embodiment B1, wherein the first repeating group is:

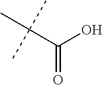

or an ionized form thereof.

Embodiment B14. The copolymer of embodiment B1, wherein the first repeating group is:

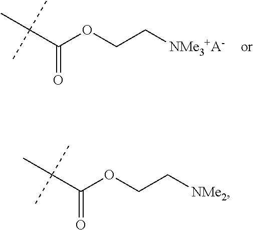

wherein A⁻ is an anion.

Embodiment B15. The copolymer of embodiment B1, wherein the first repeating group is:

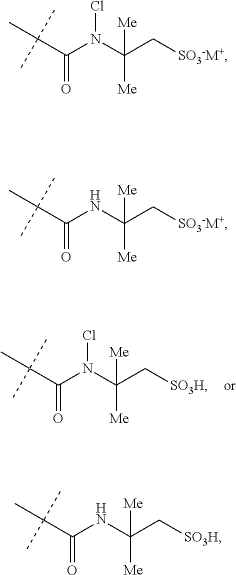

wherein M⁺ is a cation.

Embodiment B16. The copolymer of embodiment B1, wherein the second repeating group or a portion thereof is:

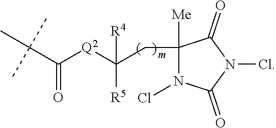

Embodiment B17. The copolymer of embodiment B1, wherein the second repeating group is:

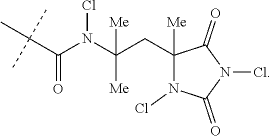

Embodiment B18. The copolymer of embodiment B1, wherein the first repeating group is:

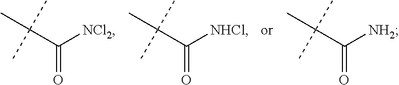

and the second repeating group is:

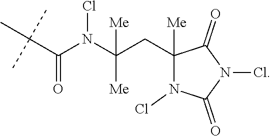

Embodiment B19. The copolymer of embodiment B1, wherein the first repeating group is:

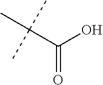

or an ionized form thereof; and the second repeating group is:

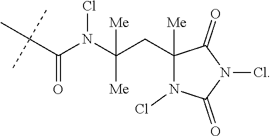

Embodiment B20. The copolymer of embodiment B1, wherein the first repeating group is:

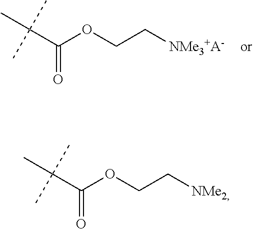

wherein A⁻ is an anion; and the second repeating group is:

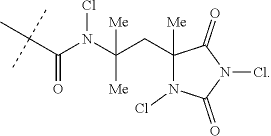

Embodiment B21. The copolymer of embodiment B1, wherein the first repeating group is:

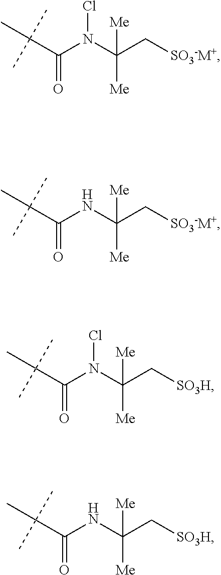

wherein M⁺ is a cation; and the second repeating group is:

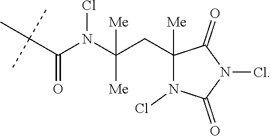

Embodiment B22. The copolymer of embodiment B1, further comprising a backbone and side chains pendant to the backbone, wherein the first repeating groups and the second repeating groups form portions of the backbone and of the sidechains.

Embodiment B23. The copolymer of embodiment B22, wherein the first repeating group or a portion thereof is:

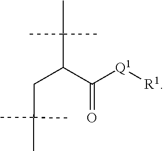

Embodiment B24. The copolymer of embodiment B22, wherein the first repeating group or a portion thereof is:

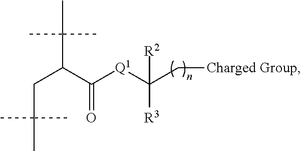

wherein n is 0, 1, 2, 3, 4, or 5.

Embodiment B25. The copolymer of embodiment B22, wherein the first repeating group is:

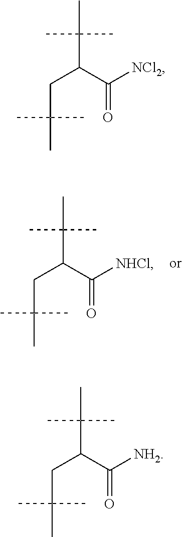

Embodiment B26. The copolymer of embodiment B22, wherein the first repeating group is:

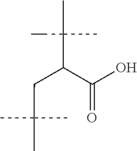

or an ionized form thereof.

Embodiment B27. The copolymer of embodiment B22, wherein the first repeating group is:

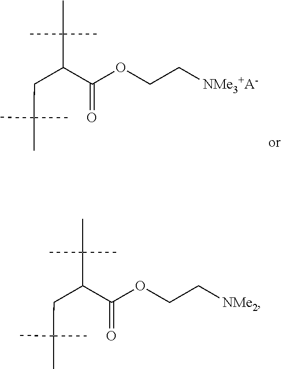

wherein A⁻ is an anion.

Embodiment B28. The copolymer of embodiment B22, wherein the first repeating group is:

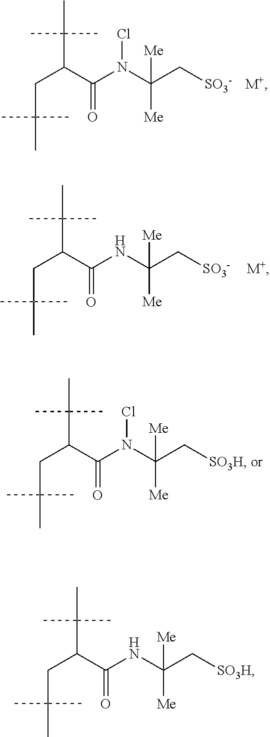

wherein M⁺ is a cation.

Embodiment B29. The copolymer of embodiment B22, wherein the second repeating group or a portion thereof is:

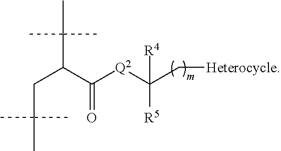

Embodiment B30. The copolymer of embodiment B22, wherein the second repeating group or a portion thereof is:

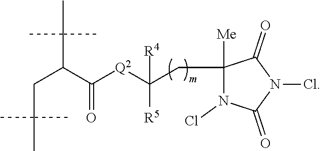

Embodiment B31. The copolymer of embodiment B22, wherein the second repeating group is:

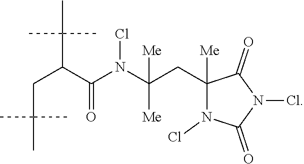

Embodiment B32. The copolymer of embodiment B22, wherein the first repeating group is:

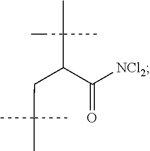

and the second repeating group is:

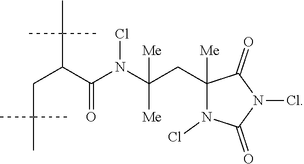

Embodiment B33. The copolymer of embodiment B22, wherein the first repeating group is:

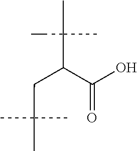

or an ionized form thereof; and the second repeating group is:

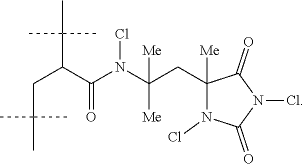

Embodiment B34. The copolymer of embodiment B22, wherein the first repeating group is:

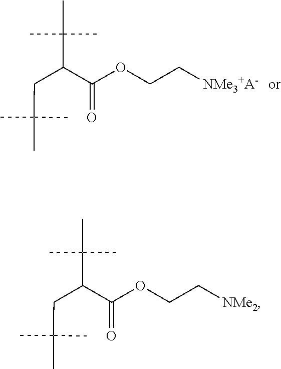

wherein A⁻ is an anion; and the second repeating group is:

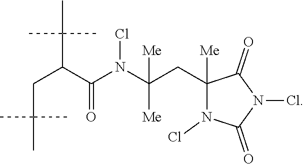

Embodiment B35. The copolymer of embodiment B22, wherein the first repeating group is:

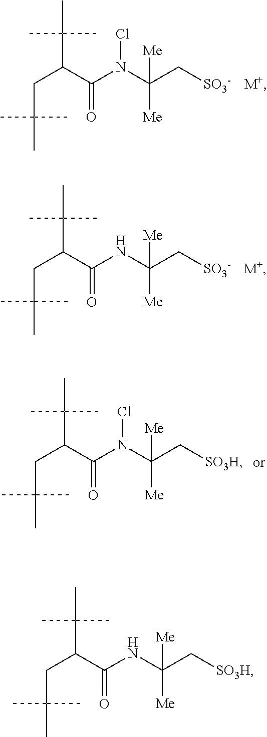

wherein M⁺ is a cation; and the second repeating group is:

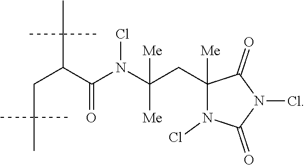

Embodiment B36. The copolymer of any one of embodiments B1-B35, wherein the copolymer has a chlorine content of about 50,000 ppm to about 250,000 ppm as determined by iodometric/thiosulfate titration.

Embodiment B37. The copolymer of any one of embodiments B1-B35, wherein the copolymer has a chlorine content of about 50,000 ppm to about 250,000 ppm as determined by spectrometer based on absorbency at 530 nm using N,N-diethyl-p-phenylenediamine (DPD) as an indicator.

Embodiment B38. The copolymer of any one of embodiments B1-B35, wherein the copolymer has a chlorine content of about 4% to about 30% as determined by iodometric/thiosulfate titration.

Embodiment B39. The copolymer of any one of embodiments B1-B35, wherein the copolymer has a chlorine content of about 4% to about 30% as determined by spectrometer based on absorbency at 530 nm using N,N-diethyl-p-phenylenediamine (DPD) as an indicator.

Embodiment B40. The composition of any one of embodiments B1-B39, wherein the copolymer is dissolvable in the aqueous medium at a concentration of at least about 0.1 w/v %.

Embodiment B41. The composition of any one of embodiments B1-B40, wherein the copolymer is dissolvable in the aqueous medium at a concentration of at least about 1 w/v %.

Embodiment B42. The composition of any one of embodiments B1-B41, wherein the copolymer is dissolvable in the aqueous medium at a concentration of at least about 3 w/v %.

Embodiment B43. The composition of any one of embodiments B1-B42, wherein the copolymer is dissolvable in the aqueous medium at a concentration of at least about 10 w/v %.

Embodiment B44. The composition of any one of embodiments B1-B43 wherein the copolymer is dissolvable in an aqueous medium.

Embodiment B45. The composition of embodiment B44, wherein the aqueous medium for dissolving the copolymer is substantially free of organic solvent.

Embodiment B46. The composition of embodiment B44, wherein the aqueous medium for dissolving the copolymer is substantially consisting of deionized water.

Embodiment B47. The composition of embodiment B44, wherein the aqueous medium for dissolving the copolymer has a pH value of about 5 and about 7.

Embodiment B48. The composition of embodiment B44, wherein upon dissolving the copolymer in the aqueous medium, a mixture comprising the copolymer and the aqueous medium has a pH value of about 3 and about 7.

Embodiment B49. The composition of embodiment B44, wherein upon dissolving the copolymer in the aqueous medium, a mixture comprising the copolymer and the aqueous medium has a pH value of about 3 and about 6.

Embodiment B50. The composition of embodiment B44, wherein upon dissolving the copolymer in the aqueous medium, a mixture comprising the copolymer and the aqueous medium has a pH value of about 4 and about 6.

Embodiment B51. The composition of embodiment B44, wherein the aqueous medium for dissolving the solid composition has a pH value of about 7 and about 10.

Embodiment B52. The composition of embodiment B44, wherein upon dissolving the copolymer in the aqueous medium, a mixture comprising the copolymer and the aqueous medium has a pH value of about 7 and about 10.

Embodiment B53. The composition of embodiment B44, wherein upon dissolving the copolymer in the aqueous medium, a mixture comprising the copolymer and the aqueous medium has a pH value of about 8 and about 10.

Embodiment B54. The composition of embodiment B44, wherein upon dissolving the copolymer in the aqueous medium, a mixture comprising the copolymer and the aqueous medium has a pH value of about 7 and about 9.

Embodiment B55. The composition of embodiment B44, wherein the aqueous medium for dissolving the solid composition has a pH value of at least about 10 and about 14.

Embodiment B56. The composition of embodiment B44, wherein upon dissolving the copolymer in the aqueous medium, a mixture comprising the copolymer and the aqueous medium a pH value of about 10 and about 14.

Embodiment B57. The composition of embodiment B44, wherein upon dissolving the copolymer in the aqueous medium, a mixture comprising the copolymer and the aqueous medium has a pH value of about 11 and about 14.

Embodiment B58. The composition of embodiment B44, wherein upon dissolving the copolymer in the aqueous medium, a mixture comprising the copolymer and the aqueous medium has a pH value of about 12 and about 14.

Embodiment C1. A method comprising combining:
a sample of a compound of formula (I):

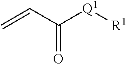

or an ionized form thereof;
a sample of a compound of formula (II):

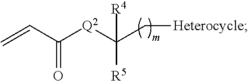

and
a solvent under free radical polymerization conditions to provide a mixture, wherein:
Q¹ is O, NH, or N(alkyl);
Q² is O, NH, or N(alkyl);
R¹ is H, —C(R²)(R³)(CH₂)ₙ-Charged Group;
R² is H or alkyl;
R³ is H or alkyl;
R⁴ is H or alkyl;
R⁵ is H or alkyl;
m is 0, 1, 2, 3, 4, or 5;
n is 0, 1, 2, 3, 4, or 5;
Charged Group is an ionizable or ionized moiety; and
Heterocycle is a heterocyclic ring containing a nitrogen atom.

Embodiment C2. The method of embodiment C1, wherein the compound of formula (II) is:

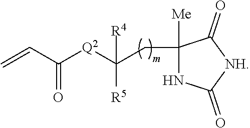

Embodiment C3. The method of embodiment C1, wherein the compound of formula (II) is:

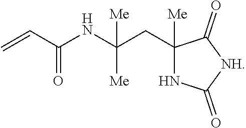 [SMILES: C=CC(=O)NC(C)(C)CC1(C)NC(=O)NC1=O]

Embodiment C4. The method of embodiment C1, wherein the compound of formula (I) is:

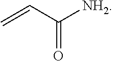

Embodiment C5. The method of embodiment C1, wherein the compound of formula (I) is:

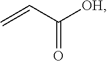

or an ionized for thereof.

Embodiment C6. The method of embodiment C1, wherein the compound of formula (I) is:

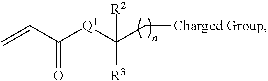

wherein n is 0, 1, 2, 3, 4, or 5.

Embodiment C7. The method of embodiment C1, wherein the compound of formula (I) is:

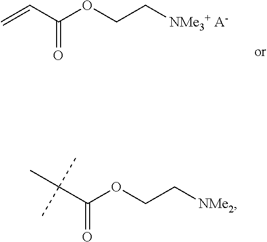

wherein A⁻ is an anion.

Embodiment C8. The method of embodiment C1,

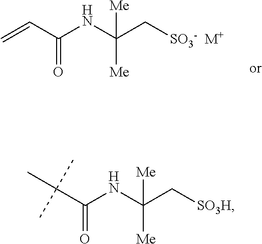

wherein M⁺ is a cation.

Embodiment C9. The method of any one of embodiments C1-C8, wherein the mixture is in a vessel suitable for containing a polymerization reaction.

Embodiment C10. The method of any one of embodiments C1-C9, wherein the solvent comprises a polar solvent.

Embodiment C11. The method of any one of embodiments C1-C10, wherein the solvent comprises a protic solvent.

Embodiment C12. The method of any one of embodiments C1-C11, wherein the solvent comprises water.

Embodiment C13. The method of any one of embodiments C1-C11, wherein the solvent comprises an alcohol.

Embodiment C14. The method of any one of embodiments C1-C11, wherein the solvent comprises methanol.

Embodiment C15. The method of any one of embodiments C1-C11, wherein the solvent comprises ethanol.

Embodiment C16. The method of any one of embodiments C1-C15, wherein the free radical polymerization conditions comprise an amount of a free radical polymerization initiator sufficient to initiate free radical polymerization.

Embodiment C17. The method of any one of embodiments C1-C15, wherein the free radical polymerization conditions comprise mixing the sample of the compound of formula (I), the sample of the compound of formula (II), and the solvent in a vessel suitable for containing a polymerization reaction, then introducing into the vessel an amount of the free radical polymerization initiator sufficient to initiate free radical polymerization.

Embodiment C18. The method of any one of embodiments C16-C17, wherein the free radical polymerization initiator is potassium persulfate.

Embodiment C19. The method of any one of embodiments C16-C17, wherein the free radical polymerization initiator is azobisisobutyronitrile.

Embodiment C20. The method of any one of embodiments C1-C19, wherein further comprising mixing the sample of the compound of formula (I) with the solvent prior to the combining.

Embodiment C21. The method of any one of embodiments C1-C20, wherein further comprising mixing the sample of the compound of formula (II) with the solvent prior to the combining.

Embodiment C22. The method of any one of embodiments C1-C19, wherein further comprising mixing the sample of the compound of formula (I) with water prior to the combining.

Embodiment C23. The method of any one of embodiments C1-C19 and C22, wherein further comprising mixing the sample of the compound of formula (II) with water prior to the combining.

Embodiment C24. The method of any one of embodiments C1-C24, further comprising stirring the mixture to provide a copolymer, wherein the copolymer is the copolymer of any one of embodiments A1-A34.

Embodiment C25. The method of embodiment C24, wherein the stirring is at a temperature of at least about 50° C.

Embodiment C26. The method of embodiment C24, wherein the stirring is at a temperature of about 80° C.

Embodiment C27. The method of any one of embodiments C24-C26, wherein the stirring is for at least about 1 hour.

Embodiment C28. The method of any one of embodiments C24-C26, wherein the stirring is for at least about 4 hours.

Embodiment C29. The method of any one of embodiments C1-C28, further comprising collecting a product from the mixture.

Embodiment C30. The method of any one of embodiments C1-C29, further comprising subjecting the mixture to reduced pressure.

Embodiment C31. The method of any one of embodiments C1-C30, further comprising removing substantially all the solvent from the mixture.

Embodiment C32. The method of any one of embodiments C1-C31, further comprising subjecting the mixture to reduced pressure, thereby removing substantially all the solvent from the mixture.

Embodiment C33. The method of any one of embodiments C1-C32, further comprising obtaining a product from the mixture.

Embodiment C34. The method of any one of embodiments C1-C33, further comprising obtaining a product from the mixture by precipitation.

Embodiment C35. The method of any one of embodiments C1-C34, further comprising obtaining a product from the mixture, wherein the product is the copolymer of any one of embodiments B1-B58.

Embodiment C36. The method of any one of embodiments C1-C35, further comprising obtaining a product from the mixture in an amount of at least 1 kg.

Embodiment C37. The method of any one of embodiments C1-C36, further comprising obtaining a product from the mixture in an amount of at least 100 kg.

Embodiment C38. The method of any one of embodiments C1-C37, further comprising obtaining a product from the mixture in an amount of at least 1,000 kg.

Embodiment C39. The method of any one of embodiments C1-C38, wherein the compound of formula (II) and the compound of formula (I) are combined in a molar ratio of 10:1 to 1:10.

Embodiment C40. The method of any one of embodiments C1-C38, wherein the compound of formula (II) and the compound of formula (I) are combined in a molar ratio of 5:1 to 1:1.

Embodiment C41. The method of any one of embodiments C1-C38, wherein the compound of formula (II) and the compound of formula (I) are combined in a molar ratio of 7:3 to 1:1.

Embodiment C42. The method of any one of embodiments C1-C38, wherein the compound of formula (II) and the compound of formula (I) are combined in a molar ratio of about 7:3.

Embodiment C43. The method of any one of embodiments C1-C38, wherein the compound of formula (II) and the compound of formula (I) are combined in a molar ratio of about 3:2.

Embodiment C44. The method of any one of embodiments C1-C38, wherein the compound of formula (II) and the compound of formula (I) are combined in a molar ratio of about 1:1.

Embodiment D1. A method comprising contacting a copolymer with an electrophilic chlorine source to provide a mixture, wherein the copolymer is a compound of any one of embodiments A1-A54.

Embodiment D2. The method of embodiment D1, wherein the electrophilic chlorine source is hypochlorous acid.

Embodiment D3. The method of embodiment D1, wherein the electrophilic chlorine source is sodium hypochlorite.

Embodiment D4. The method of any one of embodiments D1-D3, wherein the electrophilic chlorine source and the copolymer are present in the mixture in a ratio of 20:1 to 1:1.

Embodiment D5. The method of any one of embodiments D1-D4, wherein the electrophilic chlorine source and the copolymer are present in the mixture in a ratio of 10:1.

Embodiment D6. The method of any one of embodiments D1-D4, wherein the electrophilic chlorine source and the copolymer are present in the mixture in a ratio of 2:1.

Embodiment D7. The method of any one of embodiments D1-D6, further comprising adding a pH adjusting agent to the mixture.

Embodiment D8. The method of any one of embodiments D1-D7, further comprising adding a pH adjusting agent to the mixture to provide a pH of about 7 to about 11 in the mixture.

Embodiment D9. The method of any one of embodiments D7-D8, wherein the pH adjusting agent is an acidifying agent.

Embodiment D10. The method of any one of embodiments D7-D9, wherein the pH adjusting agent is hydrochloric acid.

Embodiment D11. The method of any one of embodiments D7-D10, wherein the pH adjusting agent is 4N HCl.

Embodiment D12. The method of any one of embodiments D1-D11, wherein the contacting is at room temperature.

Embodiment D13. The method of any one of embodiments D1-D12, further comprising stirring the mixture for about 5 hours to about 24 hours.

Embodiment D14. The method of embodiment D13, further comprising, after the stirring, contacting to the mixture a salt.

Embodiment D15. The method of embodiment D14, wherein the salt is NaCl.

Embodiment D16. The method of embodiment D13, wherein further comprising, after the stirring, contacting to the mixture an acidifying agent.

Embodiment D17. The method of embodiment D13, wherein further comprising, after the stirring, contacting to the mixture an acidifying agent to provide in the mixture a pH of about 3 to about 6.

Embodiment D18. The method of embodiment D17, wherein the acidifying agent is hydrochloric acid.

Embodiment D19. The method of embodiment D17, wherein the acidifying agent is 4N HCl.

Embodiment D20. The method of embodiment D13, wherein further comprising, after the stirring, contacting to the mixture a basifying agent.

Embodiment D21. The method of embodiment D13, wherein further comprising, after the stirring, contacting to the mixture a basifying agent to provide in the mixture a pH of about 8 to about 10.

Embodiment D22. The method of embodiment D21, wherein the basifying agent is sodium bicarbonate.

Embodiment D23. The method of any one of embodiments D1-D22, further comprising collecting a product from the mixture.

Embodiment D24. The method of embodiment D23, wherein the product is a crude product, further comprising obtaining a crude product from the mixture and washing the crude product with water.

Embodiment D25. The method of any one of embodiments D23-D24, comprising collecting the product from the mixture by precipitation.

Embodiment D26. The method of any one of embodiments D23-D24, comprising collecting the product from the mixture by centrifugation.

Embodiment D27. The method of any one of embodiments D23-D24, comprising collecting the product from the mixture by centrifugation at about 10,000 rpm for about two minutes.

Embodiment D28. The method of any one of embodiments D23-D24, comprising collecting the product from the mixture as a dry powder.

Embodiment D29. The method of any one of embodiments D23-D24, further comprising collecting a product from the mixture by vacuum filtration.

Embodiment D30. The method of any one of embodiments D23-D29, wherein the product is a chlorinated form of the copolymer.

Embodiment D31. The method of embodiment D30, wherein the chlorinated form of the copolymer is of any one of embodiments B1-B38.

Embodiment D32. The method of any one of embodiments D30-D31, further comprising analyzing the chlorinated form of the copolymer to assess chlorine content.

Embodiment D33. The method of any one of embodiments D30-D32, further comprising analyzing the chlorinated form of the copolymer by iodometric/thiosulfate titration to assess chlorine content.

Embodiment D34. The method of any one of embodiments D30-D32, further comprising analyzing the chlorinated form of the copolymer by spectrometer based on absorbency at 530 nm using N,N-diethyl-p-phenylenediamine (DPD) as an indicator to assess chlorine content.

Embodiment D35. The method of any one of embodiments D30-D34, further comprising analyzing the chlorinated form of the copolymer to assess chlorine content and determining that the chlorine content is about 50,000 ppm to about 250,000 ppm.

Embodiment D36. The method of any one of embodiments D30-D34, further comprising analyzing the chlorinated form of the copolymer to assess chlorine content and determining that the chlorine content is about 4% to about 30%.

Embodiment E1. A method comprising assessing chlorine content of a chlorinated copolymer, wherein the chlorinated copolymer is the copolymer of any one of embodiments B1-B38.

Embodiment E2. The method of embodiment E1, wherein the assessing comprises iodometric/thiosulfate titration.

Embodiment E3. The method of embodiment E2, wherein the assessing comprises analyzing the chlorinated form of the copolymer by spectrometer based on absorbency at 530 nm using N,N-diethyl-p-phenylenediamine (DPD) as an indicator to assess chlorine content.

Embodiment E4. The method of any one of embodiments E1-E3, wherein the assessing determines that the chlorine content is about 50,000 ppm to about 250,000 ppm.

Embodiment E5. The method of any one of embodiments E1-E3, wherein the assessing determines that the chlorine content is about 4% to about 30%.

Embodiment F1. A solid composition comprising:
(i) a N-chlorinated halamine, wherein the N-chlorinated halamine is part of a side chain of a first repeating unit of a polymer; and
(ii) a quaternary ammonium moiety,
wherein the solid composition is dissolvable in an aqueous medium.
   optionally wherein:
(x) the side chain comprises a nitrogen-containing heterocycle, wherein the nitrogen-containing heterocycle comprises the N-chlorinated halamine; and/or
(x) the side chain comprises a plurality of N-chlorinated halamines; and/or
(x) the polymer is a copolymer comprising the first repeating unit and a second repeating unit, wherein the second additional repeating unit comprises a side chain comprising the quaternary ammonium moiety,
   further optionally wherein the second repeating unit comprises the structure:

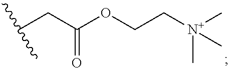

and/or
(x) the first repeating unit comprises the structure:

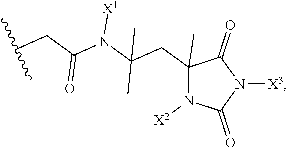

wherein at least one member of X¹, X², and X³ is Cl, and the other members of X¹, X², and X³ is each H or Cl; and/or
(x) the first repeating unit comprises the structure:

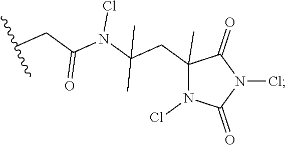

(x) the first repeating unit (RU1) and the second repeating unit (RU2) are present in the copolymer in a molar ratio of about 4:6 to about 6:4 (RU1:RU2); and/or
(x) the first repeating unit (RU1) and the second repeating unit (RU2) are present in the copolymer in a molar ratio of about 5:5 (RU1:RU2); and/or
(x) the copolymer is dissolvable in the aqueous medium at a concentration of at least about 0.1 w/v %;
(x) the copolymer is dissolvable in the aqueous medium at a concentration of at least about 1 w/v %;
(x) the copolymer is dissolvable in the aqueous medium at a concentration of at least about 3 w/v %;
(x) the copolymer is dissolvable in the aqueous medium at a concentration of at least about 10 w/v %;
(x) at least about 5% of N-halamine precursors of the copolymer is chlorinated to form N-chlorinated halamines; and/or
(x) at least about 10% of N-halamine precursors of the copolymer is chlorinated to form N-chlorinated halamines; and/or
(x) at least about 30% of N-halamine precursors of the copolymer is chlorinated to form N-chlorinated halamines; and/or
(x) an average molar mass of the copolymer is at least about 50 kilodaltons (kDa); and/or
(x) an average molar mass of the copolymer is at least about 100 kDa; and/or
(x) an average molar mass of the copolymer is less than about 50 kDa; and/or
(x) the aqueous medium for dissolving the solid composition is substantially free of organic solvent; and/or
(x) the aqueous medium for dissolving the solid composition is substantially consisting of deionized water; and/or
(x) the aqueous medium for dissolving the solid composition has a pH value of about 5 and about 7; and/or
(x) upon dissolving the solid composition in the aqueous medium, a mixture comprising the (i) the N-chlorinated halamine and the quaternary ammonium moiety and (ii) the aqueous medium has a pH value of about 3 and about 7; and/or
(x) upon dissolving the N-chlorinated halamine and the quaternary ammonium moiety in the aqueous medium, a mixture comprising (i) the N-chlorinated halamine and the quaternary ammonium moiety and (ii) the aqueous medium has a pH value of about 3 and about 6; and/or
(x) upon dissolving (i) the N-chlorinated halamine and the quaternary ammonium moiety in the aqueous medium, a mixture comprising (i) the N-chlorinated halamine and the quaternary ammonium moiety and (ii) the aqueous medium has a pH value of about 4 and about 6; and/or
(x) the aqueous medium for dissolving the solid composition has a pH value of about 7 and about 10; and/or
(x) upon dissolving the solid composition in the aqueous medium, a mixture comprising the (i) the N-chlorinated halamine and the quaternary ammonium moiety and (ii) the aqueous medium has a pH value of about 7 and about 10; and/or
(x) upon dissolving, the N-chlorinated halamine and the quaternary ammonium moiety in the aqueous medium, a mixture comprising (i) the N-chlorinated halamine and the quaternary ammonium moiety and (ii) the aqueous medium has a pH value of about 8 and about 10; and/or
(x) upon dissolving (i) the N-chlorinated halamine and the quaternary ammonium moiety in the aqueous medium, a mixture comprising (i) the N-chlorinated halamine and the quaternary ammonium moiety and (ii) the aqueous medium has a pH value of about 7 and about 9; and/or
(x) the aqueous medium for dissolving the solid composition has a pH value of at least about 10 and about 14; and/or
(x) upon dissolving the solid composition in the aqueous medium, a mixture comprising the (i) the N-chlorinated halamine and the quaternary ammonium moiety and (ii) the aqueous medium has a pH value of about 10 and about 14; and/or
(x) upon dissolving, the N-chlorinated halamine and the quaternary ammonium moiety in the aqueous medium, a mixture comprising (i) the N-chlorinated halamine and the quaternary ammonium moiety and (ii) the aqueous medium has a pH value of about 11 and about 14
(x) upon dissolving (i) the N-chlorinated halamine and the quaternary ammonium moiety in the aqueous medium, a mixture comprising (i) the N-chlorinated halamine and the quaternary ammonium moiety and (ii) the aqueous medium has a pH value of about 12 and about 14; and/or
(x) the solid composition is in a powder form; and/or
(x) the solid composition is in a tablet form; and/or
(x) upon application of at least the N-chlorinated halamine and the quaternary ammonium moiety to a surface to generate a coating on the surface, the coating exhibits residual biocidal activity,
   further optionally wherein the residual biocidal activity is exhibited in absence of any additional application of a chlorine source.

Embodiment G1. A composition comprising a copolymer, wherein the copolymer comprises a first repeating unit and a second repeating unit, wherein:
(i) the first repeating unit comprises a side chain, wherein the side chain comprises a N-chlorinated halamine moiety; and
(ii) the second repeating unit comprises a water-soluble moiety,
wherein the composition is soluble in an aqueous medium,
   optionally wherein:
(x) the side chain of the first repeating unit comprises a nitrogen-containing heterocycle, wherein the nitrogen-containing heterocycle comprises the N-chlorinated halamine; and/or
(x) the side chain of the first repeating unit comprises a plurality of N-chlorinated halamines; and/or
(x) the second repeating unit comprises a side chain comprising the water-soluble moiety,
   further optionally wherein:
   (a) the water-soluble moiety comprises a quaternary amine,
      further optionally wherein the second repeating unit comprises the structure:

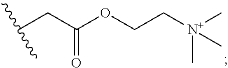

and/or
(b) the water-soluble moiety comprises a sulfonic acid;
   further optionally wherein the second repeating unit comprises the structure:

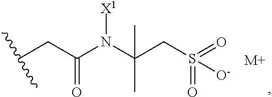

wherein X¹ is H or Cl and M⁺ is a cation; and/or
(c) the water-soluble moiety comprises an amide;
   further optionally wherein the second repeating unit comprises the structure:

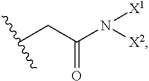

wherein X¹ is H or Cl, and X² is H or Cl; and/or
(d) the water-soluble moiety comprises a carboxylic acid;
   further optionally wherein the second repeating unit comprises the structure:

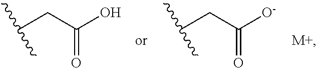

wherein M+ is a cation; and/or
(x) the first repeating unit comprises the structure:

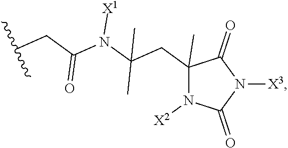

wherein at least one member of X¹, X², and X³ is Cl, and the other members of X¹, X², and X³ is each H or Cl; and/or
(x) the first repeating unit comprises the structure:

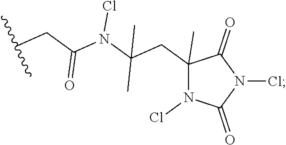

and/or
(x) the first repeating unit (RU1) and the second repeating unit (RU2) are present in the copolymer in a molar ratio of about 4:6 to about 8:2 (RU1:RU2); and/or
(x) the first repeating unit (RU1) and the second repeating unit (RU2) are present in the copolymer in a molar ratio of less than or equal to 7:3 (RU1:RU2); and/or
(x) the first repeating unit (RU1) and the second repeating unit (RU2) are present in the copolymer in a molar ratio of about 5:5 (RU1:RU2); and/or
(x) the copolymer is dissolvable in the aqueous medium at a concentration of at least about 0.1 w/v %;
(x) the copolymer is dissolvable in the aqueous medium at a concentration of at least about 1 w/v %;
(x) the copolymer is dissolvable in the aqueous medium at a concentration of at least about 3 w/v %;
(x) the copolymer is dissolvable in the aqueous medium at a concentration of at least about 10 w/v %;
(x) at least about 5% of N-halamine precursors of the copolymer is chlorinated to form N-chlorinated halamines; and/or
(x) at least about 10% of N-halamine precursors of the copolymer is chlorinated to form N-chlorinated halamines; and/or
(x) at least about 30% of N-halamine precursors of the copolymer is chlorinated to form N-chlorinated halamines; and/or
(x) an average molar mass of the copolymer is at least about 50 kilodaltons (kDa); and/or
(x) an average molar mass of the copolymer is at least about 100 kDa; and/or
(x) an average molar mass of the copolymer is less than about 50 kDa; and/or
(x) the aqueous medium for dissolving the copolymer is substantially free of organic solvent; and/or
(x) the aqueous medium for dissolving the copolymer is substantially consisting of deionized water; and/or
(x) the aqueous medium for dissolving the copolymer has a pH value of about 5 and about 7; and/or
(x) upon dissolving the copolymer in the aqueous medium, a mixture comprising the copolymer and the aqueous medium has a pH value of about 3 and about 7; and/or
(x) upon dissolving the copolymer in the aqueous medium, a mixture comprising the copolymer and the aqueous medium has a pH value of about 3 and about 6; and/or
(x) upon dissolving the copolymer in the aqueous medium, a mixture comprising the copolymer and the aqueous medium has a pH value of about 4 and about 6; and/or
(x) the aqueous medium for dissolving the copolymer has a pH value of about 7 and about 10; and/or
(x) upon dissolving the copolymer in the aqueous medium, a mixture comprising the copolymer and the aqueous medium has a pH value of about 7 and about 10; and/or
(x) upon dissolving the copolymer in the aqueous medium, a mixture comprising the copolymer and the aqueous medium has a pH value of about 8 and about 10; and/or
(x) upon dissolving the copolymer in the aqueous medium, a mixture comprising the copolymer and the aqueous medium has a pH value of about 7 and about 9; and/or
(x) the aqueous medium for dissolving the copolymer has a pH value of about 10 and about 14; and/or
(x) upon dissolving the copolymer in the aqueous medium, a mixture comprising the copolymer and the aqueous medium has a pH value of about 10 and about 14; and/or
(x) upon dissolving the copolymer in the aqueous medium, a mixture comprising the copolymer and the aqueous medium has a pH value of about 11 and about 14; and/or
(x) upon dissolving the copolymer in the aqueous medium, a mixture comprising the copolymer and the aqueous medium has a pH value of about 12 and about 14; and/or
(x) the composition is a solid composition,
   further optionally wherein:
   (i) the solid composition is in a powder form; and/or
   (ii) the solid composition is in a tablet form; and/or
(x) upon application of at least the copolymer to a surface to generate a coating on the surface, the coating exhibits residual biocidal activity,
   further optionally wherein the residual biocidal activity is exhibited in absence of any additional application of a chlorine source.

Embodiment H1. A composition comprising a copolymer, wherein the copolymer comprises a first repeating unit and a second repeating unit, wherein:
(i) the first repeating unit comprises a side chain, wherein at least a portion of the side chain forms an N-halamine when exposed to an electrophilic halogen source; and
(ii) the second repeating unit comprises a water-soluble moiety,
wherein a number average molar mass of the copolymer in the composition is less than or equal to about 10 kilodalton (kDa).
   optionally wherein:
(x) the copolymer is dissolvable in an aqueous medium,
   further optionally wherein:
   (i) the aqueous medium for dissolving the copolymer is substantially free of organic solvent; and/or
   (ii) the aqueous medium for dissolving the copolymer is substantially consisting of deionized water; and/or
   (iii) the aqueous medium for dissolving the copolymer has a pH value of about 5 and about 7; and/or
   (iv) upon dissolving the copolymer in the aqueous medium, a mixture comprising the copolymer and the aqueous medium has a pH value of about 3 and about 7; and/or
   (v) upon dissolving the copolymer in the aqueous medium, a mixture comprising the copolymer and the aqueous medium has a pH value of about 3 and about 6; and/or
   (vi) upon dissolving the copolymer in the aqueous medium, a mixture comprising the copolymer and the aqueous medium has a pH value of about 4 and about 6; and/or
   (vii) the aqueous medium for dissolving the copolymer has a pH value of about 7 and about 10; and/or
   (viii) upon dissolving the copolymer in the aqueous medium, a mixture comprising the copolymer and the aqueous medium has a pH value of about 7 and about 10; and/or
   (ix) upon dissolving the copolymer in the aqueous medium, a mixture comprising the copolymer and the aqueous medium has a pH value of about 8 and about 10; and/or
   (xi) upon dissolving the copolymer in the aqueous medium, a mixture comprising the copolymer and the aqueous medium has a pH value of about 7 and about 9; and/or
   (xii) the aqueous medium for dissolving the copolymer has a pH value of about 10 and about 14; and/or
   (xiii) upon dissolving the copolymer in the aqueous medium, a mixture comprising the copolymer and the aqueous medium has a pH value of about 10 and about 14; and/or
   (xiv) upon dissolving the copolymer in the aqueous medium, a mixture comprising the copolymer and the aqueous medium has a pH value of about 11 and about 14; and/or
   (xv) upon dissolving the copolymer in the aqueous medium, a mixture comprising the copolymer and the aqueous medium has a pH value of about 12 and about 14; and/or
(x) the copolymer is dissolvable in an aqueous medium at a concentration of at least about 0.1 w/v %;
(x) the copolymer is dissolvable in an aqueous medium at a concentration of at least about 1 w/v %;
(x) the copolymer is dissolvable in an aqueous medium at a concentration of at least about 3 w/v %;
(x) the copolymer is dissolvable in an aqueous medium at a concentration of at least about 10 w/v %;
(x) the at least the portion of the side chain comprises a nitrogen-containing heterocycle, wherein the nitrogen-containing heterocycle forms the N-halamine when exposed to an electrophilic halogen source; and/or
(x) the at least the portion of the side chain comprises N-chlorinated halamine; and/or
(x) the second repeating unit comprises a side chain comprising the water-soluble moiety,
   further optionally wherein:
   (a) the water-soluble moiety comprises a quaternary amine,
      further optionally wherein the second repeating unit comprises the structure:

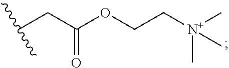

and/or
(b) the water-soluble moiety comprises a sulfonic acid;
   further optionally wherein the second repeating unit comprises the structure:

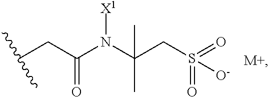

Wherein X¹ is H or Cl and M+ is a cation; and/or
(c) the water-soluble moiety comprises an amide;
   further optionally wherein the second repeating unit comprises the structure:

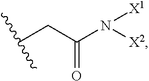

wherein X¹ is H or Cl, and X² is H or Cl; and/or
(d) the water-soluble moiety comprises a carboxylic acid;
   further optionally wherein the second repeating unit comprises the structure:

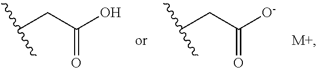

wherein M+ is a cation; and/or
(x) the first repeating unit comprises the structure:

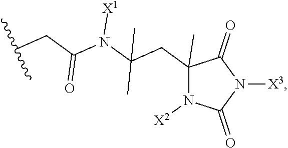

wherein at least one member of X¹, X², and X³ is Cl, and the other members of X¹, X², and X³ is each H or Cl; and/or
(x) the first repeating unit comprises the structure:

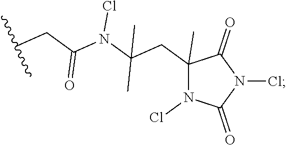

and/or
(x) the first repeating unit (RU1) and the second repeating unit (RU2) are present in the copolymer in a molar ratio of about 4:6 to about 8:2 (RU1:RU2); and/or
(x) the first repeating unit (RU1) and the second repeating unit (RU2) are present in the copolymer in a molar ratio of less than or equal to 7:3 (RU1:RU2); and/or
(x) the first repeating unit (RU1) and the second repeating unit (RU2) are present in the copolymer in a molar ratio of about 5:5 (RU1:RU2); and/or
(x) at least about 5% of N-halamine precursors of the copolymer is chlorinated to form N-chlorinated halamines; and/or
(x) at least about 10% of N-halamine precursors of the copolymer is chlorinated to form N-chlorinated halamines; and/or
(x) at least about 30% of N-halamine precursors of the copolymer is chlorinated to form N-chlorinated halamines; and/or
(x) an average molar mass of the copolymer is less than about 9 kDa; and/or
(x) an average molar mass of the copolymer is less than about 8 kDa; and/or
(x) an average molar mass of the copolymer is less than about 6 kDa; and/or
(x) the composition is a solid composition,
   further optionally wherein:
   (i) the solid composition is in a powder form; and/or
   (ii) the solid composition is in a tablet form; and/or
(x) upon application of at least the copolymer to a surface to generate a coating on the surface, the coating exhibits residual biocidal activity,
(x) further optionally wherein the residual biocidal activity is exhibited in absence of any additional application of a chlorine source.

Embodiment I1. A method comprising contacting the composition or the solid composition of any of the Embodiments F1-H1 to dissolve contacting the composition or the solid composition in the aqueous medium.

Embodiment 12. A method comprising:
(a) providing a sample of a polymer (or copolymer) comprising a N-halamine precursor configured to form a N-chlorinated halamine when exposed to an electrophilic chlorine source, wherein the N-halamine precursor is part of a repeating unit of the polymer (or the copolymer);
(b) contacting the sample of the polymer (or the copolymer) with the electrophilic chlorine source, to effect the N-halamine precursor to form the N-chlorinated halamine; and
(c) subsequent to (b), isolating for at least a portion of the sample of the polymer (or the copolymer) comprising the N-chlorinated halamine, to generate the composition or the solid composition of any of the Embodiments F1-H1.

Embodiment 13. A method comprising:
(a) providing a liquid composition comprising the composition or the solid composition of any of the Embodiments F1-H1 dispersed in the liquid composition; and
(b) applying the liquid composition to a surface to form a biocidal coating, wherein the biocidal coating comprises the N-chlorinated halamine.

Embodiment J1. A composition comprising:
a polymer comprising a N-halamine precursor configured to form a N-halogenated halamine when exposed to an electrophilic halogen source, wherein the N-halamine precursor is part of a repeating unit of the polymer; and
a small molecule binder comprising an organosilane moiety,
   optionally wherein:
(x) a side chain of the repeating unit comprises the N-halamine precursor; and/or
(x) the organosilane moiety comprises 3-aminopropyltriethoxysilane; and/or
(x) the polymer further comprises a reactive site that is different from the N-halamine precursor, wherein a reactive group of the organosilane moiety is configured to chemically conjugate to the reactive site,
   further optionally wherein:
   (a) the organosilane moiety further comprises an additional reactive site, wherein the additional reactive site is configured to chemically conjugate to a surface; and/or
   (b) the polymer is a copolymer comprising the repeating unit and an additional repeating unit, wherein additional repeating unit comprises the reactive site;
   (c) the reactive site comprises a dopamine moiety; and/or
   (d) the reactive site comprises the structure:

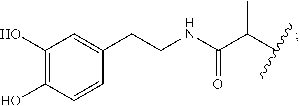 [SMILES: *C(C)C(=O)NCCc1ccc(O)c(O)c1]

and/or
(x) the composition further comprises an oxidizing agent to oxidize the reactive site of the polymer, such that the organosilane moiety is capable of chemically conjugating to the oxidized reactive site,
   further optionally wherein:
   (a) the oxidizing agent comprises hydrogen peroxide; and/or
   (b) the oxidizing agent comprises ammonium potassium; and/or
   (c) the oxidizing agent comprises a plurality of different oxidizing agents; and/or
   (d) the oxidizing agent and the reactive site are present in the composition in a molar ratio of about 1:40 to about 20:1 (oxidizing agent:reactive site); and/or
   (e) the oxidizing agent and the reactive site are present in the composition in a molar ratio of about 1:20 to about 10:1 (oxidizing agent:reactive site); and/or
(x) the repeating unit comprises the structure:

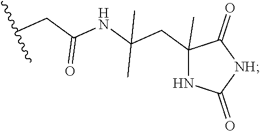

and/or
(x) an average molar mass of the copolymer is at least about 50 kilodaltons (kDa); and/or
(x) an average molar mass of the copolymer is less than about 50 kDa; and/or
(x) the composition further comprises a liquid medium, wherein the liquid medium comprises a mixture of water and an organic solvent,
   further optionally wherein:
   (a) the organic solvent comprises ethanol; and/or
   (b) the organic solvent and the water are present in the liquid medium in a volume ratio of about 80:20 to about 99:1; and/or
   (c) the organic solvent and the water are present in the liquid medium in a volume ratio of about 70:30 to about 95:5; and/or
   (d) the polymer is dispersed in the liquid medium; and/or
   (e) the small molecule binder is dispersed in the liquid medium; and/or
   (f) the polymer and the small molecule binder are dispersed in different liquid mediums, wherein the different liquid mediums are stored in different housings; and/or
(x) the composition a solid composition; and/or
(x) upon application of the composition to a surface to generate a coating on the surface, wherein the coating comprises the polymer that is coupled to the surface via the small molecule binder, the coating exhibits residual biocidal activity.

Embodiment K1. A composition comprising:
a copolymer comprising a first repeating unit and a second repeating unit, wherein:
   the first repeating unit comprises a N-halamine precursor configured to form a N-halogenated halamine when exposed to an electrophilic halogen source; and
   the second repeating unit comprises a dopamine moiety; and
a cross-linking moiety comprising:
   a reactive group configured to chemically conjugate to the dopamine moiety of the copolymer; and
   an additional reactive group configured to chemically conjugate to a surface, thereby coupling the copolymer to the surface,
      optionally wherein:
(x) the first repeating unit comprises a side chain comprising the N-halamine precursor; and/or
(x) the second repeating unit comprises a side chain comprising the dopamine moiety; and/or
(x) the cross-linking moiety comprises an organosilane moiety,
   further optionally wherein the organosilane moiety comprises 3-aminopropyltriethoxysilane; and/or
(x) the first repeating unit comprises the structure:

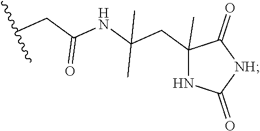

and/or
(x) the second repeating unit comprises the structure:

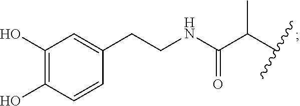

and/or
(x) the composition further comprises an oxidizing agent to oxidize the dopamine moiety, such that the organosilane moiety is capable of chemically conjugating to the oxidized dopamine moiety,
   further optionally wherein:
   (a) the oxidizing agent comprises hydrogen peroxide; and/or
   (b) the oxidizing agent comprises ammonium potassium; and/or
   (c) the oxidizing agent comprises a plurality of different oxidizing agents; and/or
   (d) the oxidizing agent and the dopamine moiety are present in the composition in a molar ratio of about 1:40 to about 20:1 (oxidizing agent:dopamine moiety); and/or
   (e) the oxidizing agent and the dopamine moiety are present in the composition in a molar ratio of about 1:20 to about 10:1 (oxidizing agent:dopamine moiety); and/or
(x) an average molar mass of the copolymer is at least about 50 kilodaltons (kDa); and/or
(x) an average molar mass of the copolymer is less than about 50 kDa; and/or
(x) the composition further comprises a liquid medium, wherein the liquid medium comprises a mixture of water and an organic solvent,
   further optionally wherein:
   (a) the organic solvent comprises ethanol; and/or
   (b) the organic solvent and the water are present in the liquid medium in a volume ratio of about 80:20 to about 99:1; and/or
   (c) the organic solvent and the water are present in the liquid medium in a volume ratio of about 70:30 to about 95:5; and/or
   (d) the copolymer is dispersed in the liquid medium; and/or
   (e) the cross-linking moiety is dispersed in the liquid medium; and/or
   (f) the copolymer and the cross-linking moiety are dispersed in different liquid mediums, wherein the different liquid mediums are stored in different housings; and/or
(x) the composition a solid composition; and/or
(x) upon application of the composition to a surface to generate a coating on the surface, wherein the coating comprises the copolymer that is coupled to the surface via the cross-linking moiety, the coating exhibits residual biocidal activity.

Embodiment L1. A composition comprising:
a copolymer comprising a first repeating unit and a second repeating unit, wherein:
   the first repeating unit comprises a N-halamine precursor configured to form a N-halogenated halamine when exposed to an electrophilic halogen source; and
   the second repeating unit comprise a dopamine moiety; and
a plurality of cross-linking moieties comprising a first cross-linking moiety and a second cross-linking moiety, wherein the first cross-linking moiety and the second cross-linking moieties are configured to:
   (i) electrostatically bind to one another; or
   (ii) chemically conjugate to one another,
      optionally wherein:
(x) the first cross-linking moiety and the second cross-linking moieties are configured to (i) electrostatically bind to one another; and/or
(x) the first cross-linking moiety and the second cross-linking moieties are configured to (ii) chemically conjugate to one another; and/or
(x) the first cross-linking moiety and the second cross-linking moieties are configured to (i) electrostatically bind to one another and (ii) chemically conjugate to one another; and/or
(x) one of the first cross-linking moiety and the second cross-linking moiety comprises a plurality of functional moieties capable of forming cationic functional groups, and the other of the first cross-linking moiety and the second cross-linking moiety comprises a plurality of functional moieties capable of forming anionic functional groups; and/or
(x) the first cross-linking moiety comprises polyethyleneimine; and/or
(x) the second cross-linking moiety comprises tannic acid; and/or
(x) the first repeating unit comprises a side chain comprising the N-halamine precursor; and/or
(x) the second repeating unit comprises a side chain comprising the dopamine moiety; and/or
(x) the first repeating unit comprises the structure:

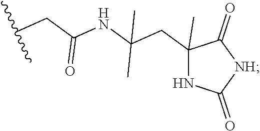

and/or
(x) the second repeating unit comprises the structure:

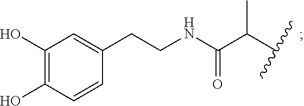

and/or
(x) an average molar mass of the copolymer is at least about 50 kilodaltons (kDa); and/or
(x) an average molar mass of the copolymer is less than about 50 kDa; and/or
(x) the composition further comprises a liquid medium, wherein the liquid medium comprises a mixture of water and an organic solvent,
   further optionally wherein:
   (a) the organic solvent comprises ethanol; and/or
   (b) the organic solvent and the water are present in the liquid medium in a volume ratio of about 80:20 to about 99:1; and/or
   (c) the organic solvent and the water are present in the liquid medium in a volume ratio of about 70:30 to about 95:5; and/or
   (d) the copolymer is dispersed in the liquid medium; and/or
   (e) the copolymer is dispersed in the liquid medium with one of the first cross-linking moiety and the second cross-linking moiety, but not the other; and/or
   (f) the first cross-linking moiety and the second cross-linking moiety are dispersed in different liquid mediums, wherein the different liquid mediums are stored in different housings; and/or
(x) the composition a solid composition; and/or
(x) upon application of the composition to a surface to generate a coating on the surface, wherein the coating comprises the copolymer and the plurality of cross-linking moieties, the coating exhibits residual biocidal activity.

Embodiment M1. A method comprising:
(a) providing a liquid composition comprising the composition of any of the Embodiments J1-L1 dispersed in the liquid composition; and
(b) applying the liquid composition to a surface to form a biocidal coating, wherein the biocidal coating comprises the N-halamine precursor,
optionally wherein the method further comprises, subsequent to (b), applying an additional liquid composition comprising the electrophilic halogen source, to transform the N-halamine precursor to the halogenated halamine.

Embodiment N1. An article of manufacture prepared by a process, the process
comprising the method of any one of Embodiments C1-C44.

What is claimed is:

1. A sample of a copolymer comprising a plurality of units of a first repeating group and plurality of units of a second repeating group, wherein:
the first repeating group or a portion thereof is: 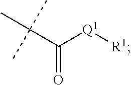
the second repeating group or a portion thereof is: 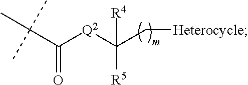
wherein
Q¹ is NCl, NH, O, or N(alkyl);
Q² is NCl, O, or N(alkyl);
R¹ is —C(R²)(R³)(CH₂)ₙ-Charged Group, H, or Cl;
R² is alkyl or H;
R³ is alkyl or H;
R⁴ is alkyl or H;
R⁵ is alkyl or H;
m is 1, 0, 2, 3, 4, or 5;
n is 1, 0, 2, 3, 4, or 5;
Charged Group is an ionizable or ionized moiety; and
Heterocycle is a heterocyclic ring containing a nitrogen atom that is substituted with a chlorine atom.

2. The copolymer of claim 1, wherein the copolymer has a molecular mass of about 50 kDa to about 150 kDa.

3. The copolymer of claim 1, wherein the copolymer has a molecular mass of about 1 kDa to about 50 kDa.

4. The copolymer of claim 1, wherein the second repeating group and the first repeating group are present in a ratio of 10:1 to 1:10.

5. The copolymer of claim 1, wherein the second repeating group and the first repeating group are present in a ratio of 5:1 to 1:1.

6. The copolymer of claim 1, wherein the second repeating group and the first repeating group are present in a ratio of 7:3 to 1:1.

7. The copolymer of claim 1, wherein the second repeating group and the first repeating group are present in a ratio of about 7:3.

8. The copolymer of claim 1, wherein the second repeating group and the first repeating group are present in a ratio of about 3:2.

9. The copolymer of claim 1, wherein the second repeating group and the first repeating group are present in a ratio of about 1:1.

10. The copolymer of claim 1, further comprising a backbone, wherein the first repeating group and the second repeating groups are sidechains, or portions thereof, pendant to the backbone.

11. The copolymer of claim 1, wherein the first repeating group or a portion thereof is: 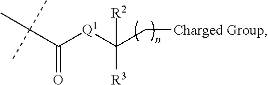
wherein n is 0, 1, 2, 3, 4, or 5.

12. The copolymer of claim 1, wherein the first repeating group is:

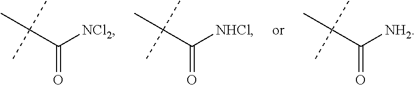

13. The copolymer of claim 1, wherein the first repeating group is: 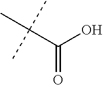
or an ionized form thereof.

14. The copolymer of claim 1, wherein the first repeating group is: 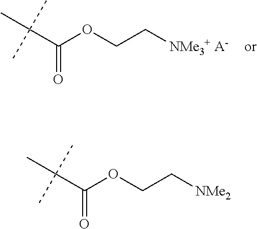
wherein A⁻ is an anion.

15. The copolymer of claim 1, wherein the first repeating group is: 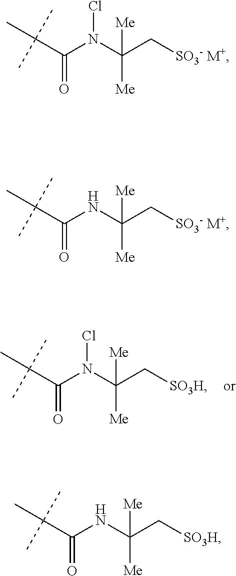
wherein M⁺ is a cation.

16. The copolymer of claim 1, wherein the second repeating group or a portion thereof is:

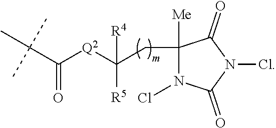

17. The copolymer of claim 1, wherein the second repeating group is:

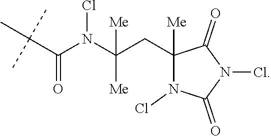

18. The copolymer of claim 1, wherein the first repeating group is: 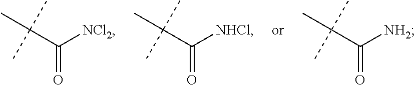
and the second repeating group is:

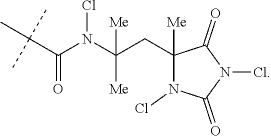

19. The copolymer of claim 1, wherein the first repeating group is: 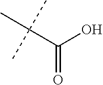
or an ionized form thereof; and the second repeating group is:

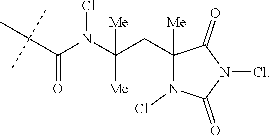

20. The copolymer of claim 1, wherein the first repeating group is: 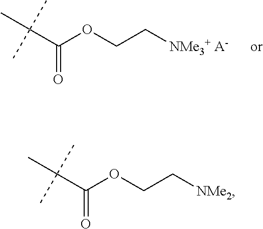
wherein A⁻ is an anion; and the second repeating group is:

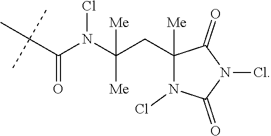

21. The copolymer of claim 1, wherein the first repeating group is: 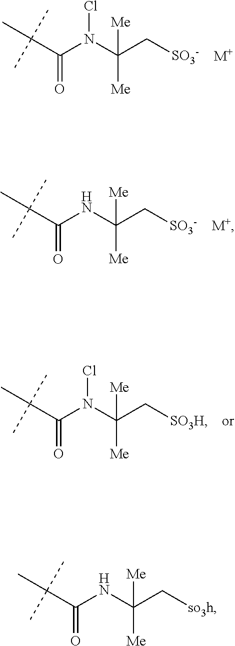
wherein M⁺ is a cation; and the second repeating group is:

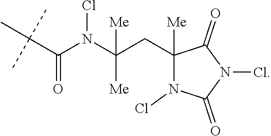

22. The copolymer of claim 1, further comprising a backbone and side chains pendant to the backbone, wherein the first repeating groups and the second repeating groups form portions of the backbone and of the sidechains.

23. The copolymer of claim 22, wherein the first repeating group or a portion thereof is:

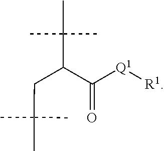

24. The copolymer of claim 22, wherein the first repeating group or a portion thereof is: 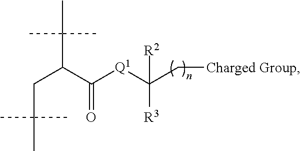
wherein n is 0, 1, 2, 3, 4, or 5.

25. The copolymer of claim 22, wherein the first repeating group is:

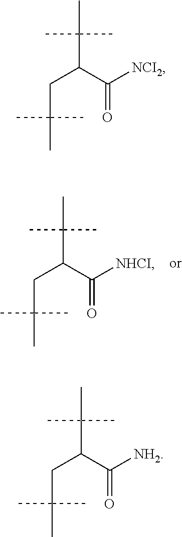

26. The copolymer of claim 22, wherein the first repeating group is: 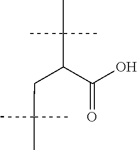
or an ionized form thereof.

27. The copolymer of claim 22, wherein the first repeating group is: 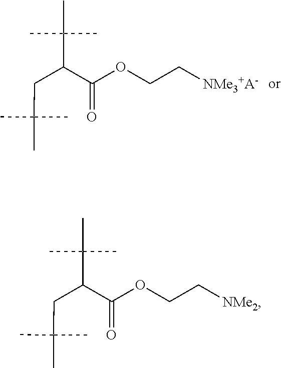
wherein A⁻ is an anion.

28. The copolymer of claim 22, wherein the first repeating group is: 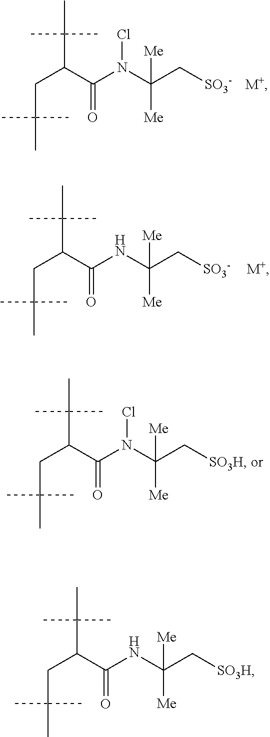
wherein M⁺ is a cation.

29. The copolymer of claim 22, wherein the second repeating group or a portion thereof is:

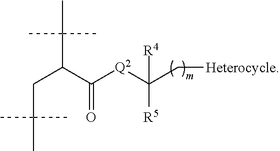

30. The copolymer of claim 22, wherein the second repeating group or a portion thereof is:

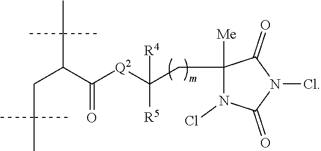

31. The copolymer of claim 22, wherein the second repeating group is:

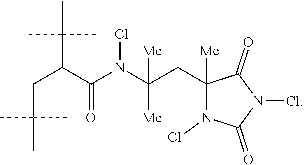

32. The copolymer of claim 22, wherein the first repeating group is: 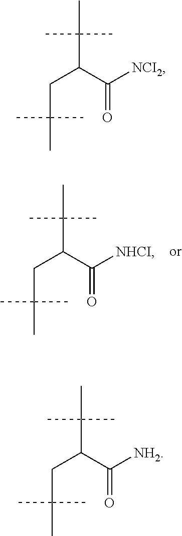
and the second repeating group is:

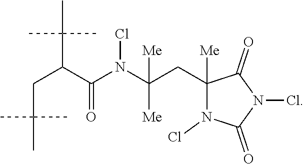

33. The copolymer of claim 22, wherein the first repeating group is: 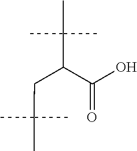
or an ionized form thereof; and the second repeating group is:

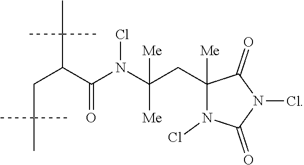

34. The copolymer of claim 22, wherein the first repeating group is: 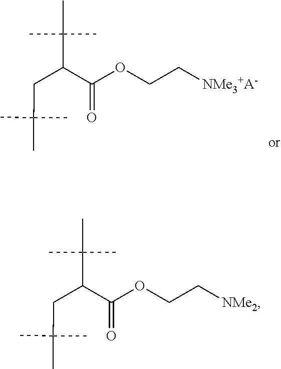
wherein A⁻ is an anion; and the second repeating group is:

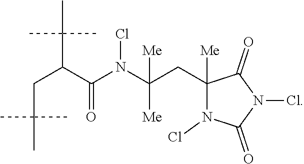

35. The copolymer of claim 22, wherein the first repeating group is: 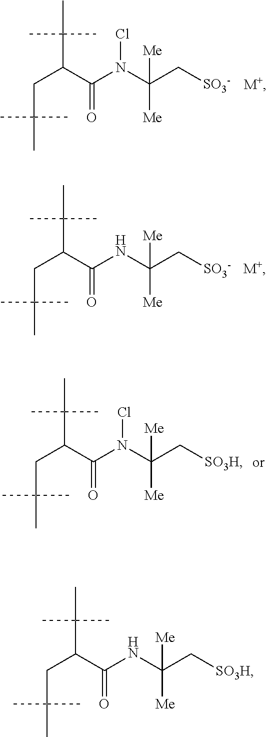
wherein M⁺ is a cation; and the second repeating group is:

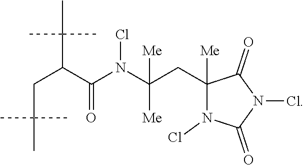

36. The copolymer of any one of claims 1-35, wherein the copolymer has a chlorine content of about 50,000 ppm to about 250,000 ppm as determined by iodometric/thiosulfate titration.

37. The copolymer of any one of claims 1-35, wherein the copolymer has a chlorine content of about 50,000 ppm to about 250,000 ppm as determined by spectrometer based on absorbency at 530 nm using N,N-diethyl-p-phenylenediamine (DPD) as an indicator.

38. The copolymer of any one of claims 1-35, wherein the copolymer has a chlorine content of about 4% to about 30% as determined by iodometric/thiosulfate titration.

39. The copolymer of any one of claims 1-35, wherein the copolymer has a chlorine content of about 4% to about 30% as determined by spectrometer based on absorbency at 530 nm using N,N-diethyl-p-phenylenediamine (DPD) as an indicator.

40. The composition of any one of claims 1-39, wherein the copolymer is dissolvable in the aqueous medium at a concentration of at least about 0.1 w/v %.

41. The composition of any one of claims 1-40 wherein the copolymer is dissolvable in an aqueous medium.

42. The composition of claim 41, wherein the aqueous medium for dissolving the copolymer is substantially free of organic solvent.

43. The composition of claim 41, wherein the aqueous medium for dissolving the copolymer is substantially consisting of deionized water.

44. The composition of claim 41, wherein the aqueous medium for dissolving the copolymer has a pH value of about 5 and about 7.

45. The composition of claim 41, wherein upon dissolving the copolymer in the aqueous medium, a mixture comprising the copolymer and the aqueous medium has a pH value of about 3 and about 7.

46. The composition of claim 41, wherein upon dissolving the copolymer in the aqueous medium, a mixture comprising the copolymer and the aqueous medium has a pH value of about 3 and about 6.

47. The composition of claim 41, wherein upon dissolving the copolymer in the aqueous medium, a mixture comprising the copolymer and the aqueous medium has a pH value of about 4 and about 6.

48. The composition of claim 41, wherein the aqueous medium for dissolving the solid composition has a pH value of about 7 and about 10.

49. The composition of claim 41, wherein upon dissolving the copolymer in the aqueous medium, a mixture comprising the copolymer and the aqueous medium has a pH value of about 7 and about 10.

50. The composition of claim 41, wherein upon dissolving the copolymer in the aqueous medium, a mixture comprising the copolymer and the aqueous medium has a pH value of about 8 and about 10.

51. The composition of claim 41, wherein upon dissolving the copolymer in the aqueous medium, a mixture comprising the copolymer and the aqueous medium has a pH value of about 7 and about 9.

52. The composition of claim 41, wherein the aqueous medium for dissolving the solid composition has a pH value of at least about 10 and about 14.

53. The composition of claim 41, wherein upon dissolving the copolymer in the aqueous medium, a mixture comprising the copolymer and the aqueous medium a pH value of about 10 and about 14.

54. The composition of claim 41, wherein upon dissolving the copolymer in the aqueous medium, a mixture comprising the copolymer and the aqueous medium has a pH value of about 11 and about 14.

55. The composition of claim 41, wherein upon dissolving the copolymer in the aqueous medium, a mixture comprising the copolymer and the aqueous medium has a pH value of about 12 and about 14.

56. The composition of any one of claims 1-55, wherein the copolymer is dissolvable in the aqueous medium at a concentration of at least about 1 w/v %.

57. The composition of any one of claims 1-56, wherein the copolymer is dissolvable in the aqueous medium at a concentration of at least about 3 w/v %.

58. The composition of any one of claims 1-57, wherein the copolymer is dissolvable in the aqueous medium at a concentration of at least about 10 w/v %.

59. A composition comprising:
a polymer comprising a N-halamine precursor configured to form a N-halogenated halamine when exposed to an electrophilic halogen source, wherein the N-halamine precursor is part of a repeating unit of the polymer; and
a small molecule binder comprising an organosilane moiety.

60. The composition of claim 59, wherein a side chain of the repeating unit comprises the N-halamine precursor.

61. The composition of claim 59, wherein the organosilane moiety comprises 3-aminopropyltriethoxysilane.

62. The composition of any one of claims 59-61, wherein the polymer further comprises a reactive site that is different from the N-halamine precursor, wherein a reactive group of the organosilane moiety is configured to chemically conjugate to the reactive site.

63. The composition of claim 62, wherein the organosilane moiety further comprises an additional reactive site, wherein the additional reactive site is configured to chemically conjugate to a surface.

64. The composition of claim 62, wherein the polymer is a copolymer comprising the repeating unit and an additional repeating unit, wherein additional repeating unit comprises the reactive site.

65. The composition of claim 62, wherein the reactive site comprises a dopamine moiety.

66. The composition of claim 62, wherein the reactive site comprises the structure:

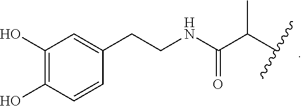 [SMILES: *C(C)C(=O)NCCc1ccc(O)c(O)c1]

67. The composition of any one of claims 59-66, further comprises an oxidizing agent to oxidize the reactive site of the polymer, such that the organosilane moiety is capable of chemically conjugating to the oxidized reactive site.

68. The composition of claim 67, wherein the oxidizing agent comprises hydrogen peroxide.

69. The composition of claim 67, wherein the oxidizing agent comprises ammonium potassium.

70. The composition of claim 67, wherein the oxidizing agent comprises a plurality of different oxidizing agents.

71. The composition of claim 67, wherein the oxidizing agent and the reactive site are present in the composition in a molar ratio of about 1:40 to about 20:1 (oxidizing agent:reactive site).

72. The composition of claim 67, wherein the oxidizing agent and the reactive site are present in the composition in a molar ratio of about 1:20 to about 10:1 (oxidizing agent:reactive site).

73. The composition of any one of claims 59-72, wherein the repeating unit comprises the structure:

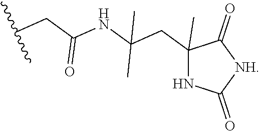

74. The composition of any one of claims 59-73, wherein an average molar mass of the copolymer is at least about 50 kilodaltons (kDa).

75. The composition of any one of claims 59-73, wherein an average molar mass of the copolymer is less than about 50 kDa.

76. The composition of any one of claims 59-75, wherein the composition further comprises a liquid medium, wherein the liquid medium comprises a mixture of water and an organic solvent.

77. The composition of claim 76, wherein the organic solvent comprises ethanol.

78. The composition of claim 76, wherein the organic solvent and the water are present in the liquid medium in a volume ratio of about 80:20 to about 99:1.

79. The composition of claim 76, wherein the organic solvent and the water are present in the liquid medium in a volume ratio of about 70:30 to about 95:5.

80. The composition of claim 76, wherein the polymer is dispersed in the liquid medium.

81. The composition of claim 76, wherein the small molecule binder is dispersed in the liquid medium.

82. The composition of claim 76, wherein the polymer and the small molecule binder are dispersed in different liquid mediums, wherein the different liquid mediums are stored in different housings.

83. The composition of any one of claims 59-82, where the composition is a solid composition.

84. The composition of any one of claims 59-83, wherein upon application of the composition to a surface to generate a coating on the surface, wherein the coating comprises the polymer that is coupled to the surface via the small molecule binder, the coating exhibits residual biocidal activity.

85. A method comprising:
(a) providing a liquid composition comprising the composition of any of claims 59-84 dispersed in the liquid composition; and
(b) applying the liquid composition to a surface to form a biocidal coating, wherein the biocidal coating comprises the N-halamine precursor,
optionally wherein the method further comprises, subsequent to (b), applying an additional liquid composition comprising the electrophilic halogen source, to transform the N-halamine precursor to the halogenated halamine.

86. A composition comprising a copolymer, wherein the copolymer comprises a first repeating unit and a second repeating unit, wherein:
(i) the first repeating unit comprises a side chain, wherein at least a portion of the side chain forms an N-halamine when exposed to an electrophilic halogen source; and
(ii) the second repeating unit comprises a water-soluble moiety,
wherein a number average molar mass of the copolymer in the composition is less than or equal to about 10 kilodalton (kDa).

87. The composition of claim 86, wherein the copolymer is dissolvable in an aqueous medium.

88. The composition of claim 87, wherein the aqueous medium for dissolving the copolymer is substantially free of organic solvent.

89. The composition of claim 87, wherein the aqueous medium for dissolving the copolymer is substantially consisting of deionized water.

90. The composition of claim 87, wherein the aqueous medium for dissolving the copolymer has a pH value of about 5 and about 7.

91. The composition of claim 87, wherein upon dissolving the copolymer in the aqueous medium, a mixture comprising the copolymer and the aqueous medium has a pH value of about 3 and about 7.

92. The composition of claim 87, wherein upon dissolving the copolymer in the aqueous medium, a mixture comprising the copolymer and the aqueous medium has a pH value of about 3 and about 6.

93. The composition of claim 87, wherein upon dissolving the copolymer in the aqueous medium, a mixture comprising the copolymer and the aqueous medium has a pH value of about 4 and about 6.

94. The composition of claim 87, wherein the aqueous medium for dissolving the solid composition has a pH value of about 7 and about 10.

95. The composition of claim 87, wherein upon dissolving the copolymer in the aqueous medium, a mixture comprising the copolymer and the aqueous medium has a pH value of about 7 and about 10.

96. The composition of claim 87, wherein upon dissolving the copolymer in the aqueous medium, a mixture comprising the copolymer and the aqueous medium has a pH value of about 8 and about 10.

97. The composition of claim 87, wherein upon dissolving the copolymer in the aqueous medium, a mixture comprising the copolymer and the aqueous medium has a pH value of about 7 and about 9.

98. The composition of claim 87, wherein the aqueous medium for dissolving the solid composition has a pH value of at least about 10 and about 14.

99. The composition of claim 87, wherein upon dissolving the copolymer in the aqueous medium, a mixture comprising the copolymer and the aqueous medium a pH value of about 10 and about 14.

100. The composition of claim 87, wherein upon dissolving the copolymer in the aqueous medium, a mixture comprising the copolymer and the aqueous medium has a pH value of about 11 and about 14.

101. The composition of claim 87, wherein upon dissolving the copolymer in the aqueous medium, a mixture comprising the copolymer and the aqueous medium has a pH value of about 12 and about 14.

102. The composition of any one of claims 86-101, wherein the copolymer is dissolvable in the aqueous medium at a concentration of at least about 0.1 w/v %.

103. The composition of any one of claims 86-102, wherein the copolymer is dissolvable in the aqueous medium at a concentration of at least about 1 w/v %.

104. The composition of any one of claims 86-103, wherein the copolymer is dissolvable in the aqueous medium at a concentration of at least about 3 w/v %.

105. The composition of any one of claims 86-104, wherein the copolymer is dissolvable in the aqueous medium at a concentration of at least about 10 w/v %.

106. The composition of any one of claims 86-105, wherein the at least the portion of the side chain comprises a nitrogen-containing heterocycle, wherein the nitrogen-containing heterocycle forms the N-halamine when exposed to an electrophilic halogen source.

107. The composition of any one of claims 86-105, wherein the at least the portion of the side chain comprises N-chlorinated halamine.

108. The composition of any one of claims 86-107, wherein the second repeating unit comprises a side chain comprising the water-soluble moiety.

109. The composition of claim 108, wherein the water-soluble moiety comprises a quaternary amine.

110. The composition of claim 109, wherein the second repeating unit comprises the structure:

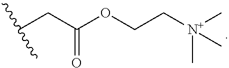

111. The composition of claim 108, wherein the water-soluble moiety comprises a sulfonic acid.

112. The composition of claim 112, wherein the second repeating unit comprises the structure: 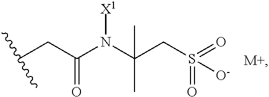
wherein X¹ is H or Cl and M⁺ is a cation.

113. The composition of claim 108, wherein the water-soluble moiety comprises an amide.

114. The composition of claim 113, wherein the second repeating unit comprises the structure: 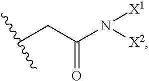
wherein X¹ is H or Cl, and X² is H or Cl.

115. The composition of claim 108, wherein the water-soluble moiety comprises a carboxylic acid.

116. The composition of claim 115, wherein the second repeating unit comprises the structure: 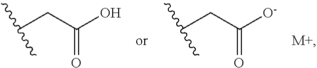
wherein M+ is a cation.

117. The composition of any one of claims 86-116, wherein the first repeating unit comprises the structure: 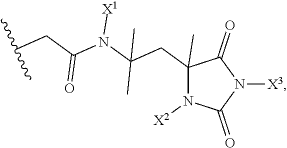
wherein at least one member of X¹, X², and X³ is Cl, and the other members of X¹, X², and X³ is each H or Cl.

118. The composition of any one of claims 86-117, wherein the first repeating unit comprises the structure:

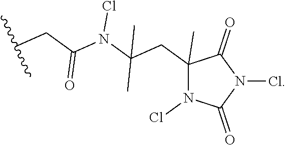

119. The composition of any one of claims 86-118, wherein the first repeating unit (RU1) and the second repeating unit (RU2) are present in the copolymer in a molar ratio of about 4:6 to about 8:2 (RU1:RU2).

120. The composition of any one of claims 86-119, wherein the first repeating unit (RU1) and the second repeating unit (RU2) are present in the copolymer in a molar ratio of less than or equal to 7:3 (RU1:RU2).

121. The composition of any one of claims 86-120, wherein the first repeating unit (RU1) and the second repeating unit (RU2) are present in the copolymer in a molar ratio of about 5:5 (RU1:RU2).

122. The composition of any one of claims 86-121, wherein at least about 5% of N-halamine precursors of the copolymer is chlorinated to form N-chlorinated halamines.

123. The composition of any one of claims 86-122, wherein at least about 10% of N-halamine precursors of the copolymer is chlorinated to form N-chlorinated halamines.

124. The composition of any one of claims 86-123, wherein at least about 30% of N-halamine precursors of the copolymer is chlorinated to form N-chlorinated halamines.

125. The composition of any one of claims 86-124, wherein an average molar mass of the copolymer is less than about 9 kDa.

126. The composition of any one of claims 86-125, wherein an average molar mass of the copolymer is less than about 8 kDa.

127. The composition of any one of claims 86-126, wherein an average molar mass of the copolymer is less than about 6 kDa.

128. The composition of any one of claims 86-127, wherein the composition is a solid composition.

129. The composition of claim 128, wherein the solid composition is in a powder form.

130. The composition of claim 128, wherein the solid composition is in a tablet form.

131. The composition of any one of claims 81-130, wherein upon application of at least the copolymer to a surface to generate a coating on the surface, the coating exhibits residual biocidal activity.

132. The composition of claim 131, wherein the residual biocidal activity is exhibited in absence of any additional application of a chlorine source.

133. A method comprising contacting the composition of any one of claims 86-132 with an aqueous medium, to dissolve the composition in the aqueous medium.

134. A method comprising:
(a) providing a sample of a copolymer of any one of claims 86-132 comprising a N-halamine precursor configured to form a N-chlorinated halamine when exposed to an electrophilic chlorine source, wherein the N-halamine precursor is part of a repeating unit of the polymer (or the copolymer);
(b) contacting the sample of the copolymer with the electrophilic chlorine source, to effect the N-halamine precursor to form the N-chlorinated halamine; and
(c) subsequent to (b), isolating for at least a portion of the sample of the copolymer comprising the N-chlorinated halamine.

135. A method comprising:
(a) providing a liquid composition comprising the copolymer of any one of claims 86-132 dispersed in the liquid composition; and
(b) applying the liquid composition to a surface to form a biocidal coating, wherein the biocidal coating comprises the N-chlorinated halamine.

136. A copolymer comprising a plurality of units of a first repeating group and a plurality of units of a second repeating group, wherein:
the first repeating group or a portion thereof is: 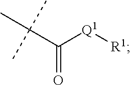
the second repeating group or a portion thereof is: 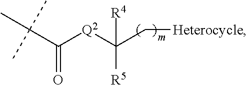
wherein
Q¹ is O, NH, or N(alkyl);
Q² is O, NH, or N(alkyl);
R¹ is H, —C(R²)(R³)(CH₂)ₙ-Charged Group;
R² is alkyl or H;
R³ is alkyl or H;
R⁴ is H or alkyl;
R⁵ is H or alkyl;
m is 1, 0, 2, 3, 4, or 5;
n is 1, 0, 2, 3, 4, or 5;
Charged Group is an ionizable or ionized moiety; and
Heterocycle is a heterocyclic ring containing a nitrogen atom.

137. A method comprising contacting a copolymer of claim 136 with an electrophilic chlorine source to provide a mixture.

138. A solid composition comprising:
(i) a N-chlorinated halamine, wherein the N-chlorinated halamine is part of a side chain of a first repeating unit of a polymer; and
(ii) a quaternary ammonium moiety,
wherein the solid composition is dissolvable in an aqueous medium.

139. A solid composition comprising a copolymer, wherein the copolymer comprises a first repeating unit and a second repeating unit, wherein:
(i) the first repeating unit comprises a side chain, wherein the side chain comprises a N-chlorinated halamine moiety; and
(ii) the second repeating unit comprises a water-soluble moiety,
wherein the composition is soluble in an aqueous medium.

140. A method comprising contacting the solid composition of claim 138 or 139 with an aqueous medium, to dissolve the solid composition in the aqueous medium.

141. A method comprising:
(a) providing a sample of a polymer comprising a N-halamine precursor configured to form a N-chlorinated halamine when exposed to an electrophilic chlorine source, wherein the N-halamine precursor is part of a repeating unit of the polymer
(b) contacting the sample of the polymer with the electrophilic chlorine source, to effect the N-halamine precursor to form the N-chlorinated halamine; and
(c) subsequent to (b), isolating for at least a portion of the sample of the polymer comprising the N-chlorinated halamine, to generate the solid composition of claim 138 or 139.

142. A method comprising:
(a) providing a sample of a polymer comprising a N-halamine precursor configured to form a N-chlorinated halamine when exposed to an electrophilic chlorine source, wherein the N-halamine precursor is part of a repeating unit of the polymer
(b) contacting the sample of the polymer with the electrophilic chlorine source, to effect the N-halamine precursor to form the N-chlorinated halamine; and
(c) subsequent to (b), isolating for at least a portion of the sample of the polymer comprising the N-chlorinated halamine, to generate the solid composition of claim 138 or 139.

143. A method comprising:
(a) providing a liquid composition comprising the solid composition of claim 138 or 139 dispersed in the liquid composition; and
(b) applying the liquid composition to a surface to form a biocidal coating, wherein the biocidal coating comprises the N-chlorinated halamine.

144. A composition comprising:
a copolymer comprising a first repeating unit and a second repeating unit, wherein:
the first repeating unit comprises a N-halamine precursor configured to form a N-halogenated halamine when exposed to an electrophilic halogen source; and
the second repeating unit comprises a dopamine moiety; and
a cross-linking moiety comprising:
a reactive group configured to chemically conjugate to the dopamine moiety of the copolymer; and
an additional reactive group configured to chemically conjugate to a surface, thereby coupling the copolymer to the surface.

145. A composition comprising:
a copolymer comprising a first repeating unit and a second repeating unit, wherein:
the first repeating unit comprises a N-halamine precursor configured to form a N-halogenated halamine when exposed to an electrophilic halogen source; and
the second repeating unit comprise a dopamine moiety; and
a plurality of cross-linking moieties comprising a first cross-linking moiety and a second cross-linking moiety, wherein the first cross-linking moiety and the second cross-linking moieties are configured to:
(i) electrostatically bind to one another; or
(ii) chemically conjugate to one another.

146. A method comprising:
(a) providing a liquid composition comprising the composition of claim 144 or 145 dispersed in the liquid composition; and
(b) applying the liquid composition to a surface to form a biocidal coating, wherein the biocidal coating comprises the N-halamine precursor,
optionally wherein the method further comprises, subsequent to (b), applying an additional liquid composition comprising the electrophilic halogen source, to transform the N-halamine precursor to the halogenated halamine.
